(19) United States
(12) Patent Application Publication
(10) Pub. No.: US 2025/0263202 A1
(43) Pub. Date: Aug. 21, 2025

(54) FOLD OUT ACCESSORIES

(71) Applicant: Garland Industries, Inc., Independence, OH (US)

(72) Inventors: David Sokol, Vermillion Township, OH (US); Melissa Rus, Independence, OH (US); Kali Peterson, Independence, OH (US); Matthew Hanson, Chagrin Falls, OH (US); Curtis Taylor, Chagrin Falls, OH (US)

(21) Appl. No.: 19/055,332

(22) Filed: Feb. 17, 2025

Related U.S. Application Data
(60) Provisional application No. 63/554,609, filed on Feb. 16, 2024.
(60) Provisional application No. 63/665,047, filed on Jun. 27, 2024.

(51) Int. Cl. B65D 21/08; A47B 81/00; B60R 11/00; B65D 5/36; B65D 5/56; B65D 25/14; B65D 25/30; B65D 25/32; E01F 9/654; E06C 7/14

(52) U.S. Cl. CPC B65D 21/086; B65D 5/3607; B65D 5/563; B65D 25/14; B65D 25/30; B65D 25/32; A47B 81/00; B60R 11/00; E01F 9/654; E06C 7/14

(57) ABSTRACT

Foldable storage bins, organizers, caddies, tray, and accessories formed from corrugated plastic materials, and methods of using the same, for work-site use. The storage bins, organizers, caddies, and/or container accessories can optionally include a protective liner.

### REFERENCED APPLICATION

This patent application claims the benefit of U.S. Provisional Patent Application Ser. Nos. 63/554,609 filed on Feb. 16, 2024 and 63/665,047 filed on Jun. 27, 2024, the disclosures of which are hereby incorporated fully by reference herein in their entirety and are made part of the present U.S. utility patent application for all purposes.

### TECHNICAL FIELD

The present disclosure relates generally to storage bins, organizers, and container accessories; and specifically to expandable, foldable, collapsible and reusable storage bins, organizers, caddies, safety cones, and accessories for vehicles, for work sites, and/or for aerial lifts, and more specifically to expandable, foldable, collapsible and reusable storage bins, organizers, caddies, safety cones, and accessories for vehicles, for work sites, and/or for aerial lifts that are partially or fully made from plastic materials such as, but not limited to plastic corrugated materials, and which storage bins, organizers, caddies, and container accessories can optionally include a protective liner.

### BACKGROUND OF DISCLOSURE

Storage bins, organizers, and containers are commonplace in modern society. However, such conventional storage bins, organizers, and containers are often heavy, bulky items that occupy a large amount of space and increase the risk of injury to individuals on or near work sites (e.g. aerial lifts, ladders, painting sites, automotive sites, landscaping/gardening sites, or the like). Further, such conventional storage bins, organizers, and containers are often subject to weathering and damage over time. Many types of storage bins, organizers, and containers are reformed into a single, unalterable shape, thus can be bulky to store and cannot be modified in shape for certain types of use.

Accordingly, there is an ongoing need for storage bins, organizers, caddies, and accessories that: (i) are formed from strong, lightweight and durable materials; (ii) can be easily and efficiently collapsed into a flat or near flat configuration when not in use, and can later be easily reformed into an assembled-expanded configuration when in use, and (iii) can be assembled and collapsed multiple times without damage to the storage bins, organizers, caddies, and accessories.

### SUMMARY OF DISCLOSURE

The present disclosure is directed to expandable, foldable, collapsible and reusable storage bins, organizers, caddies, safety cones, and accessories for vehicles, for work sites, and/or for aerial lifts that are optionally partially or fully made from plastic materials such as, but not limited to plastic corrugated materials, and which storage bins, organizers, caddies, safety cones, and accessories can optionally include a protective liner. The storage bins, organizers, caddies, safety cones, and accessories are formed from a strong, lightweight, durable material, and the storage bins, organizers, caddies, safety cones, and accessories can be easily and efficiently collapsed into a flat or closely flat configuration when not in use, and can be easily expanded or formed into an assembled-expanded configuration when in use. In one non-limiting embodiment, the material used to partially or fully form the storage bins, organizers, caddies, safety cones, and accessories is a plastic corrugated material (e.g., Coroplast™ corrugated plastic sheets, Plaskolite™ corrugated plastic sheets, Correx™ corrugated plastic sheets, Biplex™ corrugated plastic sheets, Cartonplast™ corrugated plastic sheets, Polyflute™ corrugated plastic sheets, FlutePlast™ corrugated plastic sheets, IntePro™ corrugated plastic sheets, Proplex™ corrugated plastic sheets, Twinplast™ corrugated plastic sheets, Corriflute™ corrugated plastic sheets, Corflute™ corrugated plastic sheets, etc.), which material is a strong, durable, lightweight corrugated plastic material. The type, thickness, color and/or configuration of the plastic corrugated material are non-limiting. The type of plastic used to form the plastic corrugated material is non-limiting. In one non-limiting configuration, the corrugated plastic material is an extruded twin-wall plastic-sheet product produced from a polymer material (e.g., high-impact polypropylene resin, etc.), and has a fluted internal configuration that is similar configuration to corrugated fiberboard or a shaped ribbed interior that is sandwiched between the two outer walls of the corrugated plastic material. In another non-limiting embodiment, the thickness of the corrugated plastic material is 1-10 mm (and all values and ranges therebetween). The thickness of the fluted or ribbed portion of the corrugated plastic material is typically greater than the thickness of each of the outer walls.

In one non-limiting aspect of the disclosure, one or more of the storage bins, organizers, caddies, safety cones, and/or container accessories can include one or more living hinges to facilitate in the assembly of the storage bin, organizer, caddy, safety cones, and container accessory from an unassembled or collapsed position to an assembled-expanded form, and optionally back to the collapsed or unassembled position. In one non-limiting embodiment, the storage bins, organizers, caddies, safety cones, and/or container accessories are configured such that the storage bins, organizers, caddies, safety cones, and/or container accessories can be collapsed and reassembled multiple times (e.g., 2-50000 and all values ranges therebetween) during the life of the storage bins, organizers, caddies, safety cones, and/or container accessories while still maintaining the integrity of the one or more living hinges. The living hinges, when used, are typically preformed in the material that is used to form the storage bins, organizers, caddies, safety cones, and/or container accessories. For example, a groove, serration, recess region, etc. can be formed in the material that is used to form the storage bins, organizers, caddies, safety cones, and/or container accessories so as to partially or fully form the living hinge. In one non-limiting configuration, when corrugated plastic sheets are used to partially or fully form the storage bins, organizers, caddies, safety cones, and/or container accessories, one or both sides of the corrugated sheet can be pressed together using heat and/or pressure to partially or fully form the living hinge. In another non-limiting configuration, when corrugated plastic sheets are used to partially or fully form the storage bins, organizers, caddies, safety cones, and/or container accessories, one or both sides of the corrugated sheet can a) be pressed together using heat and/or pressure to partially or fully form the living hinge, and/or b) have serrations formed in the corrugated sheets to partially or fully form the living hinge. Generally, the living hinges are pre-formed in the corrugated plastic sheets or other material used to form the storage bins, organizers, caddies, safety cones, and/or container accessories.

In another and/or alternative non-limiting aspect of the disclosure, one or more of the storage bins, organizers, caddies, safety cones, and/or container accessories can include one or more connectors (e.g., snap, hook and loop fastener, dual lock fastener, mushroom hook fastener, zipper, strap, rib and groove connection, magnet, latch, slot arrangement, tab arrangement, zip-tie, clip, adhesive connection, etc.). The one or more connectors can be used to form a permanent connection or a releasable connection. In one non-limiting embodiment, the storage bin, organizer, caddy, safety cones, and/or container accessory includes one or more connectors that form a releasable connection so that the storage bin, organizer, caddy, safety cones, and/or container accessory can be collapsed and reassembled multiple times during the life of the storage bin, organizer, caddy, and/or container accessory. In another non-limiting embodiment, the storage bin, organizer, caddy, safety cones, and/or container accessory includes one or more connectors that form a releasable connection so that the storage bin, organizer, caddy, safety cones, and/or container accessory can be connected to and detached from a structure (e.g., bar, step on a ladder, aerial lift, vehicle seat, vehicle trunk, platform, seat, bench, wall, ceiling, rail, fence, floor, etc.) multiple times during the life of the storage bin, organizer, caddy, and/or container accessory.

In another and/or alternative non-limiting aspect of the disclosure, the storage bins, organizers, caddies, safety cones, and/or container accessories can optionally include a retention arrangement that is used to facilitate in securing the storage bins, organizers, caddies, safety cones, and/or container accessories in position while in use. In one non-limiting embodiment, the storage bins, organizers, caddies, safety cones, and/or container accessories can include one or more openings, hooks, loops, snaps, clips, brackets, tabs, flanges, etc. that can be configured to be attachment and/or support locations for the storage bins, organizers, caddies, safety cones, and/or container accessories so that the storage bins, organizers, caddies, safety cones, and/or container accessories can be permanently or releasably secured in position at various locations (e.g., bar, step on a ladder, aerial lift, vehicle seat, vehicle trunk, platform, seat, bench, wall, ceiling, rail, fence, floor, etc.) during use.

In another and/or alternative non-limiting aspect of the disclosure, the storage bins, organizers, caddies, safety cones, and/or container accessories can optionally include a protective liner. The protective liner can optionally be used to protect one or more surfaces (e.g., the top surface, the side surfaces, the bottom surface, cavity, platform surfaces, etc.) of the storage bins, organizers, caddies, safety cones, and/or container accessories from damage or disfiguration or discoloration due to a) one or more liquids being spilled onto the storage bins, organizers, caddies, safety cones, and/or container accessories, and/or into one or more cavities of the storage bins, organizers, caddies, and/or container accessories, and/or b) one or more sharp materials and/or abrasive materials (e.g., tools, knives, rocks, sand, pebbles, etc.) contacting one or more surface of the storage bins, organizers, caddies, safety cones, and/or container accessories. The protective liner can also optionally be used to inhibit or prevent leakage of liquid from the storage bins, organizers, caddies, and/or container accessories due to one or more liquids being spilled on the storage bins, organizers, caddies, and/or container accessories and/or into one or more cavities of the storage bins, organizers, caddies, and/or container accessories. In another non-limiting embodiment, the protective liner can be removably connected to one or more portions of the storage bins, organizers, caddies, safety cones, and/or container accessories without damaging, discoloring or otherwise disfiguring the top surface of the storage bins, organizers, caddies, safety cones, and/or container accessories. In one non-limiting embodiment, a removable connection between the protective liner and one or more portions of the storage bins, organizers, caddies, safety cones, and/or container accessories can be formed by a snap, hook and loop fastener, dual lock fastener, mushroom hook fastener, zipper, strap, rib and groove connection, magnet, latch, slot arrangement, tab arrangement, zip-tie, clip, adhesive connection, etc. In another non-limiting embodiment, the protective liner can be configured to be irremovably connected to one or more portions of the top surface of the storage bins, organizers, caddies, safety cones, and/or container accessories. In another non-limiting embodiment, the protective liner (a) includes a liquid retention layer having a non-porous intermediate layer and/or a non-porous backing, and wherein the backing (which may or may not be non-porous) that allows for securing, optional repositioning and/or optional subsequent removal of the protective liner from a surface, and wherein when the backing is a non-porous backing, the non-porous backing can be one or more layers (e.g., a non-porous adhesive layer, a non-porous layer and an adhesive layer on the non-porous layer, etc.); (b) is optionally removable without damaging the region that the protective liner was previously connected thereto; and (c) optionally includes a reinforcement layer. In one non-limiting configuration, the liquid retention layer may or may not include absorbable components. In another non-limiting configuration, the liquid retention layer is partially or fully formed of polymer material (e.g., aramid fibers [e.g., poly-para-phenylene terephthalamide [Kevlar®]], carbon fibers, fiberglass, boron fibers, polyethylene fibers, polypropylene fibers, recycled polymer fibers, polyethylene terephthalate fibers and/or plastic fibers, etc.). In one non-limiting formulation, the fibers used to partially or fully form the liquid retention layer are formed of 60-100% post-consumer and/or post-industrial recycled PET (e.g., the post-consumer and/or post-industrial recycled PET can be used to layer provide superior liquid retention while promoting sustainability through the use of recycled plastics). In another non-limiting configuration, the fiber layer used to partially or fully form the liquid retention layer can be formed of woven and/or non-woven fibers. In another non-limiting configuration, the one or more fiber layers form a liquid retention media and the liquid retention layer is liquid penetrable, thus enabling liquid that is not retained by the one or more fiber layers to pass fully through the liquid retention layer. In another non-limiting embodiment, the non-porous backing is formulated and designed to inhibit or prevent liquid from passing through the non-porous backing and/or non-porous intermediate layer. In one non-limiting configuration, the thickness of the non-porous backing and/or non-porous intermediate layer is less than the thickness of the liquid retention layer. In another non-limiting configuration, the non-porous backing and/or non-porous intermediate layer includes one or more polymers (e.g., acrylate polymer, natural rubber, synthetic thermoplastic elastomer, silicone rubber, etc.). In another non-limiting configuration, the non-porous backing and/or non-porous intermediate layer is or includes a high-temperature polymer that has a softening point of 140-240° F. (and all values and ranges therebetween). In another non-limiting configuration, the non-porous backing and/or non-porous intermediate layer has adhesive properties that allows for securing, repositioning and/or subsequent removal of the protective liner from a surface (e.g., plastic surface, etc.). In another non-limiting configuration, the protective liner can optionally include a separate adhesive layer from the non-porous backing and/or non-porous intermediate layer that is applied to the bottom of the non-porous backing and/or non-porous intermediate layer or an optional reinforcement layer. The optional separate adhesive layer can be a high-temperature polymer that has a softening point of greater than 180° F. and the bottom surface functions as an adhesive between 32-180° F. In another non-limiting configuration, a reinforcement layer can optionally be used as a reinforcement for the protective liner, and which reinforcement layer is located between the liquid retention layer and the non-porous backing and/or non-porous intermediate layer. The composition of the reinforcement layer can be the same or different from the liquid retention layer. The reinforcement layer may or may not be porous. The reinforcement layer can be formed of one or more of fiberglass, nylon, polyester, cotton, silk, wool, hemp, straw, bamboo, flax, jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, aromatic polyamide or aramid fibers (e.g., Kevlar™, Twaron™, etc.), polyethylene fibers, polypropylene fibers, recycled polymer fibers, recycled, plastic fibers, and any blend of these materials.

In another and/or alternative non-limiting aspect of the disclosure, there is provided a foldable corner caddy. The corner caddy can optionally be partially or fully formed of corrugated plastic. The corner caddy can be optionally formed of a single piece of material. In one non-limiting configuration, the corner caddy is formed of a single piece of corrugated plastic. The corner caddy can optionally include one or more living hinges to facilitate in the folding and unfolding of the corner caddy from an unassembled or folded position or collapsed position to an assembled-expanded form, and optionally back to a collapsed or unassembled position. The corner caddy is configured to be mounted to a corner (e.g., interior corner) of a structure (e.g., corner of an aerial lift cage frame, corner of a wall or fence, corner of a box or cage or container, corner of a rail, etc.). The corner caddy can be permanently or releasably connected to the structure. The corner caddy includes one or more holders or foldable side flanges that can be used to support the corner caddy in a corner of a structure. In one non-limiting configuration, each of the holders or foldable side flanges include a holder connector living hinge that connects to a top edge of one of the side walls of the corner caddy. In another non-limiting configuration, each of the holders or foldable side flanges includes an intermediate living hinge that is spaced from the holder connector living hinge and is configured to enable a portion of the holder or foldable side flange to be bent to form a first and second portion of the holder or foldable side flange, and wherein in the first portion is connected to the holder connector living hinge. In another non-limiting configuration, the longitudinal length of the first portion is less than a longitudinal length of the second portion, and the width of the first and second portions is optionally the same along at least 80% (e.g., 80-100%) of the longitudinal length of the respective first and second portions. In another non-limiting configuration, when each of the holders or foldable side flanges is in the assemble configuration or position, the holder connector living hinge can be bent such that first portion of the holder or foldable side flange is oriented at an angle of about 80°-100° (and all values and ranges therebetween) to the side wall to which the holder or foldable side flange is connected thereto, and wherein the first portion and the second portion are oriented at an angle of about 80°-100° (and all values and ranges therebetween) relative to one another, and wherein the plane of the second portion is parallel or nearly parallel (0-15° within being parallel and all values and ranges therebetween) to the side wall to which the holder or foldable side flange is connected thereto, and wherein the holder or foldable side flange and the side wall to which the holder or foldable side flange is connected thereto for a generally U-shaped or C-shaped configuration. The generally U-shaped or C-shaped configuration of the holder or foldable side flange in the assemble configuration or position allows for the holders or foldable side flanges is in the assemble configuration or position to be positioned or fitted about a rail, bar, wall, etc. such that a portion of the rail, bar, wall, etc. is positioned between the outer surface of the side wall and the inner surface of the second portion of the holder or foldable side flange, and the bottom of the first portion of the holder or foldable side flange rests on the top edge or surface of the rail, bar, wall, etc., thus the holder or foldable side flange supports the corner caddy on the top edge or surface of the rail, bar, wall, etc. The longitudinal length of the holder or foldable side flange is 10-90% (and all values and ranges) the height of the side wall to which the holder or foldable side flange is connected thereto. In one non-limiting embodiment, the second portion of the holder or foldable side flange has a longitudinal length that is 10-49% (and all values and ranges) the height of the side wall to which the holder or foldable side flange is connected thereto. The corner caddy can include one or more openings, rings, clips, tabs, etc. that are configured to receive zip-ties, wire, cords, straps or other attachment devices used to connect the corner caddy to the structure. The number, location, size and configuration of the one or more openings, rings, clips, tabs, etc. is non-limiting. In one non-limiting configuration, the holder or foldable side flange and/or one or more side walls can optionally include one or more holes or openings configured to receive a cord, zip-tie, or the like to secure the corner caddy to the rail, bar, wall, etc. The corner caddy can include a bottom portion that forms holding compartment in the corner caddy that can be used to hold various implements (e.g., tools, cups, food, toys, containers, materials to be used by the user in an aerial lift cage or some other location where the corner caddy is mounted, etc.). In another non-limiting embodiment, the corner caddy can have a partial or full open bottom portion. In one non-limiting configuration, the bottom portion is fully closed expect for the inclusion of one or more optional drainage openings. The corner caddy can be configured to be collapsible into a substantially flat configuration when not in use. The corner caddy can optionally include one or more internal flanges that extend into the internal compartment of the corner caddy so as to a) provide structural integrity and/or rigidity to the corner caddy and/or b) form multiple compartments in the corner caddy. When the corner caddy includes two or more internal flanges, such internal flanges can optionally be connected together to facilitate in maintaining the corner caddy in assembled position and/or to provide structural rigidity to the corner caddy when in the assembled position. The one or more internal flanges in the corner caddy, when used, can be connected in the internal compartment by various means (e.g., adhesive, hook and loop fasteners, dual lock fasteners, mushroom hook fasteners, zip tie, cord clamp, cords, etc.). The connection between the one or more internal flanges can be releasable or permanent. One or more optional drainage openings can be included in the bottom portion of the internal compartment so as to allow liquids to drain from the internal compartment and/or facilitate in removing debris from internal compartment. The number, size and/or location of the optional one or more drainage openings is non-limiting. When used, the total surface area of the drainage openings is less than 10% (0.001-9.999% and all values and ranges therebetween) of the surface area of the bottom portion of the internal compartment. The shape of the internal compartment is non-limiting. In one non-limiting embodiment, the internal compartment of the corner caddy has a generally triangular cross-sectional shape and two side holders or foldable side flanges on two of the three sides of the top edge of the internal compartment. The two side holders or foldable side flanges each include a holder connector living hinge that forms a connection to the top edge of the internal compartment, and also facilitates in the reconfiguring of the corner caddy from the collapsed orientation to the uncollapsed or assembled orientation. In one non-limiting configuration, the side holders or foldable side flanges are spaced from one another when the corner caddy is in the uncollapsed or assembled position. In another non-limiting embodiment, the corner caddy can optionally include a bottom flange that is configured to be positioned over a portion (e.g., over 1-99.99% of the bottom portion of the corner caddy and all values and ranges therebetween) or all of the bottom portion of the corner caddy when the corner caddy is in the assembled position. The bottom flange, when used, can be configured to a) provide structural support to the bottom portion of the corner caddy, and/or b) provide rigidity and/or strength to the corner caddy. The bottom flange can optionally include a bottom rib that is configured to provide support, strength and/or rigidity to the bottom flange. The bottom flange can optionally include one or more connectors and/or openings used to a) releasably or permanently connect portions of the bottom flange together, b) facilitate in connecting the bottom flange to a portion of the bottom portion of the corner caddy, c) function as drainage openings, and/or d) facilitate in connecting the bottom flange to a structure to facilitate in supporting and/or connecting the corner caddy to such structure. In another non-limiting configuration, the bottom flange can include one or more living hinges to connect the bottom flange to a bottom edge of one or more side walls of the corner caddy. The bottom portion of the internal compartment can optionally include a protective liner. The protective liner can optionally include a liquid barrier layer that inhibits or prevents liquids from fully passing through the protective liner. The protective liner can be permanently or releasably secured to the top surface of the bottom portion of the internal compartment by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the top surface of the internal compartment by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the top surface of the internal compartment, the protective liner can be removed and optionally cleaned and then reinserted in the internal compartment or be replaced with a new protective liner. The color and thickness of the protective liner, when used, is non-limiting. As can be appreciated, the protective liner can be sized to fully overlie or partially overlie (e.g., overlie 5%-99.00% and all values and ranges therebetween) the top surface of the internal compartment. As can also be appreciated, the protective liner can be positioned on a portion or all of the inner side wall surfaces of the internal compartment.

In another and/or alternative non-limiting aspect of the disclosure, there is provided a foldable pipe rack. The pipe rack can optionally be partially or fully formed of corrugated plastic. The pipe rack can be optionally formed of a single piece of material. The pipe rack can optionally include one or more living hinges to facilitate in the folding and unfolding of the pipe rack from an unassembled or collapsed position to assembled-expanded form, and optionally back to a collapsed or unassembled position. The pipe rack is configured to be mounted to a structure (e.g., an aerial lift cage frame, a wall or fence, corner of a box or cage or container, etc.). The pipe rack can be permanently or releasably connected to the structure. In one non-limiting embodiment, the pipe rack includes a support member on both sides of the pipe rack that is coupled to a base, and wherein the base is configured to be affixed to corners of a structure (e.g., aerial lift cage, fence, wall, etc.). At least a portion of the top surface of the two support members forms a generally U-shape or semi-circular shaped support surface that is configured to retain a portion of a pipe or rod that is positioned on the support surface. As can be appreciated, the support surface can have other shapes. In one non-limiting embodiment, the support member each have a top support surface that have generally the same curvilinear shape. In one non-limiting embodiment, one of the support members can have a greater thickness than the other support member; however, this is not required. A slot can optionally be located in one or both of the support members that is configured to allow a portion of a support structure of the pipe rack to be positioned therethrough. The support structure can be used to provide rigidity to the pipe rack in the assembled position and/or to facilitate in maintaining the pipe rack in the assembled position. The top surface of a portion of the support structure can optionally form a base portion of a well that is located between the two support members. One or more components of the pipe rack can be connected together by a living hinge to facilitate in the reconfiguration of the pipe rack from the collapsed orientation to the uncollapsed orientation. The pipe rack can include a plurality of openings or holes that are formed in the flanges of the base and/or on one or more of the support members to receive zip-ties, wire, cords or other attachment devices that can be used to connect the pipe rack to a corner of a structure (e.g., aerial lift cage, fence, wall, or some other structure, etc.). The pipe rack can optionally include one or more side slots and the like to further facilitate in the mounting of the pipe rack on a structure. In one non-limiting embodiment, the support members form a substantially U-shaped portion that receives and supports long, lineal items like piping or other conduits. In another non-limiting embodiment, a second pipe rack that is substantially identical to a first pipe rack, can be attached to the same or adjacent structure as the first pipe rack, but at an opposite corner to that of the first pipe rack, to fully support piping or other conduits between the first pipe rack and the second pipe rack. In another non-limiting embodiment, the pipe rack is collapsible into a substantially flat configuration when not in use. It is to be understood that the pipe rack can be used to hold other items (e.g., wood planks, beams, lights, rods, etc.). The ends of the well can optionally include openings for use with an elastic tether, cord, etc. that can be used to facilitate in retaining pipes, rods, etc. in the well. In one non-limiting embodiment, there is provided an elastic tether and can be connected at one end wall of the well, and the other end of the elastic tether includes a ball or other structure that can be releasable placed into and secured to the other end wall of the well. One or more portions of the pipe rack can optionally include a protective liner. The protective liner can optionally include a liquid barrier layer that inhibits or prevents liquids from fully passing through the protective liner. The protective liner can be permanently or releasably secured to one or more surfaces of the pipe rack by any number of arrangements (e.g., adhesive, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the top surface of the pipe rack. One or more sides of the pipe rack can optionally include logos, instructions, branding, etc.

In another and/or alternative non-limiting aspect of the disclosure, there is provided a foldable trough. The trough can optionally be partially or fully formed of corrugated plastic. The trough can be optionally formed of a single piece of material. The trough can optionally include one or more living hinges to facilitate in the folding and unfolding of the trough from an unassembled or collapsed position to assembled-expanded form, and optionally back to a collapsed or unassembled position. The trough is configured to be mounted to a structure (e.g., an aerial lift cage frame, a wall or fence, box or cage or container, etc.). The trough can be permanently or releasably connected to the structure. In one non-limiting embodiment, the trough includes a contact surface that engages a structure to which the trough is to be connected (e.g., aerial lift cage, fence, wall, or some other structure, etc.). In another non-limiting embodiment, the trough is a closed bottom trough that forms an internal compartment. One or more components of the trough can be connected together by a living hinge to facilitate in the reconfiguring of the trough from the collapsed orientation to the uncollapsed orientation. In another non-limiting embodiment, a plurality of openings or holes can optionally be formed in the contact surface that are configured to receive zip-ties, wire, cord, or other attachment devices that can be used to connect the trough to the structure that the trough is to be connected. The trough can be configured to be collapsible into a substantially flat configuration when not in use. The trough can optionally include one or more drainage openings in the bottom portion of the trough so as to allow liquids to drain from the trough and/or facilitate in removing debris from the trough. The number, size and/or location of the optional one or more drainage openings is non-limiting. The bottom portion of the trough can optionally include a protective liner. The protective liner can optionally include a liquid barrier layer that inhibits or prevents liquids to pass fully through the protective liner. The protective liner can be permanently or releasably secured to the top surface of the bottom portion of the trough 300 in any number of arrangements (e.g., adhesive, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the bottom portion of the trough. As can also be appreciated, the protective liner can be positioned on a portion or all of the inner side wall surfaces of the trough. One or more sides of the trough can optionally include logos, instructions, branding, etc.

In another and/or alternative non-limiting aspect of the disclosure, there is provided a collapsible safety cone. The safety cone can optionally be partially or fully formed of corrugated plastic. The safety cone can be optionally formed of two or more pieces of material. The safety cone can optionally include one or more living hinges to facilitate in the folding and unfolding of the safety cone from an unassembled or collapsed position to an assembled-expanded form, and optionally back to a collapsed or unassembled position. The color of the material used to form the safety cone can be orange and white or some other color or combination of colors, or be partially or fully transparent. In one non-limiting embodiment, the safety cone includes a first slotted sheet and a second slotted sheet that are configured to be connected together and detached from one another via the slots in the first and second slotted sheets. In one non-limiting embodiment, the first slotted sheet and/or the second slotted sheet can optionally include reflective tape or a similar reflective adhesive material that provides enhanced visibility of the safety cone when in use. In another non-limiting embodiment, the first slotted sheet and the second slotted sheet can be connected together such that the first slotted sheet is substantially perpendicular to that of the second slotted sheet. In another non-limiting embodiment, one or more tabs on each slotted corrugated plastic sheet can be used to facilitate in connecting together the first and second slotted sheets. In another non-limiting embodiment, the one or more tabs can be configured to fold-down to stabilize the safety cone and maintain the perpendicularity between the slotted sheets. The one or more optional tabs can optionally be connected to the sheet by a living hinge or by some other arrangement (e.g., other type of hinge, etc.). In another non-limiting one or more of the tabs, when used, include a connection tab that can be insertable (e.g., removably insertable, irremovably insertable) into a slot in one or more of the slotted sheets so as to maintain the position of the tabs relative to the slotted sheets when the tabs are folded down and the front end of the tabs is connected to the slotted sheets. In one non-limiting configuration, one of the slotted sheets includes two foldable tabs that each include a connection tab and is absent tab slots, and the other slotted sheet include two tab slots and is absent foldable tabs, thus the slotted sheets are configured differently; however, this is not required. In another non-limiting configuration, the shape and/or size of the two foldable tabs is different. In another non-limiting configuration, the spacing of the two tab slots from the bottom sheet slot are different. In another non-limiting configuration, the bottom of the bottom sheet slot tapers outwardly to provide a widened opening so as to facilitate in connecting together the first and second slotted sheets. In another non-limiting configuration, the top of the top sheet slot tapers outwardly to provide a widened opening so as to facilitate in connecting together the first and second slotted sheets. In another non-limiting embodiment, an opening can be formed by the folding down of one or more tabs on one or more of the slotted sheets so as to facilitate in the movement of the tabs. In another non-limiting embodiment, the first slotted sheet includes a top sheet slot and slot tabs on each side of the upper end of the top sheet slot, and the second slotted sheet includes a bottom sheet slot and a top tab slot. When such slotted sheets are placed together, the bottom sheet slot of the second slotted sheet is slid into the top sheet slot of the first slotted sheet until the slot tabs on the first slotted sheet can be inserted into the top tab slot of the second slotted sheet. The insertion of the slot tabs on the first slotted sheet into the top tab slot of the second slotted sheet can be used to facilitate in maintaining the slotted sheets together when the sheets are connected together. One or both of the slotted sheets can optionally include a logo, warnings, instructions etc. In another non-limiting embodiment, the safety cone can be a) collapsed by separating the first slotted sheet from the second slotted sheet, and then optionally lying flat the slotted sheets together when not in use, or b) folded so that the two slotted sheets lay closely flat to one another while remaining connected to one another.

In another and/or alternative non-limiting aspect of the disclosure, there is provided a foldable holster. The holster can optionally be partially or fully formed of corrugated plastic. The holster can be optionally formed of a single piece of material. The holster can optionally include one or more living hinges to facilitate in the folding and unfolding of the holster from an unassembled or collapsed position to assembled-expanded form, and optionally back to a collapsed or unassembled position. The holster is configured to be mounted to a structure (e.g., an aerial lift cage frame, a wall or fence, box or cage or container, etc.). The holster can be permanently or releasably connected to the structure. In one non-limiting embodiment, the holster includes a contact surface that engages a structure to which the holster is to be connected (e.g., aerial lift cage, fence, wall, or some other structure, etc.). In another non-limiting embodiment, the holster is an open bottom holster that forms an internal compartment that has an open bottom. One or more components of the holster can be connected together by a living hinge to facilitate in the reconfiguring of the holster from the collapsed orientation to the uncollapsed orientation. In another non-limiting embodiment, a plurality of openings or holes can optionally be formed in the contact surface that are configured to receive zip-ties, wire, cord, or other attachment devices that can be used to connect the holster to the structure that the holster is to be connected. The holster can be configured to be collapsible into a substantially flat configuration when not in use. The holster can optionally include a rear flange that is connected to the rear top edge of the holster. The rear flange can optionally include one or more living hinges. The rear flange can optionally include one or more openings or holes that are configured to receive zip-ties, wire, cord, or other attachment devices that can be used to connect the holster to the structure that the holster is to be connected. The rear flange can be used to connect the holster to a structure to which the holster is to be connected e.g., aerial lift cage, fence, wall, rail, or some other structure, etc.). The rear flange can optionally include one or more holes or openings that are configured receive zip-ties, wire, cord, or other attachment devices that can be used to connect the holster to the structure that the holster is to be connected. In one non-limiting embodiment, the holster includes an opening in the bottom of the internal compartment of the holster. In one non-limiting configuration, the holster can be configured to receive one or more pipes, conduits, rods, or other items in one or more compartments in the internal compartment of the holster. The internal compartment can optionally include one or more dividers to form two or more compartments in the internal compartment. The size and/or shape of the two or more compartments, when formed, can be the same or different. As can be appreciated, the bottom on the internal compartment can include a base that partially or fully covers or forms the bottom of the holster. In one non-limiting embodiment, when the holster includes a base that partially or fully forms a closed bottom of the internal compartment, the internal compartment can be configured to receive and contain various items, tools, and instruments. The base can include one or more openings and/or form one or more openings to allow for liquids to drain from the internal compartment; however, this is not required. The number, size and/or shape of one more openings, when used, are not limiting. The shape of the holster is non-limiting. In one non-limiting configuration, the internal compartment has a uniform sized and shaped (e.g., square-shaped, rectangular shaped, triangular-shaped, polygonal shaped, oval shaped, etc.) along most (e.g., greater than 50% of the longitudinal length of the holster) or all of the longitudinal length of the holster. In another non-limiting configuration, the internal compartment has a non-uniform size and/or shape along most (e.g., greater than 50% of the longitudinal length of the holster) or all of the longitudinal length of the holster. In one non-limiting specific configuration, the internal compartment has a non-uniform size and/or shape along most (e.g., greater than 50% of the longitudinal length of the holster) or all of the longitudinal length of the holster, and wherein the cross-sectional area of the internal compartment tapers in size from the top to the bottom of the holster. One or more sides of the holster can optionally include logos, instructions, branding, etc. When the holster includes a base to partially or fully form the bottom of the holster, the top surface of the base can optionally include a protective liner. The protective liner can optionally include a liquid barrier layer that inhibits or prevents liquids to pass fully through the protective liner. The protective liner can be permanently or releasably secured to the top surface of the base of the holster by any number of arrangements (e.g., adhesive, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the base of the holster. As can also be appreciated, the protective liner can be positioned on a portion or all of the inner side wall surfaces of the internal compartment of the holster. The holster can be configured when collapsed to form a substantially flat configuration of the holster when not in use.

In another and/or alternative non-limiting aspect of the disclosure, there is provided a foldable bucket. The bucket can optionally be partially or fully formed of corrugated plastic. The bucket can be optionally formed of a single piece of material. The bucket can optionally include one or more living hinges to facilitate in the folding and unfolding of the bucket from an unassembled or collapsed position to assembled-expanded form, and optionally back to a collapsed or unassembled position. In one non-limiting embodiment, the bucket includes four side walls and a bottom surface that defines an internal compartment. As can be appreciated, the bucket can include less or more than four side walls. One or more of the side walls can be connected together by a living hinge or by one or more connectors (e.g., magnet, snap, hook and loop fasteners, dual lock fasteners, mushroom hook fasteners, zipper, strap, adhesive, rib and groove connection, wire, slot arrangement, rivets, heat melted seam, tie arrangement [e.g., tied with cord, chin, rope, wire, etc.], etc.). A plurality of optional openings or holes can be formed on one or more of the side walls so as to receive an optional strap and handle assembly. In one non-limiting arrangement, the strap and handle can be configured to be positioned at least partially underneath the bottom surface of the bucket to support the structural integrity of the bucket when the bucket is moved and/or when the internal compartment is partially or fully filled with one or more items. As can also be appreciated, more than one strap can be used with the bucket and be at least partially positioned underneath the bottom surface of the bucket. In another non-limiting embodiment, the bottom flaps of the bucket from each side of the bucket are configured to at least partially overlap one another to form the bottom surface. In one embodiment, the one or more flaps can be connected to a bottom of a side wall by a living hinge or by one or more connectors (e.g., magnet, snap, hook and loop fasteners, dual lock fasteners, mushroom hook fasteners, zipper, strap, adhesive, rib and groove connection, wire, slot arrangement, rivets, heat melted seam, tie arrangement [e.g., tied with cord, chin, rope, wire, etc.], etc.). The flaps can be optionally connected together by use of one or more connectors (e.g., magnet, snap, hook and loop fasteners, dual lock fasteners, mushroom hook fasteners, zipper, strap, adhesive, rib and groove connection, wire, slot arrangement, rivets, heat melted seam, tie arrangement [e.g., tied with cord, chin, rope, wire, etc.], etc.). In another non-limiting embodiment, the bucket can optionally be configured to hold a liquid material in the internal compartment. When the bucket is use to hold liquids, a plastic liner or water-proof liner can be inserted into the bucket to inhibit or prevent leakage of liquid from the bucket. In another non-limiting embodiment, the bucket, when assembled, is configured to have an internal compartment volume of at least a 0.25 gallons (e.g., 0.25-20 gallons and all values and ranges therebetween). In another non-limiting embodiment, the cross-sectional shape of the internal compartment is non-limiting (e.g., circular, oval, shape, rectangular, polygonal, etc.). In another non-limiting embodiment, the bucket is configured to be collapsible into a substantially flat configuration when not in use. In another non-limiting embodiment, the bucket can optionally include one or more drainage openings in the bottom surface of the bucket so as to allow liquids to drain from the bottom surface of the bucket and/or facilitate in removing debris from the bottom surface of the bucket. The number, size and/or location of the optional one or more drainage openings is non-limiting. In another non-limiting embodiment, the top surface of the bottom surface of the bucket can optionally include a protective liner. The protective liner can optionally include a liquid barrier layer that inhibits or prevents liquids to pass fully through the protective liner. The protective liner can be permanently or releasably secured to the top surface of the bottom surface of the bucket by any number of arrangements (e.g., adhesive, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the top surface of the bottom surface of the bucket. As can also be appreciated, the protective liner can be positioned on a portion or all of the inner side wall surfaces of the internal compartment of the bucket.

In another and/or alternative non-limiting aspect of the disclosure, there is provided a foldable platform. The platform can optionally be partially or fully formed of corrugated plastic. The platform can be optionally formed of two or more pieces of material. The platform can optionally include one or more living hinges to facilitate in the folding and unfolding of the platform from an unassembled or collapsed position to assembled-expanded form, and optionally back to a collapsed or unassembled position. The body of the platform and the platform top or top surface can be formed of the same or different material. In one non-limiting arrangement, the body of the platform and the platform top or top surface can be formed of the same material (e.g., corrugated plastic, etc.). In another non-limiting arrangement, the body of the platform and the platform top or top surface can be formed of different materials (e.g., body formed of corrugated plastic and top surface formed of particle board sheet or a metal sheet or a wood sheet or a solid plastic sheet, etc.). In another non-limiting embodiment, the platform includes an enclosed, box-like body and a platform top or top surface. The body optionally has four sides; however, it will be appreciated that the body can have a different number of sides. The body optionally includes a plurality of support legs. The height, width, size and shape of the body are non-limiting. In another non-limiting embodiment, the platform further includes an optional strap (e.g., elastomeric strap, standard strap, etc.) that can be used to secure the platform in the unassembled or folded position or collapsed position or substantially flat configuration. The strap can also or alternatively be used to facilitate in the carrying of the platform. The strap can optionally be inserted into optional strap openings in the body. In another non-limiting embodiment, the platform top or top surface is configured to be a separate piece of material from the body and is configured to be removably connected to a top portion of the body. The platform top or top surface is a generally flat and planar surface that can be used to support various items (e.g., paint trays, paint brushes, paint cans, paint accessories, tools, papers, electronic devices, etc.). In another non-limiting embodiment, one or more corners and/or one or more sides of the platform can be optionally raised. The use of the optional raised corner and/or raised edges can be used to facilitate in maintaining items on the platform top or top surface, and/or be used to facilitate in maintaining the platform top or top surface on the body when the platform is fully assembled. The optional raised corners and/or raised edges can extend partially or fully about the perimeter of the platform top or top surface when the platform is fully assembled. The height of the optional raised corners and/or edges is non-limiting (e.g., 0.1-4 inches and all values and ranges therebetween). The platform top or top surface can optionally include one or more side flanges that are configured to fit partially or fully between the optional raised corners and/or raised edges so as to facilitate in maintaining the position of the platform top or top surface to the body when the platform is fully assembled. The upper surface of the platform top or top surface can optionally include a protective liner. The protective liner can optionally include a liquid barrier layer that inhibits or prevents liquids to pass fully through the protective liner. The protective liner can be permanently or releasably secured to the upper surface of the platform top or top surface by any number of arrangements (e.g., adhesive, magnet, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the upper surface of the platform top or top surface. As can also be appreciated, the protective liner can be positioned on a portion or all of the optional raised corners and/or raised edges, and/or other portions of the body.

In another and/or alternative non-limiting aspect of the disclosure, there is provided a foldable ladder caddy. The ladder caddy can optionally be partially or fully formed of corrugated plastic. The ladder caddy can be optionally formed of a single piece of material or a plurality of pieces of material. The ladder caddy can optionally include one or more living hinges to facilitate in the folding and unfolding of the ladder caddy from an unassembled or collapsed position to assembled-expanded form, and optionally back to a collapsed or unassembled position. The ladder caddy is configured to be removably connected to a top portion of a ladder. As can be appreciated, the ladder caddy can be connected to other structures, thus is not limited to only connecting to a ladder. In another non-limiting embodiment, the ladder caddy is a closed bottom ladder caddy that forms an internal compartment. In one non-limiting embodiment, the ladder caddy includes a support member coupled to a trough. In one non-limiting embodiment, the support member is connected to a top edge of the trough (e.g., connected together by a living hinge, etc.); however, this is not required. The support member partially or fully forms a ladder opening that receives a top portion of a ladder. In one non-limiting arrangement, the support member and the trough form the ladder opening. In another non-limiting arrangement, the support member fully forms the ladder opening. The ladder opening can optionally include one of more stability flanges that are configured to facilitate in stabilizing and/or securing the ladder caddy to the top portion of the ladder. The ladder opening can include one or more flanges about the ladder opening that can extend upwardly or downwardly from the ladder opening to facilitate in the rigidity and/or strength of the region about the ladder opening and/or facilitate in stabilizing the ladder caddy on the top portion of the ladder. The back end of the support member can optionally include an upwardly or downwardly oriented flange to facilitate in the rigidity and/or strength of the back region of the support member. The ladder caddy can optionally include one or more preformed creases to facilitate in the bending, assembly of the ladder caddy, and/or mounting of the ladder caddy to a ladder. One or more holes or apertures can optionally be formed in the support member that can receive tools, utensils, instruments, and other similar items. As can be appreciated, the one or more holes or apertures can be used to facilitate in securing the ladder caddy to the top portion of the ladder by one or more connection arrangements (e.g., zip-ties, wire, cord, or other attachment devices). The one or more holes or apertures can be optionally positioned about the ladder opening. The size, shape, location, configuration and/or number of holes or apertures are not non-limiting. The trough of the ladder caddy typically has a closed bottom that can hold various items, tools, accessories, and utensils. In one non-limiting embodiment, the trough of the ladder caddy can support at least 1 lbs. (e.g., 1-100 lbs. and all values and ranges therebetween) of items, tools, and equipment. The trough of the ladder caddy can optionally include one or more bottom openings that can be used to drain liquids from the trough. The number, location, and size of the openings, when used, is non-limiting. In one non-limiting embodiment, the ladder caddy can fold down to 5-100 in. long (and all values and ranges therebetween), 2-25 in. wide (and all values and ranges therebetween), and 0.25-4 in. thick (and all values and ranges therebetween). It is to be understood that the ladder caddy is not limited for use with only ladders. One or more portions or all of the interior surface of the trough can optionally include a protective liner. The protective liner can optionally include a liquid barrier layer that inhibits or prevents liquids to pass fully through the protective liner. The protective liner can be permanently or releasably secured to the interior surface of the trough by any number of arrangements (e.g., adhesive, snap, magnet, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the interior surface of the trough.

In another and/or alternative non-limiting aspect of the disclosure, there is provided a drop-cloth assembly that comprises a corrugated plastic sheet and one or more drop-cloths. In one non-limiting embodiment, optional pre-formed perforations/fold lines are formed in the corrugated plastic sheet to aid in the folding and unfolding of the corrugated plastic sheet. In another non-limiting embodiment, the corrugated plastic sheet optionally includes a strap having an optional buckle. To assemble the drop-cloth assembly, in accordance with one non-limiting embodiment, (i) the corrugated plastic sheet is laid out flat; (ii) the one or more drop-cloths are bundled around the flat, corrugated plastic sheet; (iii) the corrugated plastic sheet having the drop-cloths is thereafter folded and secured via the strap and the optional buckle. The strap may or may not be an elastic strap, and (iv) one or multiple drop-cloth assemblies can optionally be placed in a bin.

In another and/or alternative non-limiting aspect of the disclosure, there is provided a drop-cloth assembly comprising a corrugated plastic sheet having strap handles and one or more drop-cloths. In one non-limiting embodiment, the corrugated plastic sheet can optionally include pre-formed perforations/fold lines to aid in the folding and unfolding of the plastic corrugated sheet. In another non-limiting embodiment, the corrugated plastic sheet includes a strap having an optional buckle. The strap may or may not be an elastic strap. To assemble the drop-cloth assembly, in accordance with one non-limiting embodiment, (i) the corrugated plastic sheet is laid out flat; (ii) one or more drop-cloths are placed on the flat, corrugated plastic sheet; (iii) the one or more drop-cloths are bundled and fastened within the corrugated plastic sheet, and (iv) the drop-cloth assembly is optionally placed in a bin. As can be appreciated, the drop-cloth assembly can be used to carry items other than drop cloths (e.g., rolls of plastic sheeting, paper rolls, etc.).

In another and/or alternative non-limiting aspect of the disclosure, there is provided a foldable work tray. The work tray can optionally be partially or fully formed of corrugated plastic. The work tray can be optionally formed of a single piece of material or a plurality of pieces of material. The work tray can optionally include one or more living hinges to facilitate in the folding and unfolding of the work tray from an unassembled or collapsed position to assembled-expanded form, and optionally back to a collapsed or unassembled position. In one non-limiting embodiment, a plurality of connectors (e.g. snaps, magnet, hook and loop fasteners, dual lock fasteners, mushroom hook fasteners, rib and slot arrangement, adhesive, rivets, heat melted seam, zipper, tie arrangement [e.g., tied with cord, chin, rope, wire, etc.], etc.) can be positioned at one or more corners or corner flaps of the work tray so as to be connect together portions of the work tray and form the assembled work tray. The connectors that are located on the corners or corner flaps can be optionally configured to engage one another when the work tray is in the unassembled or folded position or collapsed position to hold the work tray flat. The connectors that are located on the corners or corner flaps can also or alternatively be configured to engage one another when the work tray is in the unfolded or assembled-expanded configuration to hold the work tray in the unfolded or assembled position. In another non-limiting embodiment, one or more handle openings are optionally formed in one or more of the side walls of the work tray to facilitate in the moving and/or carrying of the work tray. One or more reinforcement layers can optionally be positioned about a portion or all of the one or more handle openings to facilitate in strengthening the region about the handle openings, to provide improved gripping about the one or more handle openings, to facilitate in protecting the one or more handle openings from damage, etc. The material used to form the reinforcement layer is non-limiting (e.g., paper, nylon, fabric, polyester, plastic, metal, etc.), and the method for securing the one or more reinforcement layers about the one or more handle openings is also non-limiting (e.g., adhesive, magnet, melted seam or connection, snap, hook and loop fasteners, dual lock fasteners, mushroom hook fasteners, etc.). In another non-limiting embodiment, the work tray optionally further includes a plurality of pre-formed perforations/fold lines that aid in the assembly and flattening of the work tray. In another one non-limiting embodiment, the work tray is at least 5 inches long, at least 2 inches wide, and the side walls, when assembled, are at least 2 inches long. The shape of the work tray is typically polygonal (e.g., square, rectangular, etc.). In another non-limiting embodiment, the work tray can optionally include one or more drainage openings that can be used to allow liquids that have collected in the bottom of the work tray to flow out of the work tray. The number, shape, size and/or location of the optional one or more drainage openings are non-limiting. In another non-limiting embodiment, the top surface of the base of the work tray can optionally include a protective liner. The protective liner can optionally include a liquid barrier layer that inhibits or prevents liquids to pass fully through the protective liner. The protective liner can be permanently or releasably secured to the top surface of the base of the work tray by any number of arrangements (e.g., adhesive, magnet, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the top surface of the base of the work tray. As can also be appreciated, the protective liner can be positioned on a portion or all of the inner side wall surfaces of the work tray.

In another and/or alternative non-limiting aspect of the disclosure, there is provided a cargo tray. The cargo tray can be configured to be positioned in a seat of a vehicle, trunk of a vehicle, cargo bay of a vehicle, truck bed of a vehicle, etc. Depending on the location that the cargo tray is to be used, the shape and size of the cargo tray can be appropriately configured for such use location. In one non-limiting embodiment, the cargo tray can optionally be partially or fully formed of corrugated plastic. The cargo tray can be optionally formed of a single piece of material or a plurality of pieces of material. The cargo tray can optionally include one or more living hinges to facilitate in the folding and unfolding of the cargo tray from an unassembled or collapsed position to assembled-expanded form, and optionally back to a collapsed or unassembled position. In one non-limiting embodiment, a plurality of connectors (e.g. snaps, magnet, hook and loop fasteners, dual lock fasteners, mushroom hook fasteners, rib and slot arrangement, adhesive, rivets, heat melted seam, zipper, tie arrangement [e.g., tied with cord, chin, rope, wire, etc.], etc.) can be positioned at one or more corners or corner flaps of the cargo tray to connect together portions of the cargo tray and form the assembled cargo tray. The connectors that are located on the corners or corner flaps can be optionally configured to engage one another when the cargo tray is in the unassembled or folded position or collapsed position to hold the cargo tray flat. The connectors that are located on the corners or corner flaps can also or alternatively be configured to engage one another when the cargo tray is in the unfolded or assembled-expanded configuration to hold the cargo tray in the unfolded or assembled position. In another non-limiting embodiment, one or more handle openings are optionally formed in one or more of the side walls of the cargo tray to facilitate in the moving and/or carrying of the cargo tray. One or more reinforcement layers can optionally be positioned about a portion or all of the one or more handle openings to facilitate in strengthening the region about the handle openings, to provide improved gripping about the one or more handle openings, to facilitate in protecting the one or more handle openings from damage, etc. The material used to form the reinforcement layer is non-limiting (e.g., paper, nylon, fabric, polyester, plastic, metal, etc.), and the method for securing the one or more reinforcement layers about the one or more handle openings is also non-limiting (e.g., adhesive, magnet, melted seam or connection, snap, hook and loop fasteners, dual lock fasteners, mushroom hook fasteners, etc.). In another non-limiting embodiment, the cargo tray optionally further includes a plurality of pre-formed perforations/fold lines that aid in the assembly and flattening of the cargo tray. In another non-limiting embodiment, the cargo tray is at least 5 inches long, at least 2 inches wide, and the side walls, when assembled, are at least 2 inches long. The shape of the cargo tray is typically polygonal (e.g., square, rectangular, etc.). In another non-limiting embodiment, the cargo tray can optionally include one or more drainage openings that can be used to allow liquids that have collected in the bottom of the cargo tray to flow out of the cargo tray. The number, shape, size and/or location of the optional one or more drainage openings are non-limiting. In another non-limiting embodiment, the top surface of the base of the cargo tray can optionally include a protective liner. The protective liner can optionally include a liquid barrier layer that inhibits or prevents liquids to pass fully through the protective liner. The protective liner can be permanently or releasably secured to the top surface of the base of the cargo tray by any number of arrangements (e.g., adhesive, magnet, snap, hook and loop fasteners, dual lock fasteners, mushroom hook fasteners, zipper, strap, rib and groove connection, etc.). The color and thickness of the protective liner, when used, is non-limiting. As can be appreciated, the protective liner can be sized to fully overlie or partially overlie (e.g., overlie 5%-99.00% and all values and ranges therebetween) the top surface of the base of the cargo tray. As can also be appreciated, the protective liner can be positioned on a portion or all of the inner side wall surfaces of the cargo tray. In another non-limiting embodiment, the cargo tray optionally includes a plurality of pre-formed perforations/fold lines that aid in the assembly and flattening of the cargo tray. In another non-limiting embodiment, one or more side walls and/or corner flaps can optionally include a connection arrangement (e.g., rings, clips, tether, cords, openings, etc.) that can be used to facilitate in securing the cargo tray to a seat of a vehicle, trunk of a vehicle, cargo bay of a vehicle, truck bed of a vehicle, etc. In another non-limiting embodiment, one or more corners and/or side walls can optionally include a connection arrangement (e.g., slot, opening, connection ring, connection clip, recessed region, attached cord, etc.) to facilitate in connecting the cargo tray to a seat of a vehicle, trunk of a vehicle, cargo bay of a vehicle, truck bed of a vehicle, etc. In another non-limiting embodiment, one or more of the side walls of the cargo tray can optionally include one or more recessed regions on a top edge of the one or more side walls is configured to receive a portion of a seat belt to facilitate in securing the cargo tray of a seat of a vehicle, trunk of a vehicle, cargo bay of a vehicle, truck bed of a vehicle, etc. In another non-limiting embodiment, the bottom of the cargo tray can optionally include one or more grip strips to facilitate in maintaining the cargo tray in position while located on a seat of a vehicle, trunk of a vehicle, cargo bay of a vehicle, truck bed of a vehicle, etc. The one or more grip strips are typically made of a different composition or material (e.g., rubber, synthetic rubber, gripping tape, gripping adhesive, gripping material, etc.) from the material use to form the cargo tray (e.g., corrugated plastic sheets). In another non-limiting embodiment, one or more side walls of the cargo tray can have a height that is different from one or more other walls. In one non-limiting specific arrangement, one or more of the side walls are higher than the from or back wall. In another non-limiting specific arrangement, the back wall of the cargo tray is the tallest wall of the cargo tray. In another non-limiting specific arrangement, the height ratio of the back wall to the front wall is 1.1:1 to 10:1 (and all values and ranges therebetween). In another non-limiting specific arrangement, the side walls optionally progressively increase in height from the front wall to the back walls. In another non-limiting embodiment, one or more of the corner flaps include one or more connection arrangement (e.g., snaps arrangement, etc.). The one or more connection arrangements are optionally configured to releasable secure together one or more corner flaps. Such a feature allows a user, when needed, to disconnect the connection arrangement to allow the front wall and/or back wall to be pushed back or forward so as to lay closely or fully flat with the bottom surface of a surface that the cargo tray is positioned on (e.g., a vehicle, trunk of a vehicle, cargo bay of a vehicle, truck bed of a vehicle, etc.). The ability to flatten or partially flatten the front and/or back wall thus allow items such as poles, shovels, and other larger items that have a size that cannot fit within the assembled cargo tray to be at least partially laid in a portion of the cargo tray when one or more connectors are disconnected or disengaged to allow the front wall and/or back wall to lay closely or fully flat with the bottom surface of the cargo tray. Once such larger items are removed from the cargo tray, the one or more connectors are to be reconnected so as to once again fully assemble the cargo tray. Such a feature to increase the versatility of the cargo tray to at least partially protect a seat of a vehicle, trunk of a vehicle, cargo bay of a vehicle, truck bed of a vehicle, etc. from damage from larger items placed in the seat of a vehicle, trunk of a vehicle, cargo bay of a vehicle, truck bed of a vehicle, etc. In another non-limiting embodiment, when the cargo tray is positioned in the seat of a vehicle, trunk of a vehicle, cargo bay of a vehicle, truck bed of a vehicle, etc., the cargo tray can be optionally secured in position in the seat of a vehicle, trunk of a vehicle, cargo bay of a vehicle, truck bed of a vehicle, etc. to inhibit or prevent the cargo tray from sliding on the seat of a vehicle, trunk of a vehicle, cargo bay of a vehicle, truck bed of a vehicle, etc. while the vehicle is driven. In one non-limiting embodiment, one or more of the corner flaps can include one or more mount arrangements. In one non-limiting configuration, the end portion of one or more corner flaps can optionally include an opening so that one portion of a tether, cord, wire, bungee cord, chain, strap, etc. can be connected to the corner flaps and/or another portion of the tether, cord, wire, bungee cord, chain, strap, etc. can be connected using end clip to the vehicle to thereby temporarily secure the cargo tray in position in the vehicle. As can be appreciated, connection arrangements other than openings (e.g., rings, clips, mounted cords, mounted straps, loops, handles, etc.) can be positioned on the corner flaps and/or other side walls of the cargo tray for use in temporarily securing the cargo tray in position in the vehicle. As can be appreciated, one or more walls can include one or more openings that can be used to facilitate in securing the mounted cords, mounted straps, loops, etc. to the cargo tray. In another non-limiting arrangement, one or more of the corner flaps can be moveably (e.g., pivotally connected to the corners, etc.) connected to or about the corner so that corner flap is movable relative to side walls, front wall, back wall and/or a portion of the corner flap. The movement of one or more of the corner flaps allows the cargo tray to be positioned in different width vehicle trunks, cargo bays or truck beds. The one or more moveable of corner flaps can be configured to be pivoted, bent, moved, etc. as required so that the cargo tray can be positioned in a desired location in a vehicle. The bendability of one or more of the corner flaps is a significant advantage over pre-molded plastic trays that have a single non-altering size.

In one non-limiting object of the present disclosure is the provision of expandable, foldable, collapsible and reusable storage bins, organizers, caddies, safety cones, and accessories for vehicles, for work sites, and and/or for aerial lifts that are optionally partially or fully made from plastic materials such as, but not limited to plastic corrugated materials, and which storage bins, organizers, caddies, safety cones, and accessories can optionally include a protective liner.

In another non-limiting object of the present disclosure is the provision of a collapsible corner caddy comprising a body and first and second side flanges; the body includes first and second side walls, a back wall and a bottom wall that form an internal compartment; the first side wall is connected to the back wall by a first living hinge; the second side wall is connected to the back wall by a second living hinge; the first and second side walls are connected together by a first connector; the bottom wall is connected to the back wall by a bottom living hinge; a living hinge is absent between the bottom wall and the first and second side walls; the first side flange is connected to the first side wall by a first side living hinge; the second side flange is connected to the second side wall by a second side living hinge; the first side flange is bendable between a flat configuration and a generally L-shaped configuration; the second side flange is bendable between a flat configuration and a generally L-shaped configuration; the first and second side flanges are spaced from one another when the corner caddy is in both a generally unfolded flat configuration and an assembled-expanded configuration; and wherein the corner caddy is collapsable to the generally unfolded flat configuration from the assembled-expandable configuration, and wherein the internal compartment has a generally triangular cross-sectional shape when the body is in the expanded configuration.

In another non-limiting object of the present disclosure is the provision of a collapsible corner caddy wherein the body and the first and second side flanges are formed form a single piece of corrugated plastic.

In another non-limiting object of the present disclosure is the provision of a collapsible corner caddy wherein the internal compartment includes at least one drainage opening that is at least partially formed by the bottom wall.

In another non-limiting object of the present disclosure is the provision of a collapsible corner caddy further including a bottom flange; the bottom flange is connected to the first side wall by a first bottom living hinge and is connected to the second side wall by a second bottom living hinge; a living hinge is absent between the back wall and the bottom flange.

In another non-limiting object of the present disclosure is the provision of a collapsible corner caddy wherein the bottom flange includes a bottom rib that extends downwardly from a bottom surface of the bottom flange; the bottom flange includes a bottom flange living hinge that facilitates in folding the bottom flange in half when the corner caddy is folded to from the assembled-expanded configuration to the generally unfolded flat configuration.

In another non-limiting object of the present disclosure is the provision of a collapsible corner caddy wherein a connected portion of the first and second side walls forms a cavity flange that extends inwardly into an internal compartment when the corner caddy is in the expanded configuration.

In another non-limiting object of the present disclosure is the provision of a collapsible corner caddy further including a protective liner in a bottom of the internal compartment.

In another non-limiting object of the present disclosure is the provision of a collapsible corner caddy further including at least one connector opening positioned on one or more structures selected from the group consisting of the first side wall, the second side wall, the first side flange and the second side flange; the at least one connector opening configured to be used with a connection device to secure the corner caddy to a structure.

In another non-limiting object of the present disclosure is the provision of a collapsible corner caddy wherein the back wall includes a back wall living hinge that facilitates in folding the back wall in half when the corner caddy is folded or collapsed from the assembled-expanded configuration to the unfolded flat configuration.

In another non-limiting object of the present disclosure is the provision of a collapsible pipe rack that is configured to be folded between an unfolded flat configuration and an assembled-expanded configuration; the pipe rack comprises a body that includes first and second support members, first and second end walls, and a base wall; the body forms an internal pipe rack compartment when the collapsible pipe rack is in an expanded and assembled-expanded configuration; the first support member is connected to the first and second end walls by a first and second side living hinge; the second support member is connected to the first and second end walls by the third and fourth side living hinge; the first end wall is connected between the first and second support members; the second end wall is connected between the first and second support members; the first and second end walls are spaced from one another; the first and second support members are spaced from one another; the base wall is connected to the first support member; the base wall is not connected to the second support member, and the first and second end walls; and wherein a front portion of the base wall is configured to extend outwardly from the second support member when the pipe rack is in the expanded and assembled-expanded configuration.

In another non-limiting object of the present disclosure is the provision of a collapsible pipe rack wherein the first support member includes a plurality of pieces of corrugated plastic; the first and second end walls each include a plurality of pieces of the corrugated plastic.

In another non-limiting object of the present disclosure is the provision of a collapsible pipe rack wherein a width of the base wall is less than a width between the first and second end walls.

In another non-limiting object of the present disclosure is the provision of a collapsible pipe rack wherein first support member includes first and second rear flanges; the first and second rear flanges are each connected to the first support member by first and second flange living hinges; and wherein the first and second rear flanges are configured to extend rearwardly of the first support member when the pipe rack is in the expanded and assembled-expanded configuration.

In another non-limiting object of the present disclosure is the provision of a collapsible pipe rack wherein a bottom edge of the first and second end walls, and a bottom edge of a mid-portion of the first support member are located between a bottom surface of the first and second rear flanges when the pipe rack is in the expanded and assembled-expanded configuration.

In another non-limiting object of the present disclosure is the provision of a collapsible pipe rack further including a protective liner on an outer surface of at least a portion of the body.

In another non-limiting object of the present disclosure is the provision of a collapsible pipe rack further including at least one connector opening positioned on the base wall.

In another non-limiting object of the present disclosure is the provision of a collapsible pipe rack further including at least one connector opening positioned on each of the first and second rear flanges.

In another non-limiting object of the present disclosure is the provision of a collapsible pipe rack wherein a top surface of each of first and second support members forms a support surface; a midportion of each of the support surface of the first and second support members has a U-shape or semi-circular shape.

In another non-limiting object of the present disclosure is the provision of a collapsible pipe rack wherein a mid-portion of a bottom of the second support member includes a recessed region; the recessed region is configured to receive a portion of the base wall when the pipe rack is in the expanded and assembled-expanded configuration; and wherein a bottom edge of the second support member on each side of the recessed region is located below a bottom surface of the base wall when the pipe rack is in the expanded and assembled-expanded configuration.

In another non-limiting object of the present disclosure is the provision of a collapsible pipe rack wherein each of the first and second end walls include an opening for use with a connector and includes an elastic portion and a connection end; a size and shape of the opening on the first and second end walls is the same; a first end of the connector is connected to the opening in the first end wall; the connector is configured to include in length so that the connection end can be inserted into and be releasably maintained in the opening in the second end wall.

In another non-limiting object of the present disclosure is the provision of a collapsible trough that is configured to be folded between an unfolded flat configuration and an assembled-expanded configuration; the trough comprises a body that includes front wall, a back wall, first and second side walls, and a bottom wall; the body forms an internal trough compartment when the trough is in the expanded and assembled-expanded configuration; the front wall is connected to the first side wall by a first side living hinge; the front wall is connected to the second side wall by a second side living hinge; the bottom wall is connected to front wall and the back wall by first and second bottom living hinges; the bottom wall is not connected to the first and second side walls; the first side wall includes a first body portion, a first side flange and a first side living hinge that connects the first side flange to the first body portion; the second side wall includes a second body portion, a second side flange and a second side living hinge that connects the second side flange to the second body portion; the first side flange is connected to the back wall; the second side flange is connected to the back wall.

In another non-limiting object of the present disclosure is the provision of a collapsible trough wherein the body is formed of a single piece of corrugated plastic.

In another non-limiting object of the present disclosure is the provision of a collapsible trough further including a protective liner in the internal trough compartment.

In another non-limiting object of the present disclosure is the provision of a collapsible trough further including at least one connector opening positioned on the back wall.

In another non-limiting object of the present disclosure is the provision of a collapsible trough further including a rear flange that is connected to a top edge of the back wall by a back wall living hinge; the rear flange having a height that is less than a height of the back wall; the rear flange including one or more flange connectors that connects a body of the rear flange to an outer surface of the back wall; the one or more flange connectors are spaced from the back wall living hinge.

In another non-limiting object of the present disclosure is the provision of a collapsible trough further including at least one connector opening positioned on the rear flange.

In another non-limiting object of the present disclosure is the provision of a collapsible trough wherein each of the first and second side walls each include a side living hinge that facilitates in folding each of the first and second side walls in half when the trough is folded from the assembled-expanded configuration to the unfolded flat configuration.

In another non-limiting object of the present disclosure is the provision of a collapsible trough wherein the bottom wall includes a plurality of living hinges.

In another non-limiting object of the present disclosure is the provision of a collapsible trough wherein the bottom wall includes one or more drainage openings; the one or more drainage openings fully formed in the bottom wall or partially formed by the bottom wall.

In another non-limiting object of the present disclosure is the provision of a collapsible safety cone that includes a first and second slotted sheet; the first and second slotted sheets are configured to be releasably connected together to form the safety cone; the first slotted sheet includes a top slot that extends to a top edge of the first slotted sheet and extends at least 20% of a longitudinal length of the first slotted sheet; the first slotted sheet includes first and second connection flanges that are positioned in a top sheet opening that is located below and spaced from the top slot; the first and second connection flanges are each connected to a portion of the first slotted sheet by a living hinge that is located at the bottom edge of the top sheet opening; the first and second connection flanges are configured to independently move with respect to one another; the second slotted sheet includes a bottom slot that extends to a bottom edge of the second slotted sheet and extends at least 20% of a longitudinal length of the second slotted sheet; the second slot includes first and second side slots; the first side slot is positioned on an opposite side of the bottom slot from the second side slot; each of the first and second side slots are spaced from the bottom slot, the bottom edge of the second slotted sheet, and side edges of the second slotted sheet; and wherein the top slot of the first slotted sheet is configured to receive the bottom slot of the second slotted sheet when the first and second slotted sheets are releasably connected together to form the safety cone; and wherein the first flange of the first slotted sheet is configured to releasably connect to the first side slot of the second slotted sheet when the first and second slotted sheets are releasably connected together to form the safety cone; and wherein the second flange of the first slotted sheet is configured to releasably connect to the second side slot of the second slotted sheet when the first and second slotted sheets are releasably connected together to form the safety cone; and wherein the first and second connection flanges of the first slotted sheet are each configured to bend about the living hinge to enable the first and second connection flanges to be releasably connected to the second slotted sheet.

In another non-limiting object of the present disclosure is the provision of a collapsible safety cone wherein each of the first and second slotted sheets are formed of corrugated plastic.

In another non-limiting object of the present disclosure is the provision of a collapsible safety cone wherein a top portion of the top slot of the first slotted sheet and a bottom portion of the bottom slot of the second slotted sheet each include an outwardly flaring portion.

In another non-limiting object of the present disclosure is the provision of a collapsible safety cone wherein each of the first and second connection flanges includes a flange tab that are configured to pass partially or fully through the first and second side slots on the second slotted sheet.

In another non-limiting object of the present disclosure is the provision of a collapsible safety cone wherein the first and second connection flanges do not fully cover the top sheet opening when the first slotted sheet is in a flat configuration.

In another non-limiting object of the present disclosure is the provision of a collapsible safety cone wherein the second slotted sheet includes an upper slot that is positioned above and spaced from the bottom slot; a longitudinal length of the upper slot is less than a longitudinal length of the bottom slot; the first slotted sheet includes; the at least one top slot tab is connected to a portion of the first slotted sheet by a living hinge; the at least one top tab is spaced from the top edge of the first slotted sheet; the at least one top slot tab is configured to lie in a same flat plane as the first slotted sheet when the first slotted sheet is in a flat configuration; the at least one top slot tab is configured to be releasably connected in the upper slot when the first and second slotted sheets are releasably connected together to form the safety cone.

In another non-limiting object of the present disclosure is the provision of a collapsible safety cone wherein a spacing of the first side slot from the bottom slot is different from a spacing of the second side slot from the bottom slot.

In another non-limiting object of the present disclosure is the provision of a collapsible safety cone wherein a size of the first connection flange is larger than a size of the second connection flange.

In another non-limiting object of the present disclosure is the provision of a collapsible safety cone wherein one or both of the first and second slotted sheets includes one or more of reflective tape, reflective material, logo, instructions, and/or branding.

In another non-limiting object of the present disclosure is the provision of a collapsible safety cone further including one or more weights connected to a) the first second slotted sheet at a location at or below a bottom edge of the top sheet opening, and/or b) the second slotted sheet at a location at or below a bottom edge of the first and/or second side slots.

In another non-limiting object of the present disclosure is the provision of a collapsible holster that is configured to be folded between an unfolded flat configuration and an assembled-expanded configuration; the holster comprises a body that includes front wall, a back wall, and first and second side walls; the body forms an internal holster compartment when the holster is in the expanded and assembled-expanded configuration; the front wall is connected to the first side wall by a first side living hinge; the front wall is connected to the second side wall by a second side living hinge; the collapsible holster includes three or more features selected from the group consisting of a) the body is absent a bottom wall such that the internal holster compartment is open at both a top end and bottom end of the internal holster compartment, b) the front wall has a height that is less than a height of the back wall, c) the first and second side walls include one or more living hinges, d) the front wall and the back wall having a rhombus shape, e) the front wall and the back wall each have a rectangular shape, and f) a rear flange that is connected to the back wall and the rear flange includes at least one hinge to form a first and second portions of the rear flange.

In another non-limiting object of the present disclosure is the provision of a collapsible holster wherein the body is formed of a single piece of corrugated plastic.

In another non-limiting object of the present disclosure is the provision of a collapsible holster further including a protective liner in the internal holster compartment.

In another non-limiting object of the present disclosure is the provision of a collapsible holster further including at least one connector opening positioned on the back wall.

In another non-limiting object of the present disclosure is the provision of a collapsible holster further including a rear flange that is connected to the back wall; the rear flange includes one or more features selected from the group consisting of a) the rear flange is connected to the back wall by one or more flange connectors, b) the rear flange is connected to the back wall by a living hinge, and c) the rear flange includes the first and second portions that are connected together by a rear flange living hinge.

In another non-limiting object of the present disclosure is the provision of a collapsible holster further including at least one connector opening positioned on the rear flange.

In another non-limiting object of the present disclosure is the provision of a collapsible holster wherein each of the first and second side walls each include a side living hinge that facilitates in folding each of the first and second side walls in half when the trough is folded from the assembled-expanded configuration to the unfolded flat configuration.

In another non-limiting object of the present disclosure is the provision of a collapsible holster wherein each of the first and second side walls includes a U-Shaped or C-shaped top edge profile in the top mid-region of the first and second side walls.

In another non-limiting object of the present disclosure is the provision of a collapsible holster wherein each of the front wall and the back wall have the trapezoidal shape; a length of the top edge of each of the front wall and the back wall is longer than a length of the bottom edge of each of the front wall and the back wall.

In another non-limiting object of the present disclosure is the provision of a collapsible holster wherein the body is absent a bottom wall.

In another non-limiting object of the present disclosure is the provision of a collapsible holster wherein the body includes a bottom wall that covers 80-100% of a bottom of the internal holster compartment when the holster is in the expanded and assembled-expanded configuration.

In another non-limiting object of the present disclosure is the provision of a collapsible holster further including a divider flange that is connected in the internal holster compartment; the divider flange is configured to divided the internal holster compartment into two or more compartments when the holster is in the expanded and assembled-expanded configuration.

In another non-limiting object of the present disclosure is the provision of a collapsible holster wherein the divider flange is connected to the front wall and the back wall.

In another non-limiting object of the present disclosure is the provision of a collapsible bucket that is configured to be folded between an unfolded flat configuration and an assembled-expanded configuration; the bucket comprises a body and a support strap; the body includes front wall, a back wall, and first and second side walls; the body forms an internal bucket compartment when the bucket is in the expanded and assembled-expanded configuration; the body is formed of a single piece of material; the front wall is connected to the first side wall by a first side living hinge; the first side wall is connected to the back wall by a living hinge, the back wall is connected to the second side wall by a living hinge; the second side wall is connected to the first side wall by one or more releasable connectors; a bottom of the bucket is formed of a plurality of bottom flaps that are folded together when the bucket is in the assembled-expanded configuration; each of the bottom flaps is connected by a living hinge to a bottom edge of one of the front wall, the back wall, the first side wall or the second side wall; a portion of the support strap is configured to be positioned on a bottom surface of the bottom of the bucket so as to facilitate in maintaining the bottom flaps in a folded together configuration when the bucket is in the expanded and assembled-expanded configuration; the collapsible bucket includes two or more features selected from the group consisting of a) two or more of the bottom flaps have a different size and configuration, b) two or more of the bottom flaps have a different size and configuration and two of the bottom flaps have the same size and configuration, c) the front wall and the back wall each include two strap openings that are configured to receive a portion of the support strap, and d) the first side wall and the second side wall each include two strap openings that are configured to receive a portion of the support strap.

In another non-limiting object of the present disclosure is the provision of a collapsible bucket wherein the body is formed of a single piece of corrugated plastic.

In another non-limiting object of the present disclosure is the provision of a collapsible bucket further including a protective liner in the internal holster compartment.

In another non-limiting object of the present disclosure is the provision of a collapsible bucket further including a handle that is connected to the strap; the handle includes an internal cavity wherein the strap is positioned therein.

In another non-limiting object of the present disclosure is the provision of a collapsible platform that is configured to be folded between an unfolded flat configuration and an assembled-expanded configuration; the platform comprises a body and top board; the body includes front wall, a back wall, and first and second side walls; the body is formed of a single piece of material; the front wall is connected to the first side wall by a first side living hinge; the first side wall is connected to the back wall by a living hinge, the back wall is connected to the second side wall by a living hinge; the second side wall is connected to the first side wall by one or more releasable connectors; the collapsible platform includes two or more features selected from the group consisting of a) the first and second side walls includes a living hinge that allow a portion of each of the first and second side walls to be folded over one another, b) each of the front and back wall include a plurality of upwardly extending support legs and a recessed region positioned between at least two adjacently positioned upwardly extending support legs, and wherein the top board includes a plurality of support flanges that are positionable between adjacently positioned upwardly extending support legs when the top board is positioned on the body when the platform is in the assembled-expanded configuration, c) each of the first and second side walls include a plurality of upwardly extending support legs and a recessed region positioned between at least two adjacently positioned upwardly extending support legs, and wherein the top board includes a plurality of support flanges that are positionable between adjacently positioned upwardly extending support legs when the top board is positioned on the body when the platform is in the assembled-expanded configuration, d) each of the front and back walls include a plurality of downwardly extending legs, and e) each of the first and second side walls include a plurality of upwardly extending support legs,

In another non-limiting object of the present disclosure is the provision of a collapsible platform wherein the body is formed of a single piece of corrugated plastic and the top board is formed of a piece of material that is separate from the body.

In another non-limiting object of the present disclosure is the provision of a collapsible platform wherein a top surface of the top board includes a protective liner.

In another non-limiting object of the present disclosure is the provision of a collapsible platform further including an elastic strap that is connected to the body.

In another non-limiting object of the present disclosure is the provision of a collapsible ladder caddy that is configured to be folded between an unfolded flat configuration and an assembled-expanded configuration; the ladder caddy comprises a ladder trough and a ladder support member; the ladder trough includes front wall, a back wall, first and second side walls, and a bottom wall; the body forms an internal trough compartment when the ladder caddy is in the expanded and assembled-expanded configuration; the front wall is connected to the first side wall by a first side living hinge; the front wall is connected to the second side wall by a second side living hinge; the bottom wall is connected to front wall and the back wall by first and second bottom living hinges; the bottom wall is not connected to the first and second side walls; the first side wall includes a first body portion, a first side flange and a first side living hinge that connects the first side flange to the first body portion; the second side wall includes a second body portion, a second side flange and a second side living hinge that connects the second side flange to the second body portion; the first side flange is connected to the back wall; the second side flange is connected to the back wall; the ladder support is connected to the back wall; the ladder support includes first and second side arms and a rear arm that is connected to the first and second side arms; the first and second side arms are spaced from one another; the rear arm is spaced from the back wall of the ladder trough; the first and second side arms and the rear arm and at least a portion of the ladder trough define a ladder opening.

In another non-limiting object of the present disclosure is the provision of a collapsible ladder caddy wherein the ladder caddy and the ladder support are formed from a same single piece of corrugated plastic.

In another non-limiting object of the present disclosure is the provision of a collapsible ladder caddy further including a protective liner in the internal trough compartment.

In another non-limiting object of the present disclosure is the provision of a collapsible ladder caddy wherein each of the first and second side walls each include a side living hinge that facilitates in folding each of the first and second side walls in half when the ladder caddy is folded from the assembled-expanded configuration to the unfolded flat configuration.

In another non-limiting object of the present disclosure is the provision of a collapsible ladder caddy wherein the bottom wall includes a plurality of living hinges.

In another non-limiting object of the present disclosure is the provision of a collapsible ladder caddy wherein the bottom wall includes one or more drainage openings; the one or more drainage openings fully formed in the bottom wall or partially formed by the bottom wall.

In another non-limiting object of the present disclosure is the provision of a collapsible ladder caddy wherein the first and second side arms are connected by a back arm living hinge to the back wall; the rear arm is connected to the first and second side arms by a living hinge.

In another non-limiting object of the present disclosure is the provision of a collapsible ladder caddy wherein the rear arm forms an upwardly extending flange and a downwardly extending flange when the rear arm is bent downwardly about the back arm living hinge.

In another non-limiting object of the present disclosure is the provision of a collapsible ladder caddy wherein the back wall includes an upwardly extending flange that is located in a mid-portion of the back wall.

In another non-limiting object of the present disclosure is the provision of a collapsible ladder caddy wherein the first and/or second side arms of the ladder support includes one or more openings.

In another non-limiting object of the present disclosure is the provision of a collapsible work tray that is configured to be folded between an unfolded flat configuration and an assembled-expanded configuration; the work tray comprises a body that includes front wall, a back wall, first and second side walls, and a bottom wall; the body forms an internal work tray compartment when the work tray is in the expanded and assembled-expanded configuration; the front wall is connected to the bottom wall by a first bottom living hinge; the back wall is connected to the bottom wall by a back bottom living hinge; the first side wall is connected to the bottom wall by a first bottom side living hinge; the second side wall is connected to the bottom wall by a second bottom side living hinge; the front wall includes front first and second side flanges that are each connected to the first wall by first wall living hinges; the back wall includes back first and second side flanges that are each connected to the back wall by back wall living hinges; the first side wall includes first and second side flanges that are each connected to the first side wall by first side wall living hinges; the second side wall includes second side first and second side flanges that are each connected to the second side wall by second side wall living hinges; adjacently positioned side flanges are connected together by flange living hinges; adjacently positioned side flanges are configured to extend outwardly from a corner of the work tray when in the assembled-expanded configuration.

In another non-limiting object of the present disclosure is the provision of a collapsible work tray wherein the body is formed of a single piece of corrugated plastic.

In another non-limiting object of the present disclosure is the provision of a collapsible work tray further including a protective liner in the internal work tray compartment.

In another non-limiting object of the present disclosure is the provision of a collapsible work tray wherein each of the front wall, the back wall and the bottom wall include a mid-region living hinge that facilitates in folding each of the front wall, the back wall and the bottom wall in half when the work tray is folded from the assembled-expanded configuration to the unfolded flat configuration.

In another non-limiting object of the present disclosure is the provision of a collapsible work tray wherein the bottom wall includes one or more drainage openings; the one or more drainage openings fully formed in the bottom wall or partially formed by the bottom wall.

In another non-limiting object of the present disclosure is the provision of a collapsible work tray wherein each of the first and second side wall includes a handle opening and an opening flange; the opening flange on each of the first and second side walls is connected by a living hinge.

In another non-limiting object of the present disclosure is the provision of a collapsible work tray wherein the adjacently positioned side flanges include one or more connectors that are configured to releasably connect together the adjacently positioned side flanges.

In another non-limiting object of the present disclosure is the provision of a collapsible work tray wherein each of the side flanges have a same shape and a same size.

In another non-limiting object of the present disclosure is the provision of a collapsible work tray wherein a plurality of the side flanges are formed of four edges; a first top edge extends from one of the living hinges on one of the front wall, back wall, first side wall or second side wall; a second bottom edge that extends from the same living hinge; a third edge that is connected along the same living hinge and is connected to a first end of the first top edge and a first end of the second bottom edge and wherein the third edge is non-parallel to both the first top edge and the second bottom edge, and a fourth edge that connects together second ends of the first top edge and second bottom edge and wherein the fourth edge is non-parallel to both the first top edge and the second bottom edge.

In another non-limiting object of the present disclosure is the provision of a collapsible cargo tray that is configured to be folded between an unfolded flat configuration and an assembled-expanded configuration; the cargo tray comprises a body that includes front wall, a back wall, first and second side walls, and a bottom wall; the body forms an internal cargo tray compartment when the cargo tray is in the expanded and assembled-expanded configuration; the front wall is connected to the bottom wall by a first bottom living hinge; the back wall is connected to the bottom wall by a back bottom living hinge; the first side wall is connected to the bottom wall by a first bottom side living hinge; the second side wall is connected to the bottom wall by a second bottom side living hinge; the front wall includes front first and second side flanges that are each connected to the first wall by first wall living hinges; the back wall includes back first and second side flanges that are each connected to the back wall by back wall living hinges; the first side wall includes first side first and second side flanges that are each connected to the first side wall by first side wall living hinges; the second side wall includes second side first and second side flanges that are each connected to the second side wall by second side wall living hinges; adjacently positioned side flanges are connected together by flange living hinges; adjacently positioned side flanges are configured to extend outwardly from a corner of the cargo tray when in the assembled-expanded configuration; the cargo tray includes one or more features selected from the group consisting of a) one or more strap slots located in one of the first side wall, the second side wall, the front wall, the back wall, first and/or second side flanges of the first side wall, first and/or second side flanges of the second side wall, first and/or second side flanges of the front wall, and/or first and/or second side flanges of the back wall, b) one or more gripping members connected to a bottom surface of the bottom wall, c) a top side flange that is connected by a top side living hinge to a body of the first side wall, and wherein the top side flange is configured to be bent about the top side living hinge over a portion of a front face or a back face of the first side wall, d) a top side flange that is connected by a top side living hinge to a body of the second side wall, and wherein the top side flange is configured to be bent about the top side living hinge over a portion of a front face or a back face of the second side wall, e) a top side flange that is connected by a top side living hinge to a body of the first side wall, and an opening flange in the first side wall, and wherein the top side flange is configured to be bent about the top side living hinge over a portion of a front face or a back face of the first side wall, and wherein the opening flange is movable to form a handle opening in the first side wall, and wherein the opening flange is configured to partially overlie a portion of the top side flange of the first side wall when the opening flange is moved to form the handle opening, and/or f) a top side flange that is connected by a top side living hinge to a body of the second side wall, and an opening flange in the first side wall, and wherein the top side flange is configured to be bent about the top side living hinge over a portion of a front face or a back face of the second side wall, and wherein the opening flange is movable to form a handle opening in the second side wall, and wherein the opening flange is configured to partially overlie a portion of the top side flange of the second side wall when the opening flange is moved to form the handle opening.

In another non-limiting object of the present disclosure is the provision of a collapsible cargo tray wherein the body is formed of a single piece of corrugated plastic.

In another non-limiting object of the present disclosure is the provision of a collapsible cargo tray further including a protective liner in the internal cargo tray compartment.

In another non-limiting object of the present disclosure is the provision of a collapsible cargo tray wherein each of the front wall, the back wall and the bottom wall include a mid-region living hinge that facilitates in folding each of the front wall, the back wall and the bottom wall in half when the cargo tray is folded from the assembled-expanded configuration to the unfolded flat configuration.

In another non-limiting object of the present disclosure is the provision of a collapsible cargo tray wherein the bottom wall includes one or more drainage openings; the one or more drainage openings fully formed in the bottom wall or partially formed by the bottom wall.

In another non-limiting object of the present disclosure is the provision of a collapsible cargo tray wherein each of the first and second side wall includes the handle opening and the opening flange; the opening flange on each of the first and second side walls is connected by a living hinge.

In another non-limiting object of the present disclosure is the provision of a collapsible cargo tray wherein the adjacently positioned side flanges include one or more connectors that are configured to releasably connect together the adjacently positioned side flanges.

In another non-limiting object of the present disclosure is the provision of a collapsible cargo tray wherein each of the side flanges have a same shape and a same size.

In another non-limiting object of the present disclosure is the provision of a collapsible cargo tray wherein a plurality of the side flanges are formed of four edges; a first top edge extends from one of the living hinge one of the front wall, back wall, first side wall or second side wall; a second bottom edge that extends from the same living hinge; a third edge that is connected along the same living hinge and is connected to a first end of the first top edge and a first end of the second bottom edge and wherein the third edge is non-parallel to both the first top edge and the second bottom edge, and a fourth edge that connects together second ends of the first top edge and second bottom edge and wherein the fourth edge is non-parallel to both the first top edge and the second bottom edge.

In another non-limiting object of the present disclosure is the provision of a collapsible cargo tray wherein one or more of the one or more strap slots located in one of the first side wall, the second side wall, the front wall, the back wall, first and/or second side flanges of the first side wall, first and/or second side flanges of the second side wall, first and/or second side flanges of the front wall, and/or first and/or second side flanges of the back wall; one or more of the strap slots includes a strap positioned the strap slot; the strap includes one or more connectors.

In another non-limiting object of the present disclosure is the provision of a collapsible cargo tray wherein the front wall has a height that is less than a height of the back wall.

In another non-limiting object of the present disclosure is the provision of a collapsible cargo tray wherein the first and second side walls progressively increase in height from the front wall to the back wall.

In another non-limiting object of the present disclosure is the provision of a collapsible cargo tray wherein the first and second side flanges on the back wall and one of the side flanges on each of the first and second side walls include the strap slot that are configured to at least partially overlap one another when the first side flange on the back wall is connected to one of the side flanges on the side wall and the second side flange on the back wall is connected to one of the side flanges on the second side wall.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 depicts exemplary sheets of corrugated plastic that can be used to partially or fully form one or more of the embodiments and implementations disclosed herein;

FIGS. 2A-2G illustrate a non-limiting implementation of a corner caddy, wherein FIGS. 2A-2D are various views of the corner caddy in an assembled-expanded configuration, and wherein FIGS. 2E-2F are two views of the corner caddy in a collapsed and substantially flat configuration, and wherein FIG. 2G depicts the corner caddy mounted to a portion of an exemplary aerial lift cage or other structure;

FIGS. 3A-3L illustrate a non-limiting implementation of a pipe rack, wherein FIGS. 3A-3I are various views of the pipe rack in an assembled-expanded configuration, and wherein FIG. 3J-3K is a view of the pipe rack collapsed into a substantially flat configuration, and wherein FIG. 3L depicts the pipe rack mounted to a portion of an exemplary aerial lift cage or other structure;

FIGS. 4A-4H illustrate a non-limiting implementation of a trough, wherein FIGS. 4A-4E are various views of the trough in an assembled-expanded configuration, and wherein FIGS. 4F-4G are views of the trough in a collapsed and substantially flat configuration, and wherein FIG. 4H depicts the trough mounted to portion of an exemplary aerial lift cage or other structure;

FIGS. 5A-5H illustrate a non-limiting implementation of a disclosed safety cone, wherein FIGS. 5A-5D are various views of the safety cone in an assembled-expanded configuration, and wherein FIGS. 5E-5F are various views of the safety cone in a collapsed and substantially flat configuration, and wherein FIGS. 5G-5H are various views of the safety cone in an unassembled configuration, and wherein FIG. 5I is various of view of the safety cone that is used with bottom weights.

FIGS. 6A-6R illustrate a non-limiting implementation of a holster or caddy, wherein FIGS. 6A-6F are various views of a first non-limiting embodiment of the holster or caddy in an assembled configuration that includes an open base for receiving a plurality of exemplary pipes, conduits, or other items, and wherein 6G-6H are various views of the first non-limiting embodiment of the holster or caddy in a substantially flat configuration, and wherein FIGS. 6I-6M are various views of a second non-limiting embodiment of the holster or caddy in the assembled configuration that includes an open base for receiving a plurality of exemplary pipes, conduits, or other items and a compartment divider, and wherein FIGS. 6N-6O are views of the second non-limiting embodiment of the holster or caddy in a substantially flat configuration, and wherein FIG. 6P is a view of the second non-limiting embodiment of the holster or caddy in the assembled configuration that includes an open base and is illustrated as receiving a plurality of exemplary pipes, conduits, or other items, and wherein FIG. 6Q illustrates a third non-limiting embodiment of the holster or caddy in an assembled configuration that includes an open base for receiving a plurality of exemplary pipes, conduits, or other items, and wherein FIG. 6R illustrates the third non-limiting embodiment of the holster or caddy in an assembled configuration, and wherein the holster or caddy is mounted to portion of an exemplary aerial lift cage or other structure;

FIGS. 7A-7J illustrate a non-limiting implementation of a bucket, wherein FIGS. 7A-7G depict various views of the bucket in an assembled-expanded configuration, and wherein FIG. 7H illustrates the bucket strap separated from the bucket, and wherein FIGS. 7I-7J illustrate views of the bucket in the collapsed and substantially flat configuration;

FIGS. 8A-8F illustrate non-limiting implementations of a platform in an assembled and collapsed state; and wherein FIGS. 8A-8C depict various views of the platform in an assembled-expanded configuration, and wherein FIGS. 8D-8E depict various views of the platform in the collapsed and substantially flat configuration; and wherein FIG. 8F depicts a view of the platform in an assembled-expanded configuration that includes various items of the top platform surface of the platform;

FIGS. 9A-9L illustrate a non-limiting implementation of a ladder caddy, wherein FIGS. 9A-9F are various views of the ladder caddy in an assembled-expanded configuration, and wherein FIG. 9G is a view of the ladder caddy in an assembled-expanded configuration that has an optional protective liner in the internal compartment of the ladder caddy, and wherein FIG. 9H is a view of the ladder caddy in an assembled-expanded configuration that is removably connected to a top portion of a ladder, and wherein FIGS. 9I-9L are various views of the ladder caddy in the collapsed and substantially flat configuration;

FIGS. 10A-10C illustrate a non-limiting implementation of a drop-cloth holder assembly comprising a corrugated plastic sheet and drop-cloths, wherein FIG. 10A depicts the corrugated plastic sheet in a flat configuration, wherein FIG. 10B depicts the drop-cloths bundled around the corrugated plastic sheet, and wherein FIG. 10C depicts a plurality of drop-cloth assemblies housed within an exemplary bin;

FIGS. 11A-11C illustrate another non-limiting implementation of a drop-cloth assembly comprising a corrugated plastic sheet having strap handles and drop-cloths, wherein FIG. 11A depicts the corrugated plastic sheet having strap handles in a flat configuration, wherein FIG. 11B depicts the drop-cloths bundled in the corrugated plastic sheet, and wherein FIG. 11C depicts the drop-cloth assembly housed within an exemplary bin;

FIGS. 12A-12K illustrate a non-limiting implementation of a work tray, wherein FIGS. 12A-12F are various views of the work tray in an assembled-expanded configuration, and wherein FIG. 12G is a view of the work tray in an assembled-expanded configuration and includes an optional protective liner in the internal cavity of the work tray, and wherein FIGS. 12H-12K are various views of the work tray in a collapsed and substantially flat configuration;

FIGS. 13A-13M illustrate a non-limiting implementation of a cargo tray, wherein FIGS. 13A-13F are various views of the cargo tray in an assembled-expanded configuration, and wherein FIG. 13G is an exploded view of the cargo tray in an assembled-expanded configuration and the protective liner is separated from the cargo tray, and wherein FIGS. 13H-13J are various views of the work tray in a collapsed and substantially flat configuration, and FIGS. 13K-13M are various views of the work tray in an unassembled or folded position or collapsed position or substantially flat configuration;

FIGS. 14A-14N illustrate a non-limiting implementation of a cargo tray, wherein FIGS. 14A-14F are various views of the cargo tray in an assembled-expanded configuration, and wherein FIG. 14G-14H are various views of the cargo tray in an assembled-expanded configuration that includes a mount strap, and wherein FIGS. 14I-14L are various views of the cargo tray in a collapsed and substantially flat configuration, and FIGS. 14M-14N are various views of the cargo tray in an unassembled or folded position or collapsed position or substantially flat configuration;

FIG. 14O illustrates a non-limiting implementation of various sized cargo trays; and

15A-15B are cross-sectional depictions of non-limiting protective liners having a construction that includes an absorbable layer, an optional non-porous layer, an adhesive backing layer, and an optional release layer.

### DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

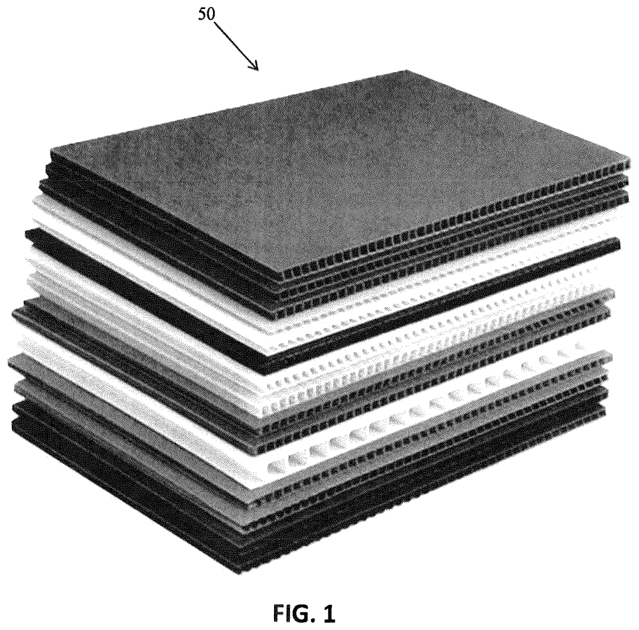

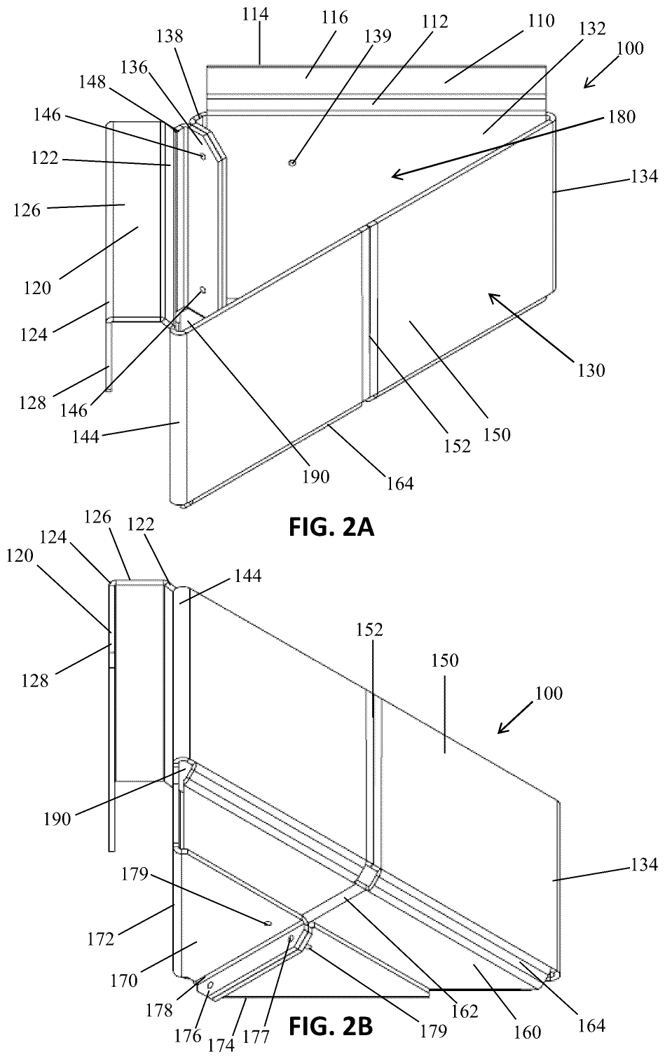

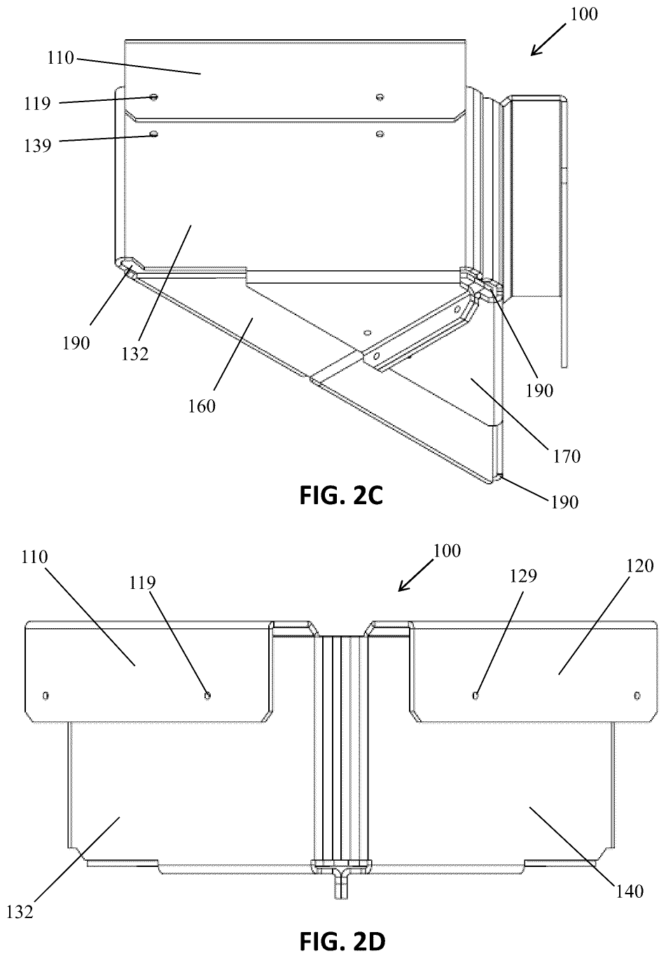

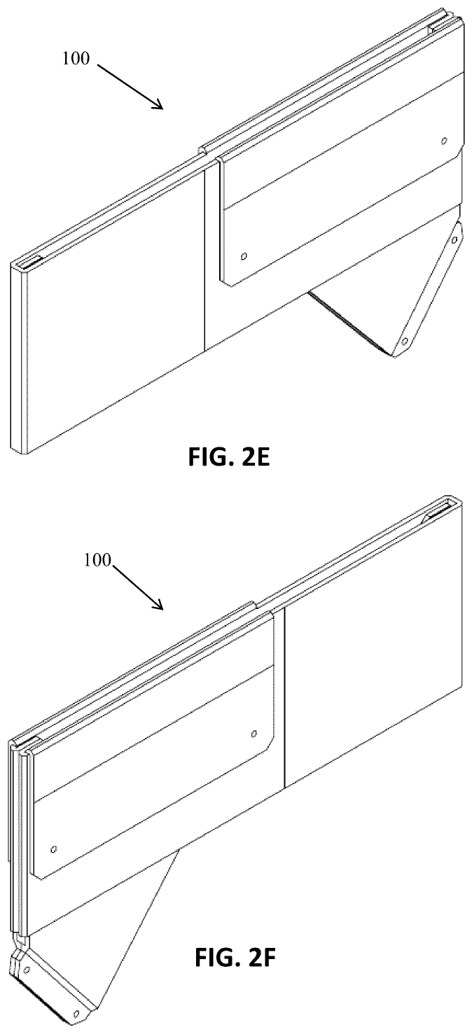

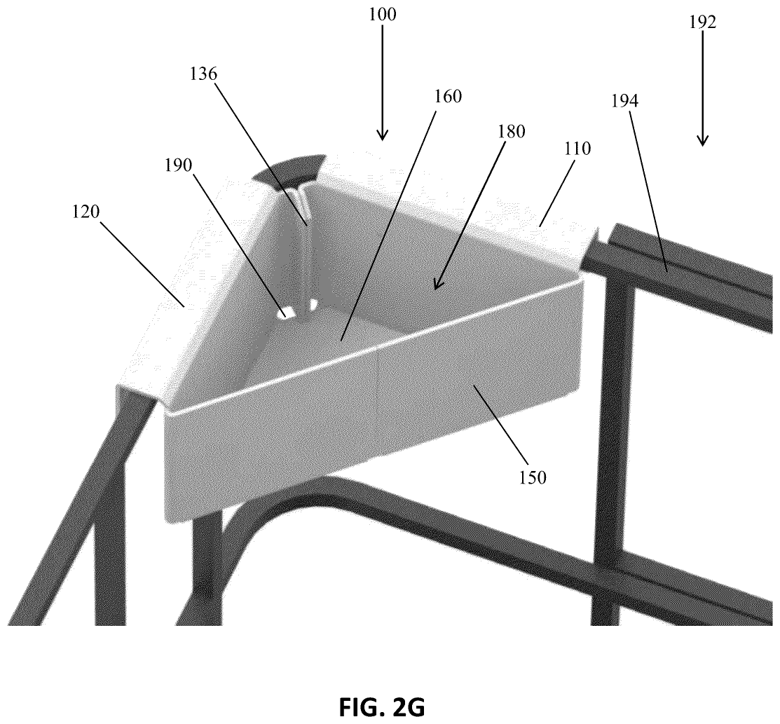

Referring now to FIG. 1, there is illustrated a stack of corrugated plastic materials 50 of differing configuration, color and size. The non-limiting embodiments of the present disclosure that are illustrated in FIGS. 2-14 can be partially or fully formed from one or more of corrugated plastic materials 50. The corrugated plastic materials 50 is generally a lightweight, durable, tough, waterproof and stain-resistant material. The corrugated plastic materials 50 can be available in sheets, both translucent or in various colors. These corrugated plastic materials 50 can be formed of a variety of materials such as, but not limited to, polypropylene/polyethylene. The thickness of the corrugated plastic sheets can vary. The corrugated plastic sheets generally include an outer surface having a printable surface wherein verbiage, art, logos, etc. can be optionally printed thereon, and an inside core produced with specifically arranged flutes or ribs to provide strength to the corrugated sheet while minimizing its weight. The corrugated plastic sheets are generally easily cut, route, fold, die-cut, and/or finished.

Referring now to FIGS. 2-14, there are illustrated various non-limiting configurations of organizers, caddies, safety cones, and accessories in accordance with the present disclosure that are partially or fully formed from one or more corrugated plastic sheets 50. The non-limiting organizers, caddies, safety cones, and accessories can be configured to be foldable and collapsible into a substantially flat configuration when not in use for convenient storage and/or transport. The non-limiting configurations of the organizers, caddies, safety cones, and accessories can be used in/at various work sites and/or worksite locations (e.g. automotive, landscaping/gardening, painting, construction, plumbing, remodeling and repair projects, or the like) and/or in association with various work-site accessories (e.g. ladders, aerial lifts, power tools, hand tools and instruments, caulk guns, pipes, conduits, buckets, brushes, cans, plants, liquids, clothes, cloths, hats and helmets, phones, radios, head-phones, keys, tags, goggles, glasses, ear and eye protection, communication equipment, construction plans or other paper products or manuals or magazines or books, or the like). It is to be understood that the above-mentioned work sites and work-site accessories are non-limiting. In one non-limiting embodiment, some of the non-limiting configurations of the organizers, caddies, safety cones, and accessories disclosed herein can also be used as storage containers in vehicles, trunks of vehicles, and/or cargo bays, cargo truck or cargo beds of vehicles. The size and thickness of the plastic sheets 50 used to partially or fully form the configurations of the organizers, caddies, safety cones, and accessories are non-limiting. In one non-limiting embodiment, the thickness of the plastic sheets 50 is 0.05-0.5 inches (and all values and ranges therebetween).

FIGS. 2A-2G illustrate a non-limiting implementation of a foldable and collapsible corner caddy 100 in accordance with the present disclosure, and wherein the corner caddy 100 is formed from at least one corrugated plastic sheet 50. FIG. 2A is a top-rear isometric view of the corner caddy 100 in an assembled-expanded configuration. FIG. 2B is a bottom-rear isometric view of the corner caddy 100 in the assembled configuration. FIG. 2C is a bottom-front isometric view of the corner caddy 100 in the assembled configuration. FIG. 2D is a front plan view of the corner caddy 100 in the assembled configuration. FIG. 2E of a top-rear isometric view of the corner caddy 100 in an unassembled or folded position or collapsed position or substantially flat configuration. FIG. 2F of a top-front isometric view of the corner caddy 100 in an unassembled or folded position or collapsed position or substantially flat configuration. FIG. 2G is a top-rear isometric view of the corner caddy 100 in an assembled-expanded configuration and positioned on the corner of a bar or rail arrangement of a structure such as, but not limited to, an aerial lift cage 192.

The corner caddy 100 includes a body 130 and two holders or side flanges 110, 120 that support corner caddy 100 in a corner of a bar or rail arrangement of a structure such as, but not limited to, an aerial lift cage 192 as illustrated in FIG. 2G. The body includes sides walls 132, 140, back wall 150, and a bottom wall 160. Side walls 132, 140 are connected together (permanently connected together or releasably connected together) by one or more connectors 146. In one non-limiting configuration, the side walls 132, 140 are permanently connected together by a connection such as, but not limited to, a snap connection, a press-fit connection, adhesive connection, melted connection. The connection formed by side walls 132, 140 can optionally form an interior flange 136 that extends inwardly into internal compartment 180 of the corner caddy 100. As illustrated in FIG. 2A, the interior flange 136 only extends partially inwardly into internal compartment 180 of the corner caddy 100, thus does not contact rear wall 150. As can be appreciated, interior flange 136 can optionally be configured to extend inwardly into internal compartment 180 of the corner caddy 100 and contact rear wall 150, thus forming a plurality of sections or partitions in the internal compartment 180. When the interior flange 136 is optionally configured to extend to and contact rear wall 150, the interior flange can optionally be releasably connected to the rear wall 150 by one or more connectors. The interior flange, when used, can provide structural rigidity and/or strength to the corner caddy when fully assembled. One or more living hinges 138, 148 are used to facilitate in the folding or moving of the side walls 132, 140 relative to one another when the corner caddy is in an unassembled or folded position or collapsed position or substantially flat configuration. As illustrated in FIG. 2A, the living hinges 138, 148 can optionally be spaced from the ends of side walls 132, 140 such that the end portions of the side walls 132, 140 can form the optional interior flange 136. As illustrated in FIG. 2A, the front edge of the corner caddy 100 can optionally be a generally flat face portion that is formed by the side walls 132, 140, and the living hinges 138, 148 that are spaced from the ends of the side walls 132, 140.

Side walls 132, 140 are connected to back wall 150 by a living hinge 134, 144. The back wall 150 also optionally includes a living hinge 152 to facilitate in the folding in half of the back wall when the corner caddy 100 is folded into the unassembled or folded position or collapsed position or substantially flat configuration. Likewise, the bottom wall 160 also optionally includes a living hinge 162 to facilitate in the folding in half of the bottom wall 160 when the corner caddy 100 is folded into the unassembled or folded position or collapsed position or substantially flat configuration. The bottom wall 160 also includes a rear living hinge 164 that connects that bottom wall 160 to the back wall 150. The edges of the bottom wall are optionally not connected to side walls 132, 140 so that the bottom wall can be moved upwardly form the bottom edges of the side walls 132, 140 when the corner caddy 100 is folded into the unassembled or folded position or collapsed position or substantially flat configuration. A bottom flange 170 is connected to the bottom edges of the side walls 132, 140 by living hinges 172, 174. The bottom flange 170 is configured to support front portion of the bottom wall 160 and maintain the position of the bottom wall 160 relative to the bottom edges of the side walls 132, 140 when the corner caddy 100 is in the assembled position. The mid-portion of the bottom flange 170 can optionally include a support rib 176 that extends downwardly from the bottom flange 170, and/or a mid-bottom living hinge 178 that enables the bottom flange 170 to be folded in half when the corner caddy 100 is folded into the unassembled or folded position or collapsed position or substantially flat configuration. The support rib 176 can be used to provide strength to the bottom flange 170, and/or structural rigidity to the bottom flange 170. The bottom flange 170 can optionally be formed of two portions that are connected together (permanently connected together or releasably connected together) by one or more connectors 177. In one non-limiting configuration, the two portions of the bottom flange 170 are permanently connected together by a connection such as, but not limited to, a snap connection, a press-fit connection, adhesive connection, melted connection. The bottom flange 170 can optionally include one or more bottom connectors or openings 179. When the bottom flange 170 includes one or more bottom connectors 179, the bottom connector can be used to releasably connect the bottom flange 170 to the bottom wall 160. When the bottom flange 170 includes one or more bottom openings 179, the bottom openings can be used to facilitate in drainage from the internal compartment 180 of the corner caddy 100 when fully assembled.

Each of holders or side flanges 110, 120 are connected to a top edge of a side wall 132, 140 by a holder connector living hinge 112, 122. Each of holders or side flanges 110, 120 includes an intermediate living hinge 114, 124 that is spaced from the holder connector living hinge 112, 122 and is configured to enable a portion of the holder or foldable side flange 110, 120 to be bent to form a first portion 116, 126 and second portion 118, 128 of the holder or foldable side flange 110, 120. The holders or side flanges 110, 120 are illustrated in FIG. 2A as being spaced from one another, and optionally separated by the optional flat face portion on the assembled corner caddy 100; however, this is not required.

One or more of the side walls 132, 140 and/or one or more of holders or side flanges 110, 120 can optionally include one or more holes or openings 119, 129, 139 used to facilitate in securing the corner caddy 100 to a structure (e.g., rail, bar, fence, etc.) by use of a connector (e.g., cord, zip-tie, wire, strap etc.).

The bottom of the internal compartment 180 can optionally include one or more drainage openings 190 so as to allow liquids to drain form the internal compartment 180 and/or facilitate in removing debris from the internal compartment 180. The cross-sectional area of the one or more drainage openings 190, when used, is generally less than 15% (e.g., 0.01-14.99% and all values and ranges therebetween) of the total cross-sectional area of the bottom of the internal compartment 180. As can be appreciated, the internal compartment 180 can be absent drainage openings. As can also be appreciated, the bottom of the internal compartment can be open, thus 40-100% (an all values and ranges therebetween) of the bottom wall 160 can optionally be eliminated from the corner caddy 100. As illustrated in FIGS. 2A and 2G, the interior flange 136 extends partially or fully across the drainage opening 190 that is located at the front portion of the internal compartment 190, which opening is defined by a portion of the bottom edge of side walls 132, 140, the front edge of bottom flange 170, and the front edge of bottom wall 160. FIGS. 2B and 2C illustrate that optional drainage openings 190 can be located at the bottom rear of the corner caddy 100. As illustrated in FIGS. 2B and 2C, one optional drainage opening 190 is formed at a bottom corner of the corner caddy 100 where side wall 132 is adjacent to bottom wall 160, and another optional drainage opening 190 is formed at a bottom corner of the corner caddy 100 where side wall 140 is adjacent to bottom wall 160.

As illustrated in FIG. 2G, the corner caddy 100, when fully assembled, can be positioned in the corner of an aerial lift cage 192 and connected to the rails 194 of the aerial lift cage 192. The holders or foldable side flanges 110, 120 in the assembled configuration have a generally U-shaped or C-shaped configuration that can be positioned or fitted about a rail 194 so as to support the corner caddy on the top edge or surface of the rail 194.

As illustrated in FIGS. 2E-2F, the corner caddy 100 can be configured to be collapsed into a substantially flat configuration when not in use and/or being stored. When the corner caddy is to be used, the corner caddy 100 can be unfolded and positioned in the assembled-expanded position for use as illustrated in FIGS. 2A-2D and 2G.

As illustrated in FIGS. 2A and 2G, the internal compartment 180 of the corner caddy 100 can have a generally triangular cross-sectional shape.

Although not illustrated, the bottom of the internal compartment 180 can optionally include a protective liner as is discussed in more detail below. The protective liner can optionally include a liquid barrier layer that inhibits or prevents liquids to pass fully through the protective liner. The protective liner can be permanently or releasably secured to the top surface of the bottom of the internal compartment 180 by any number of arrangements (e.g., adhesive, snap, hook and loop fasteners, dual lock fasteners, mushroom hook fasteners, zipper, strap, rib and groove connection, etc.). In one non-limiting arrangement, the protective liner can be releasably secured to the top surface of the bottom of the internal compartment 180 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the top surface of the bottom of the internal compartment 180, the protective liner can be removed and optionally cleaned and then reinserted on the top surface of the bottom of the internal compartment 180 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the top surface of the bottom of the internal compartment 180. As can also be appreciated, the protective liner can be positioned on a portion or all of the inner side wall surfaces of the internal compartment 180, and/or any other surface of the corner caddy 100. One or more sides of the corner caddy 100 can optionally include logos, instructions, branding, etc.

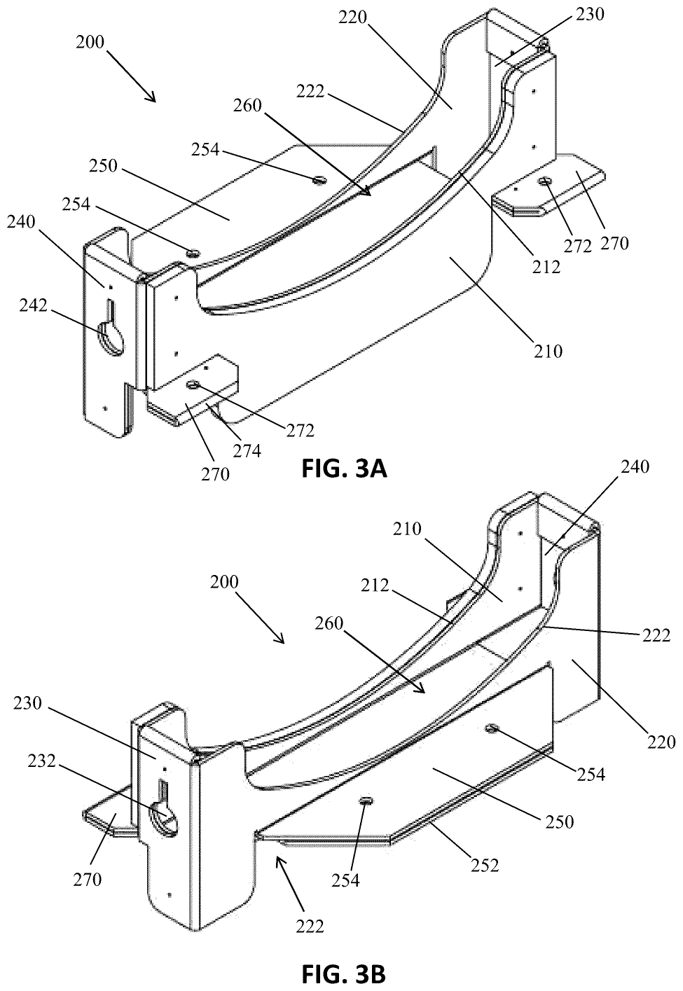

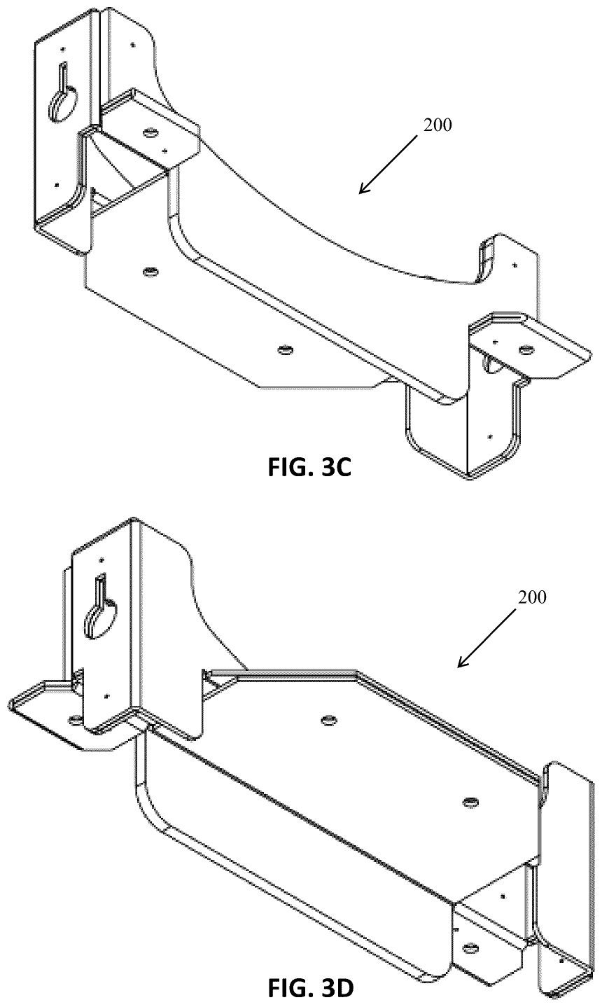

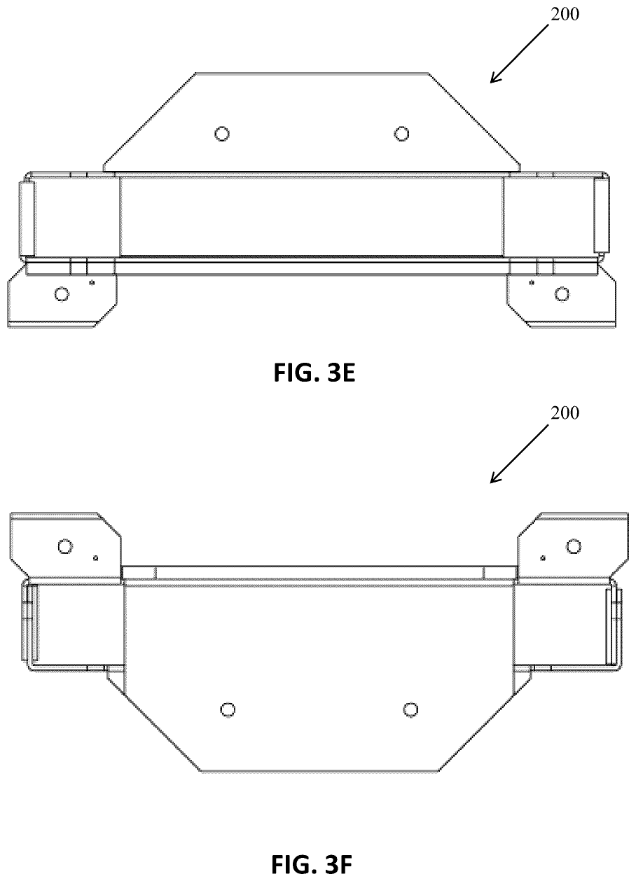

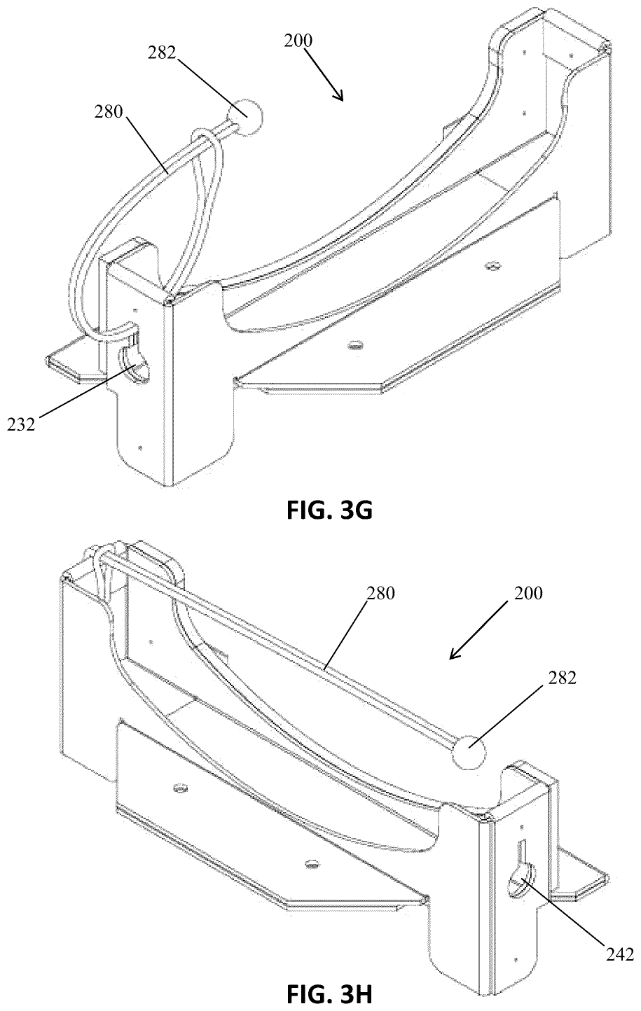

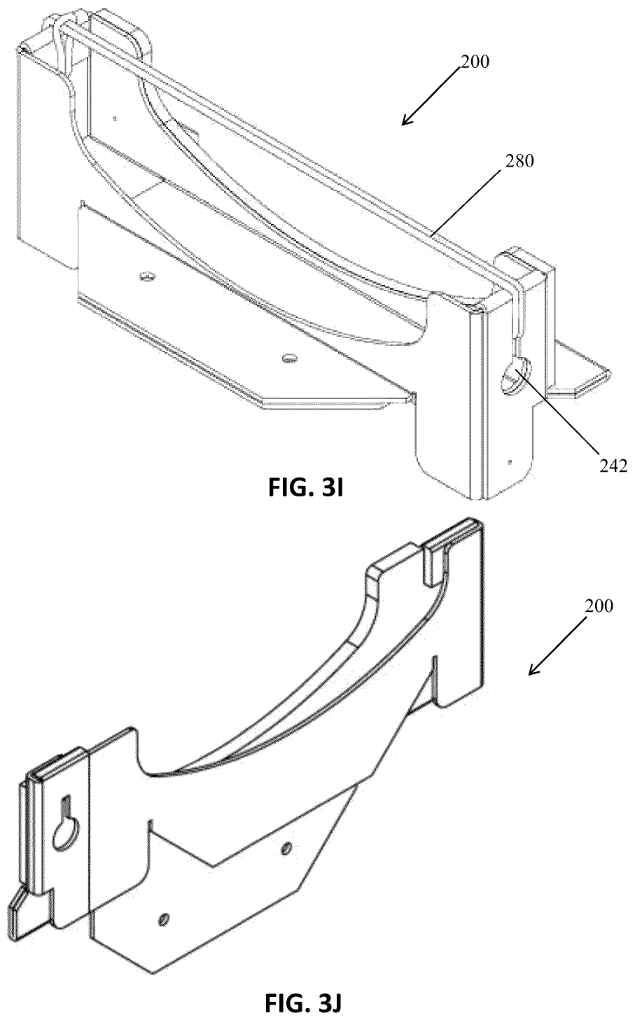

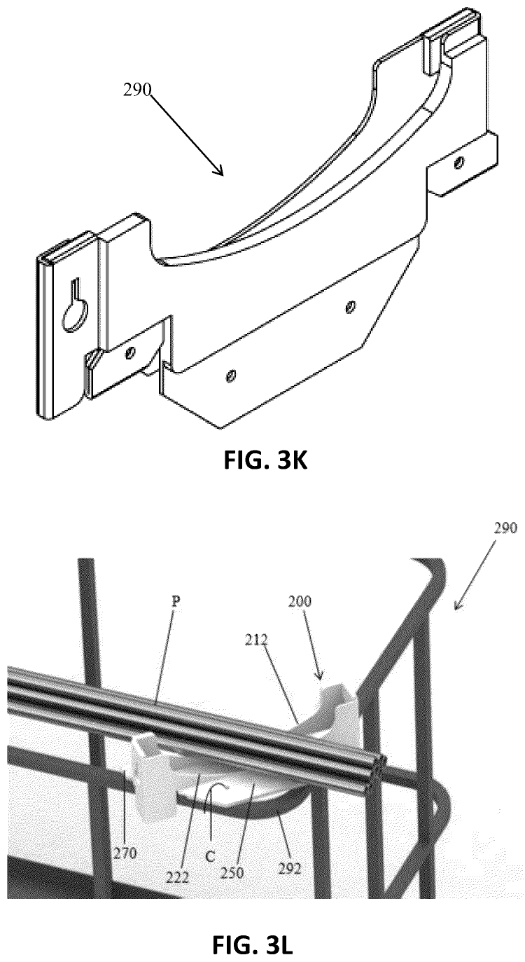

Referring now to FIGS. 3A-3K, there is illustrated a non-limiting implementation of a foldable and collapsible pipe rack 200 in accordance with the present disclosure, and wherein the pipe rack 200 is formed from at least one corrugated plastic sheet 50. FIG. 3A is a rear-top isometric view of the pipe rack 200 in an assembled-expanded configuration. FIG. 3B is a front-top isometric view of the pipe rack 200 in an assembled-expanded configuration. FIG. 3C is a rear-bottom isometric view of the pipe rack 200 in an assembled-expanded configuration. FIG. 3D is a front-bottom isometric view of the pipe rack 200 in an assembled-expanded configuration. FIG. 3E is a top plan view of the pipe rack 200 in an assembled-expanded configuration. FIG. 3F is a bottom plan view of the pipe rack 200 in an assembled-expanded configuration. FIGS. 3G-3I are various front-top isometric views of the pipe rack 200 in an assembled-expanded configuration that also illustrate a retention device such as, but not limited to a retention cord. FIG. 3J is a rear-bottom isometric view of the pipe rack 200 in a folded and substantially flat configuration. FIG. 3K is a front-bottom isometric view of the pipe rack 200 in a folded and substantially flat configuration. FIG. 3L illustrates the pipe rack 200 in the fully assembled-expanded configuration mounted to an exemplary aerial lift cage 290. Although not shown, an identical pipe rack 200 can be mounted to another location on the aerial lift cage 290 so that both end portions of the pipes are supported on the two pipe racks 200 that are mounted on the aerial lift cage 290.

The pipe rack 200 includes first and second support members 210, 220, first and second end walls 230, 240 that are each connected between the ends of the first and second support members 210, 220, and a base wall 250. The top of each of the first and second support members 210, 220 is a support surface 212, 222. The first and second support members 210, 220, first and second end walls 230, 240 and the base wall 250 form a pipe rack cavity 260 when the pipe rack 200 is fully assembled. The shape profile of support surfaces 212, 222 is generally U-shaped or semi-circular shaped; however, other shapes can be used. The shape profile of the support surfaces 212, 222 is configured to retain a portion of a pipe P or rod that is positioned on support surfaces 212, 222 as illustrated in FIG. 3L.

The first and second support members 210, 220 are connected to first and second end walls 230, 240 by a living hinge so that the pipe rack can be folded between an unassembled or folded position or collapsed position or substantially flat configuration as illustrated in FIGS. 3J-3K and an unfolded or assembled-expanded configuration as illustrated in FIGS. 3A-3I. In one non-limiting configuration, the front and back surfaces of the first and second support members 210, 220 lie in planes that are generally parallel to one another (e.g., within 0 to ±10° of parallel to one another and all values and ranges therebetween) when the pipe rack is in the assembled-expanded configuration. In another non-limiting configuration, the front and back surfaces of the first and second end walls 230, 240 lie in planes that are generally parallel to one another (e.g., within 0 to ±10° of parallel to one another and all values and ranges therebetween) when the pipe rack is in the assembled-expanded configuration. The rear end of the base wall 250 may or may not be connected to the first support member 210. In one non-limiting configuration, the rear end of the base wall 250 is connected by a living hinge to first support member 210. In one non-limiting configuration, the rear end of the base wall 250 is connected by a connector (e.g., adhesive, hook and loop fastener, etc.) to first support member 210 to form a releasable or permanent connection. The base wall 250 can optionally include a living hinge 252 that allows a portion of the base wall 250 to be folded over itself. The folding of the base wall 250 to create two layers can be used to enhance the strength, rigidity and/or durability of the base wall 250. The base wall 250 can optionally have one or more openings or holes 254 that can be used with a connector C (e.g., zip-tie, cord, wire, etc.) to facilitate in the securing of the pipe rack 200 to a structure. As illustrated in FIGS. 3A-3B, the width of the base wall 250 can optionally be less than the distance between first and second end walls 230, 240. A portion of the base wall 250 can optionally be tapered. As illustrated in FIGS. 3E-3F, the base wall 250 has a tapered portion that is located forwardly of support member 220. The end walls 230, 240 can optionally be formed of two pieces that are releasably or permanently connected together. As illustrated in FIGS. 3A-3B, an additional piece can be secured to the top inner surface of each of the end walls 230, 240 and be bent over the top edge of the other piece of the end walls 230, 240 (e.g., via a living hinge, etc.). Such additional pieces can be used to enhance the strength, rigidity and/or durability of the end walls 230, 240.

Support member 210 can optionally be formed of two pieces that are releasably or permanently connected together, and wherein a first piece that faces the second support surface 220 optionally has the same thickness as the second support surface, and support surface 210 is optionally connected to the base wall by a living hinge. The second piece of the first support wall can optionally be thicker than the first piece of the support surface 210. Such second piece can be used to enhance the strength, rigidity and/or durability of support surface 210.

As illustrated in FIG. 3A, the pipe rack 200 can optionally include one or more rear support flanges 270 that are used to facilitate in supporting the pipe rack 200 on a structure when the pipe rack 200 is in the fully assembled-expanded configuration. The one or more rear flanges 270 are illustrated as extending rearwardly of the support member 210, and the top plane of the one or more rear flanges 270 are generally normal (e.g., 80-100° and all values and ranges therebetween) to the plane of support member 210 when the pipe rack 200 is in the fully assembled-expanded configuration. The one or more rear flanges 270 can optionally be connected to support member 210 (e.g., connected to the first piece of support surface 210) by a permanent connection (e.g., living hinge, adhesive connection, etc.) or a releasable connection (e.g., snap, hook and loop fastener, magnet, etc.). The one or more rear flanges 270 can optionally include a living hinge 274 that allows a portion of the rear flange 270 to be folded over itself such that the top and bottom planes of the top and bottom surfaces are generally parallel to one another. The folding of the rear flanges 270 to create two layers can be used to enhance the strength, rigidity and/or durability of the rear flanges 270. The one or more rear flanges 270 can optionally one or more openings or holes 272 that can be used with a connector C (e.g., zip-tie, cord, wire, etc.) to facilitate in the securing of the pipe rack 200 to a structure. As illustrated in FIG. 3A, the one or more rear flanges 270 are positioned above the lowest portion of support member 210 and also positioned above the bottom of the first and second end walls 230, 240.

Referring now to FIG. 3B, support member 220 includes a slot or recessed region 222 positioned in the bottom middle portion of the support member 220. As illustrated in FIG. 3B, the top of base wall 250 engages the top of slot or recessed region 222 when the pipe rack 200 is in the assemble configuration. The plane of the bottom of the base wall 250 can a) optionally be generally parallel to the plane of the bottom of rear flanges 270 when the pipe rack is in the assembled-expanded configuration and/or b) optionally lie in the same plane as the plane of the bottom of rear flanges 270 when the pipe rack is in the assembled-expanded configuration.

Referring now to FIGS. 3G-3I, first and second end walls 230, 240 can optionally each include an opening 232, 242 for use with an elastic tether 280, cord, rubber band, etc. that can be used to facilitate in retaining pipes, rods, etc. on support surface 212, 222. The size and shape of the opening 232, 242 is non-limiting. In one non-limiting configuration, each of the openings have the same size and shape. In one non-limiting configuration, there is provided an elastic tether 280 that is connected the the first walls 230, and the other end of the elastic tether 280 includes a ball 282 or other structure that can be releasable placed into and secured to second wall 240. The size and shape of the openings 232, 242 is such that the ball 282 can be fitted therethrough. As illustrated in FIGS. 3G-3I, one end of the tether 280 is looped through opening 232; however, it can be appreciated that tether can alternatively be looped through opening 242. As illustrated in FIGS. 3I & 3J, after the tether 280 is looped through opening 282, the elastic tether is stretched until the ball 282 can be positioned through opening 242 to secure the tether in the secured position. The openings 232, 242 are shaped such that a larger sized opening portion is located at the bottom portion of openings 232, 242, and a smaller sized opening portion is located above the larger sized opening portion. Such a configuration allows the ball 282 to pass through the larger sized opening portion, but not the smaller size opening portion, thus once the ball 282 is inserted through opening 242, it will not inadvertently release from opening 242 until the user manually moves the ball 282 through and out of the larger sized opening portion in opening 242 to thereby release one end of the tether 280 from opening 242. As can be appreciated, other opening configurations can be used to achieve similar results. Once the tether 280 is secured in place, the tether can be used to entrap a portion of a pipe P or other structure between the tether and support surfaces 212, 222 to thereby secure a portion of the pipe P or other structure to the pipe rack 200.

Referring now to FIG. 3L, the pipe rack can optionally between positioned on a corner region of a structure such as, but not limited to, a corner of aerial lift cage 290. The support surface 212, 222 of the first and second support members 210, 220 are illustrated as supporting an end portion of several pipes P. A connector C is positioned in an opening 254 in the base wall 250 and about bar 292 of aerial lift cage 290 to secure the pipe rack 200 to the aerial lift cage 290. As can be appreciated, other connector can be placed in additional openings 254 in the base wall 250, in openings 272 of one or both of the rear flanges 270 and about one or more of bars 292 to secure the pipe rack 200 to the aerial lift cage 290. As can be appreciated, the optional tether 280 or other type of connector can be used to maintain pipes P on support surfaces 212, 222 of the pipe rack 200. As illustrated in FIG. 3L, a portion of the rear flanges 270, and a portion of the base wall 250 rest on top a portion of one of bars 292 of aerial lift cage 290 when the pipe rack 200 is positioned on the aerial lift cage 290. As also illustrated in FIG. 3L, the bottom portion of first and second end walls 230, 240 extends downward about a side of one of bars 292 of aerial lift cage 290 when the pipe rack 200 is positioned on the aerial lift cage 290. This combination of structures inhibits or prevents the pipe rack from moving or sliding forwardly and into the aerial lift cage 290. The downwardly extending portion of the first and second end walls 230, 240 and the mid-region of the first support members 210 act as a stop to forward sliding of the pipe rack 200 on bar 292, and the spacing between the first and second end walls 230, 240 inhibits or prevents lateral sliding of the pipe rack 200 on bar 292. When one or more connectors C are positioned in a) one or more openings 254 in the base wall 250 and about bar 292 of aerial lift cage 290, and/or b) one or more openings 272 of one or both of the rear flanges 270 and about one or more of bars 292 of aerial lift cage 290, the one or more connectors C secure the pipe rack 200 to the one or more bars 292 of aerial lift cage 290 to thereby inhibit or prevent the pipe rack 200 from sliding rearwardly off of the aerial lift cage 290.

Although not illustrated, one or more portions of the pipe rack (e.g., pipe rack cavity 260, etc.) can optionally include a protective liner as is discussed in more detail below. The protective liner can optionally include a liquid barrier layer that inhibits or prevents liquids to pass fully through the protective liner. The protective liner can be permanently or releasably secured to the outer surface of one or more portions of the pipe rack 200 by any number of arrangements (e.g., adhesive, snap, hook and loop fasteners, dual lock fasteners, mushroom hook fasteners, zipper, strap, rib and groove connection, etc.). In one non-limiting arrangement, the protective liner can be releasably secured to the top surface of the pipe rack cavity 260 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the top surface of pipe rack cavity 260, the protective liner can be removed and optionally cleaned and then reinserted on the top surface of pipe rack cavity 260 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the top surface of pipe rack cavity 260. As can also be appreciated, the protective liner can be positioned on a portion or all of the inner side wall surfaces of pipe rack cavity 260, and/or any other surface of the pipe rack 200. One or more sides of the pipe rack 200 can optionally include logos, instructions, branding, etc.

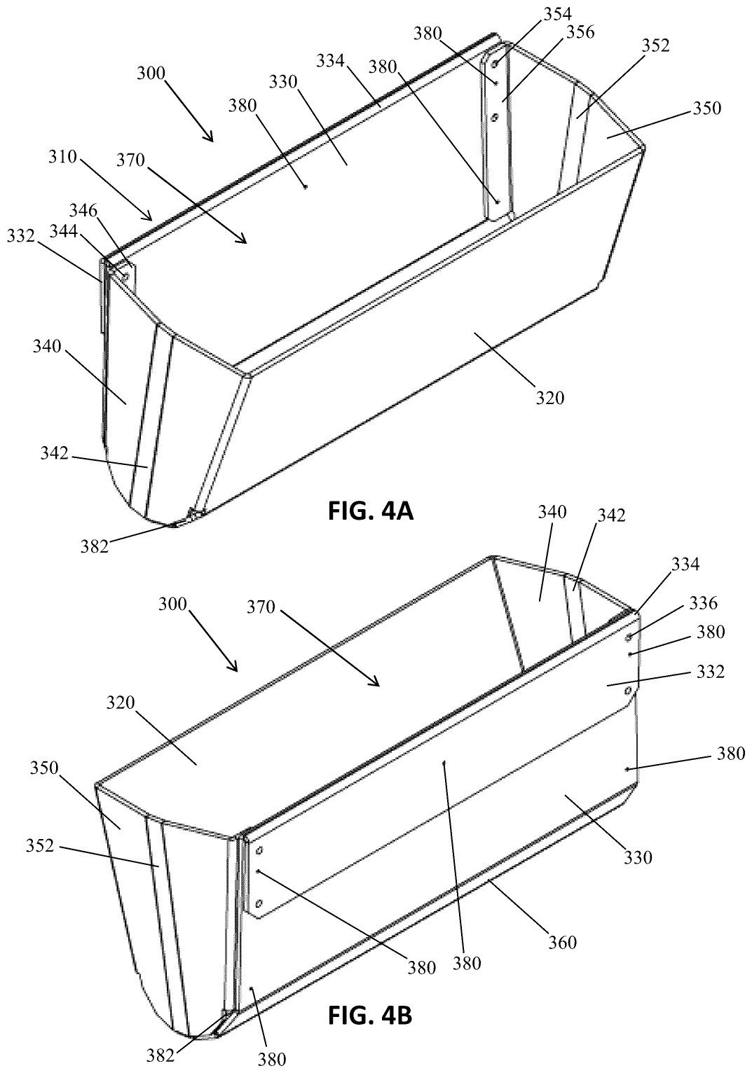

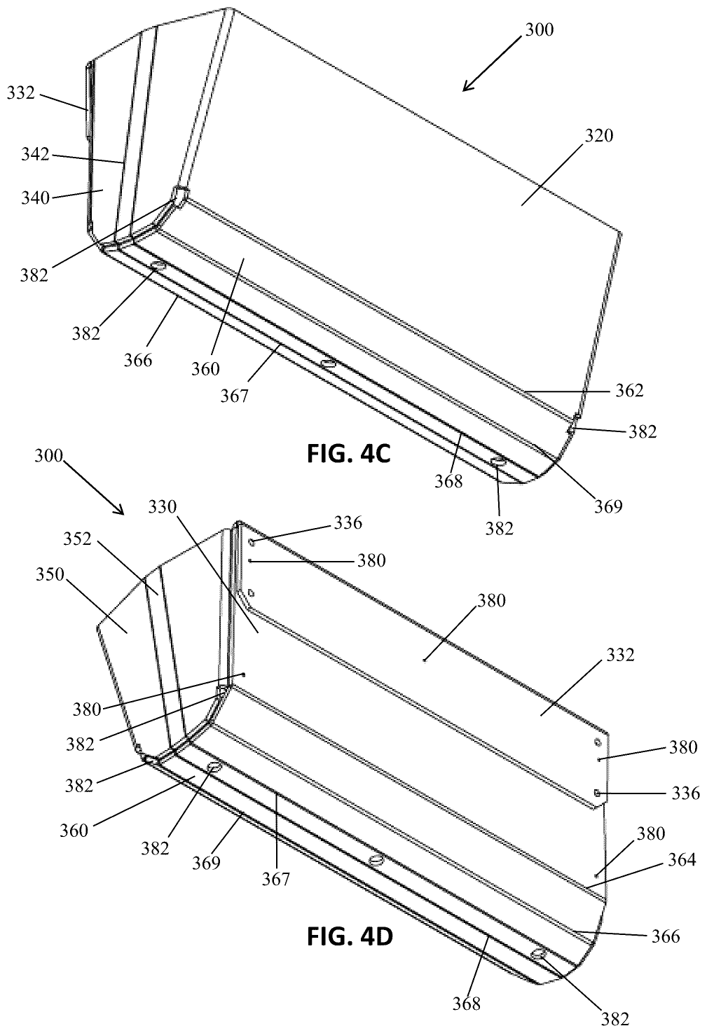

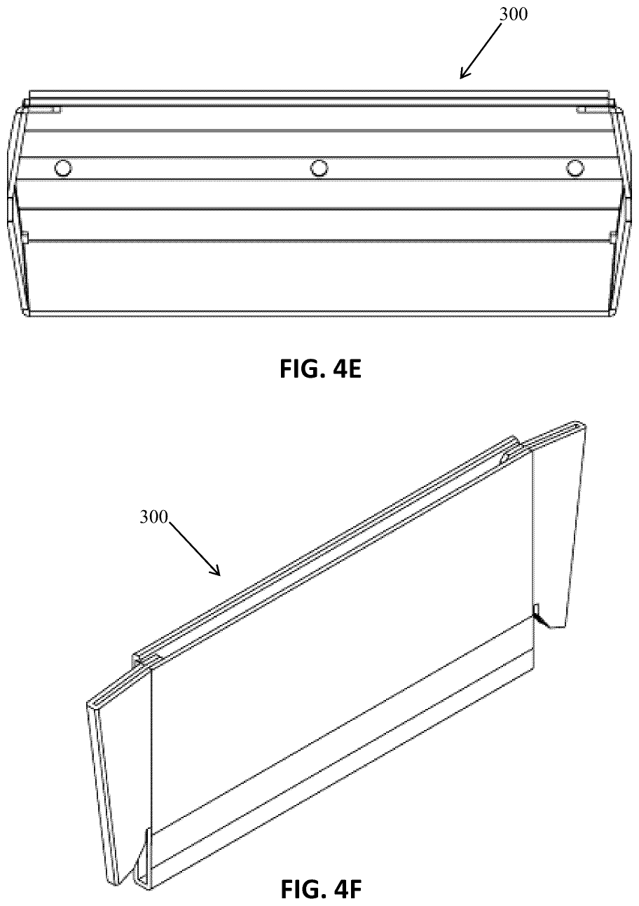

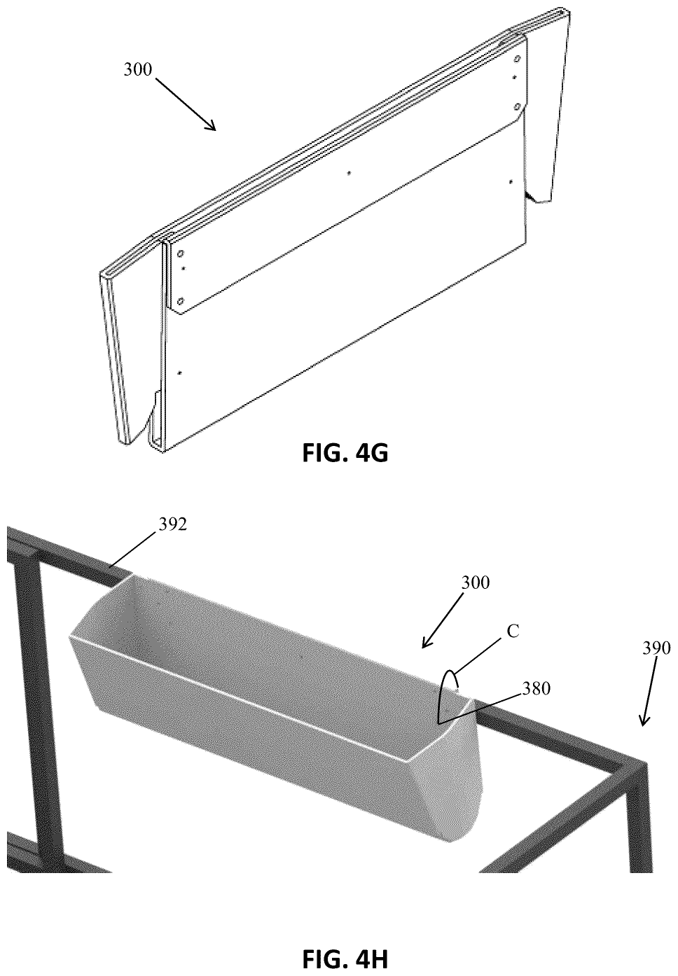

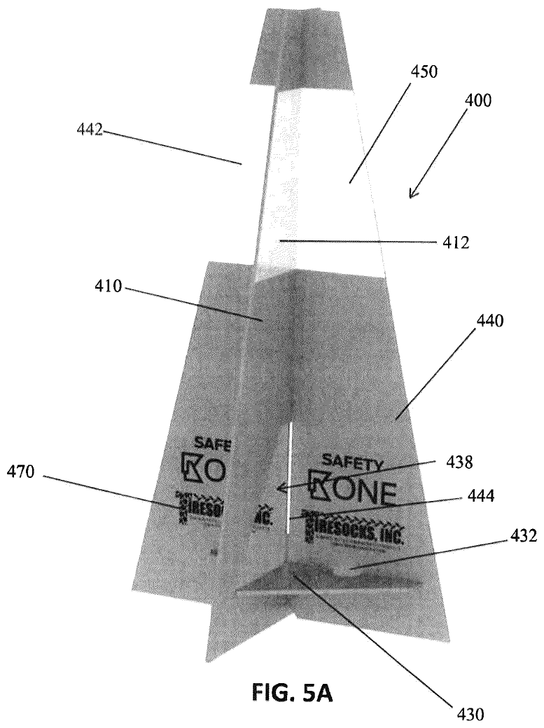

FIGS. 4A-4H illustrate a non-limiting implementation of a foldable and collapsible trough 300 in accordance with the present disclosure, and wherein the trough 300 is formed from at least one corrugated plastic sheet 50. FIG. 4A is a top-front isometric view of the trough 300 in an assembled-expanded configuration. FIG. 4B is a top-rear isometric view of the trough 300 in the assembled configuration. FIG. 4C is a bottom-front isometric view of the trough 300 in the assembled configuration. FIG. 4D is a bottom-rear isometric view of the trough 300 in the assembled configuration. FIG. 4E is a top plan view of the trough 300 in the assembled configuration. FIG. 4F is a top-front isometric view of the trough 300 in an unassembled or folded position or collapsed position or substantially flat configuration. FIG. 4G of a top-rear isometric view of the trough 300 in an unassembled or folded position or collapsed position or substantially flat configuration. FIG. 4H is a top-front isometric view of the trough 300 in an assembled-expanded configuration and positioned on the bar or rail arrangement of a structure such as, but not limited to, an aerial lift cage 390.

The trough 300 includes a body 310 that is formed of a front wall 320, a back wall 330, first and second sides walls 340, 350 and a bottom wall 360. The body forms an internal compartment 370 when the trough is in the assembled-expanded position to the unfolded and assembled-expended configuration. Side walls 340, 350 are connected to the front wall 320 and the back wall 330. The front wall 320 is connected to the first and second sides walls 340, 350 by a living hinge, and the back wall 330 is connected to the first and second sides walls 340, 350 by a connectors 344, 354 that form a detachable connection (e.g., snap, hook and loop fastener, etc.) or a permanent connection (e.g., adhesive, permanent mechanical connection, melted connection, etc.). Alternatively, the back wall 330 is connected to the first and second sides walls 340, 350 by a living hinge, and the front wall 320 is connected to the first and second sides walls 340, 350 by a connector that forms a detachable connection (e.g., snap, hook and loop fastener, etc.) or a permanent connection (e.g., adhesive, permanent mechanical connection, melted connection, etc.). The first and second side walls 340, 350 can optionally include a connection flange 346, 356 that is connected by connectors 344, 354 to the back wall 330 or the front wall 320. The connection flanges 346, 356 can optionally be movable relative to the other portion of the first and second side walls 340, 350 by a living hinge. As can be appreciated, the back wall 330 or front wall 320 can include the connection flange that is connected to one of the side walls.

The bottom wall 360 is connected to the front wall 320 and back wall 330 by living hinge 362, 364, and the bottom wall is not connected to first and second side walls 340, 350. Each of the first and second sides walls 340, 350 includes one or more side living hinges 342, 352 to enable the first and second side walls 340, 350 to be folded and unfolded when the trough 300 is folded into the unassembled or folded position or collapsed position or substantially flat configuration; and unfolded to the assembled-expanded configuration. Generally, the first and second sides walls 340, 350 have the same number of side living hinges. In one non-limiting configuration, each of the first and second sides walls 340, 350 includes a single side living hinge 342, 352 that is located in the middle or mid-region of the first and second sides walls 340, 350 as illustrated in FIGS. 4A & 4B so that the first and second sides walls 340, 350 can be folded in half or nearly in half when the trough 300 is folded into the folded and substantially flat configuration as illustrated in FIGS. 4F & 4G. As illustrated in FIGS. 4C & 4D, the bottom wall 360 includes one or more living hinges 366, 367, 368, 369 that enables the bottom wall 360 to be folded in substantially flat configuration when the trough 300 is folded into the folded and substantially flat configuration as illustrated in FIGS. 4F & 4G. In one non-limiting configuration, the bottom wall 360 includes a plurality of living hinges such that when the bottom wall 360 is in the unfolded or assembled-expanded configuration, the bottom profile of the bottom wall has a generally curved or arcuate profile; however, this is not required.

Referring now to FIGS. 4A-4D, the back wall 330 can optionally have a height that is about the same (e.g., within 0-10% the same and all values and ranges therebetween) as a height of the front wall 320. The longitudinal length of each of the front and back walls 320, 330 is greater (e.g., 10-5000% greater and all values and ranges therebetween) than a longitudinal length of each of the first and second sides walls 340, 350.

Referring now to FIGS. 4B & 4D, a rear flange 332 can be positioned on all or a portion of the back wall 330. The rear flange 332 can optionally be a contact surface for trough 300 when the trough 300 is connected to a structure. Rear flange 332 can also or alternatively functions to increase the strength and/or rigidity of the trough 300 when the trough is in the unfolded or assembled-expanded configuration. In one non-limiting arrangement, the rear flange 332 is optionally connected to the top edge of the back wall 330 by a back living hinge 334. The body of the rear flange 332 can optionally be connected to the back wall 330 by one or more permanent or releasable connectors 336 (snap, adhesive, melted connection, press-fit connection, etc.).

The trough 300 can optionally include one or more holes or openings 380 that are configured to receive a connector C that is used to secure the trough to a structure. The one or more openings 380 are generally configured to extend from an outer surface of the trough 300 to the internal compartment 370. The one or more openings 380 can be positioned in a variety of locations in the trough 300 (e.g., back wall, bottom wall, rear flange, side walls, etc.). As illustrated in FIGS. 4A-4D, one or more openings 380 are located on back wall 330, and rear flange 332.

The trough 300 can optionally include one or more drainage openings 382 so as to allow liquids to drain from the trough 300 and/or facilitate in removing debris from trough 300. As illustrated in FIGS. 4A-4D, the one or more drainage openings when used can be located in the bottom wall 360, and/or first and/or second side walls 340, 350.

Referring now to FIG. 4H, the trough 300 is connected to a structure such as, but not limited to, a rail or bar 392 on an aerial lift cage 390. The rear flange 332 and/or upper portion of the back wall 300 lies against bar 392 and one or more connectors C (e.g., zip-ties, wire, cord, or other attachment devices) are fitted through one or more openings 380 to secure the trough 300 to the bar 392 of aerial lift cage 390.

Although not illustrated, one or more portions of the internal compartment 370 can optionally include a protective liner as is discussed in more detail below. The protective liner can optionally include a liquid barrier layer that inhibits or prevents liquids to pass fully through the protective liner. The protective liner can be permanently or releasably secured to the top surface of the internal compartment 370 of the trough 300 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the internal compartment 370 of the trough 300 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the internal compartment 370 of the trough 300, the protective liner can be removed and optionally cleaned and then reinserted on internal compartment 370 of the trough 300 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the internal compartment 370 the trough 300. As can also be appreciated, the protective liner can be positioned on other portions of the trough 300. One or more sides of the trough 300 can optionally include logos, instructions, branding, etc.

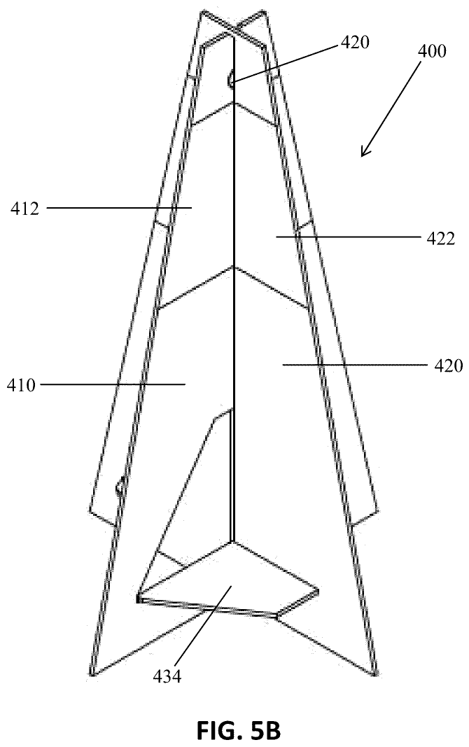

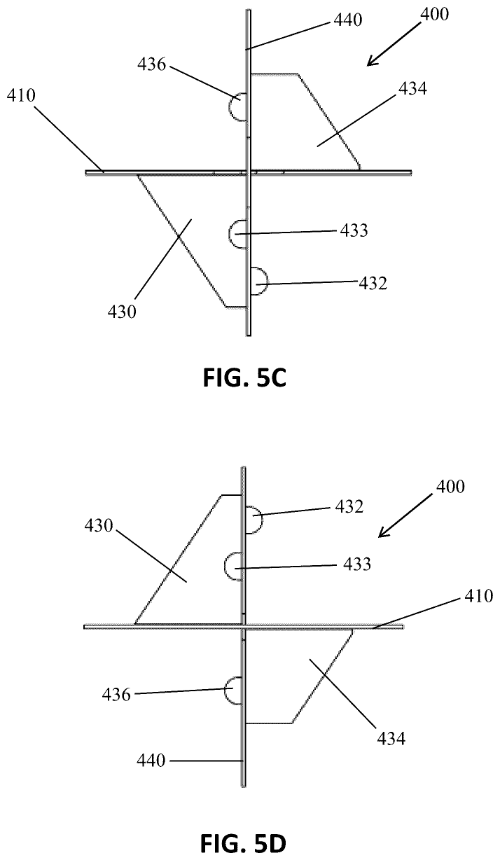

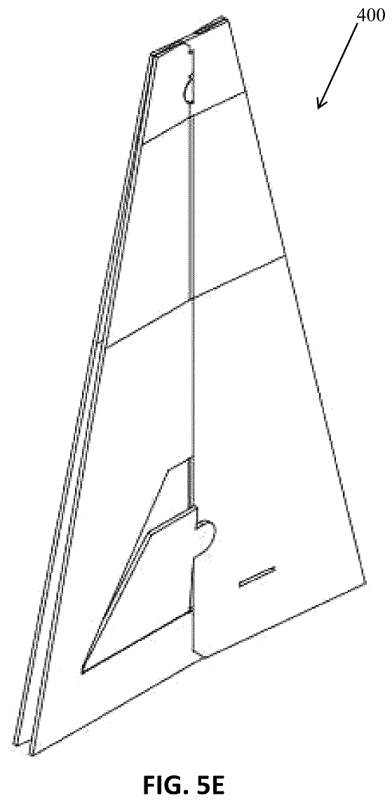

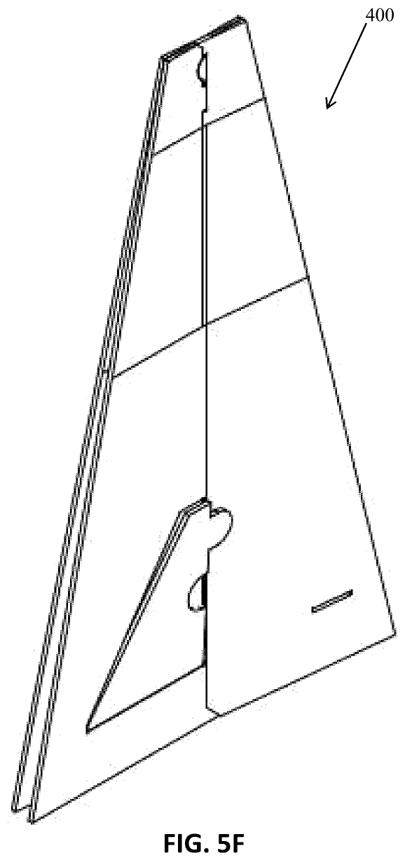

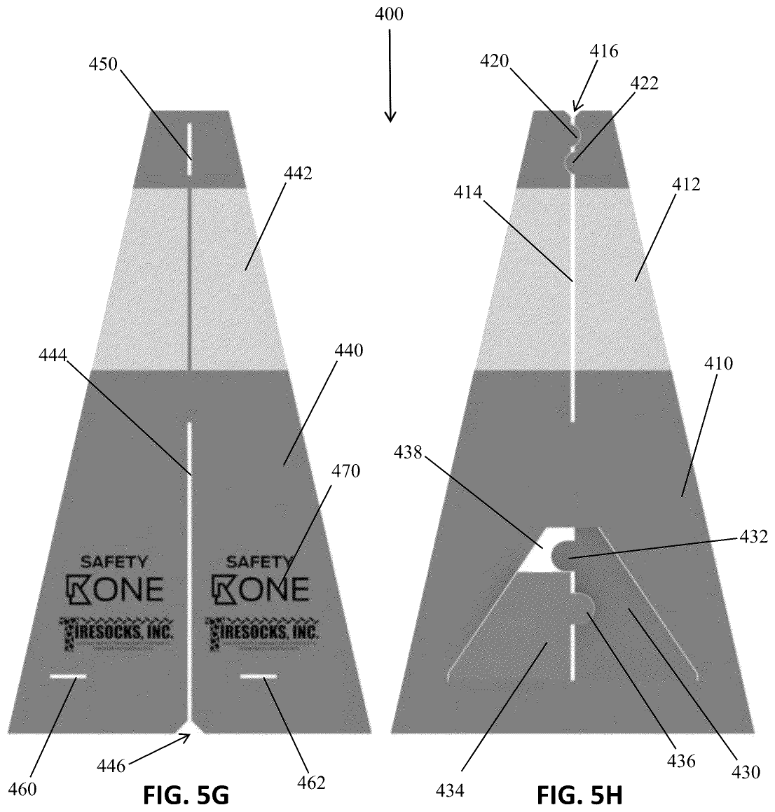

FIGS. 5A-5I illustrate a non-limiting implementation of a foldable and collapsible safety cone 400 in accordance with the present disclosure, and wherein the safety cone is formed from two pieces of corrugated plastic sheet 50. FIG. 5A is a front isometric view of safety cone 400 in an assembled-expanded configuration. FIG. 5B is a rear isometric view of safety cone 400 in the assembled configuration. FIG. 5C is a top plan view of safety cone 400 in the assembled configuration. FIG. 5D is a bottom plan view of safety cone 400 in the assembled configuration. FIG. 5E is a front isometric view of the safety cone 400 in a folded position or collapsed position or substantially flat configuration. FIG. 5F of a rear isometric view of the safety cone 400 in a folded position or collapsed position or substantially flat configuration. FIG. 5G is a front plan view of one of the pieces of the safety cone 400 in an unassembled and flat configuration. FIG. 5H is a front plan view of another of the pieces of the safety cone 400 in an unassembled and flat configuration. FIG. 5I are various view of the a front isometric view of safety cone 400 in a folded position or collapsed position or substantially flat configuration and wherein one or more weights 480 can be attached to the bottom region of the safety cone 400.

Referring now to FIGS. 5A, 5B, 5G and 5H, the safety cone 400 is formed of a first slotted sheet 410 and a second slotted sheet 440 that are each formed form a single piece of corrugated plastic 50. The generally outer edge shape of each of the first slotted sheet 410 and a second slotted sheet 440 can be generally triangular with an optional truncated top that forms a flat top portion. The width and height of the first slotted sheet 410 and a second slotted sheet 440 are non-limiting.

The color of each of the corrugated plastic sheets that forms the first slotted sheet 410 and the second slotted sheet 440 can be orange or some other color or combination of colors. One or more portions of the first slotted sheet 410 and/or the second slotted sheet 440 can optionally include reflective tape 412, 442 or a similar reflective adhesive material that provides enhanced visibility of the safety cone 400; however, this is not required. The location of the reflective tape 412, 442 or a similar reflective adhesive material on the first slotted sheet 410 and/or second slotted sheet 440 is non-limiting. One or more sides of the first slotted sheet 410 and/or second slotted sheet 440 can optionally include logos 470, instructions, branding, etc.

The first slotted sheet 410 includes a top slot 414 that extends at least 20% (e.g., 20-70% and all values and ranges therebetween) of a longitudinal length of the first slotted sheet 410, and starts at the top edge of the first slotted sheet 410. The top portion of the top slot 414 can optionally have a flaring outwardly or tapering outwardly profile 416 that can be used to facilitate in connecting the first slotted sheet 410 to the second slotted sheet 440. Spaced below the top edge of the first slotted sheet 410 is one or more top slot tabs 420, 422. The one or more top slot tabs 420, 422 can be connected to the body of the first slotted sheet 410 by a living hinge or by some other type of hinge. One top slot tab 420 is located on one side of the top slot 414 and the other top slot tab is located on the other side of the top slot 414. The two top slot tabs 420, 422 can have a similar curvature configuration; however, this is not required. The two top slot tabs 420, 422 can be spaced from the top edge of the first slotted sheet 410; however, this is not required. The top slot tabs 420, 422 can each extend across the longitudinal central axis of the top slot 414; however, this is not required. The top slot tabs 420, 422 can be configured to lie in the same flat plane as the body of the first slotted sheet 410 when the first slotted sheet is in the flat or unassembled configuration as illustrated in FIG. 5H. Top slot tabs 420, 422 can be connected to the respective first slotted sheet 410 and/or second slotted sheet 440 by a living hinge; however, this is not required. The first slotted sheet 410 also includes first and second connection flanges 430, 434 that are positioned in a sheet opening 438. The sheet opening 438 is located below the top slot 414 and is spaced from the bottom and side edges of the first slotted sheet 410. The first and second connection flanges 430, 434 are each connected to the body of the first slotted sheet 410 by a hinge (e.g., living hinge, etc.). In one non-limiting configuration, first and second connection flanges 430, 434 are each connected to the body of the first slotted sheet 410 at the bottom of the sheet opening 438. The first and second connection flanges 430, 434 are configured to be independently movable with respect to one another. In one non-limiting configuration, when the first and second connection flanges 430, 434 are in the flat or unassembled configuration as illustrated in FIG. 5H, the first and second connection flanges 430, 434 do not fully cover the sheet opening 438 (e.g., first and second connection flanges cover 40-95% of the sheet opening and all values and ranges therebetween). The first and second connection flanges 430, 434 can each optionally include flange tabs 432, 436. In one non-limiting configuration, each of the first and second connection flanges 430, 434 include a single flange tab 432, 436, and that the flange tabs are configured to face in opposite directions when the first and second connection flanges 430, 434 are in the unassembled or flat configuration as illustrated in FIG. 5H. As illustrated in FIGS. 5C, 5D and 5H, the size of one of the connection flanges can be larger than the other connection flange. In one non-limiting configuration, the first connection flange 430 is larger than the second connection flange 434 and the body of the first connection flange 430 can optionally include a slot or cavity 433 that can receive flange tab 436 on the second connection flange 434 when the first slotted sheet 410 is in the unassembled or flat configuration as illustrated in FIG. 5H. The first and second connection flanges 430, 434 can be configured to lie in the same flat plane as the body of the first slotted sheet 410 when the first slotted sheet is in the unassembled or flat configuration as illustrated in FIG. 5H.

The second slotted sheet 440 includes a bottom slot 444 that extends at least 20% (e.g., 20-70% and all values and ranges therebetween) of a longitudinal length of the second slotted sheet 440, and starts at the bottom edge of the second slotted sheet 440. The bottom portion of the bottom slot 444 can optionally have a flaring outwardly or tapering outwardly profile 446 that can be used to facilitate in connecting the second slotted sheet 440 to the first slotted sheet 410. The second slotted sheet 440 also includes an upper slot 450 is positioned above and spaced from the bottom slot 444. Generally, the length of the upper slot 450 is less than (e.g., 10-90% less and all values and ranges therebetween) the length of the bottom slot 444. In one non-limiting configuration, the central longitudinal axis of the bottom slot 444 and the upper slot 450 are the same; however, this is not required. Positioned on the lower portion of the second slotted sheet 440 includes first and second side slots 460, 462, and where the first side slot 460 is positioned on the opposite side of the bottom slot 444 from the second side slot 462. In one non-limiting configuration, the spacing of the first side slot 460 from the bottom slot 444 can optionally be different from the spacing of the second side slot 462 from the bottom slot 444, and that the first and second side slots 460, 462 are spaced from the bottom slot 444. In another non-limiting configuration, the first and second side slots 460, 462 are spaced from the bottom edge and side edges of the second slotted sheet 440 and that the first and second side slots 460, 462 are spaced closer to the bottom edge of the second slotted sheet 440 than to the top edge of the second slotted sheet 440. In one non-limiting configuration, the central lateral axis of the first and second side slots 460, 462 are the same; however, this is not required.

Referring now to FIGS. 5A-5D, the first slotted sheet 410 and/or second slotted sheet 440 are releasably coupled together such that the first slotted sheet 410 is substantially perpendicular to the second slotted sheet 440. The first and second connection flanges 430, 434 on the first slotted sheet 410 are configured to provide structural stability and rigidity to the assembled safety cone 400. When the safety cone 400 is assembled, the first slotted sheet 410 and second slotted sheet are connected together by inserting the bottom slot 444 of the second slotted sheet 440 into the top slot 414 of the first slotted sheet 410 until the bottom edges of the first and second slotted sheets 410, 440 positioned adjacent to one another, and thereafter the first and second slotted sheets 410, 440 are oriented perpendicular to one another. The slot tabs 420, 422 on the first slotted sheet 410 are inserted (e.g., removably insertable, irremovably insertable) into the upper slot 450 of the second slotted sheet 440 to create strength and/or structural rigidity to the top portion of the safety cone 400. After the first and second slotted sheets 410, 440 are connected together, the first and second connection flanges 430, 434 are bent downwardly (e.g., bent downwardly about the living hinge, etc.) until the flange tab 432, 436 can be insertable (e.g., removably insertable, irremovably insertable) in first and second side slots 460, 462. The positioning of the flange tab 432, 436 into an at least partially through the first and second side slots 460, 462 results in the first and second connection flanges 430, 434 on the first slotted sheet 410 being fixed in positioned relative to the second slotted sheet 440. As can be appreciated, the first and second slotted sheets 410, 440 can optionally be configured to be bent upwardly. As illustrated in FIGS. 5A & 5B, when the first and second connection flanges 430, 434 bent so that flange tab 432, 436 can be insertable in first and second side slots 460, 462, the plane of the first and second connection flanges 430, 434 is generally perpendicular (e.g., 0-20° of perpendicularity and all values and ranges therebetween) of the plane of the body of the first slotted sheet 410.

The safety cone 400 can be a) collapsed by separating the first slotted sheet 410 from the second slotted sheet 440, and then optionally lying flat the slotted sheets together when not in use, or b) folded so that the two slotted sheets lay closely flat to one another while remaining connected to one another as illustrated in FIGS. 5E-5F.

Referring now to FIG. 5I, one or more weights 480 can optionally be connected to the bottom portion of first slotted sheet 410 and/or the second slotted sheet 440 so as to provide additional stability to the safety cone when fully assembled and in use. The type of weights are non-limiting (e.g., metal weights, ceramic weights, plastic weights, composite weights, wood weights, etc.) The size of the one or more weights is non-limiting. In one non-limiting configuration, the one or more weights are positioned below or adjacent to the bottom of opening sheet opening 438 in the first slotted sheet 410 when one or more weights are connected to the first slotted sheet 410, and/or the one or more weights are positioned below or adjacent to the bottom of first and/or second side slots 460, 462 in the second slotted sheet 440 when one or more weights are connected to the second slotted sheet 440. The one or more weights can be connected (e.g., permanently or releasably connected) to the first slotted sheet 410 and/or the second slotted sheet 440 by a variety of arrangements (e.g., adhesive connection, magnet connection, melted connection, snap connection, hook and loop fastener connection, mushroom connection, rivets, screws, clamps, etc.). As illustrated in FIG. 5I, each of the weights 480, includes a weighted body 482, an adhesive backing 484, and a release tape layer 486. In one non-limiting operation, the release tape layer is removed from the one or more weights 480 to expose the top surface of the adhesive backing 484. Thereafter, the weight is connected to the first slotted sheet 410 and/or the second slotted sheet 440 by contacting the adhesive backing 484 with the surface of the first slotted sheet 410 and/or the second slotted sheet 440 to secure the weighted body 482 of the weight 480 to the first slotted sheet 410 and/or the second slotted sheet 440.

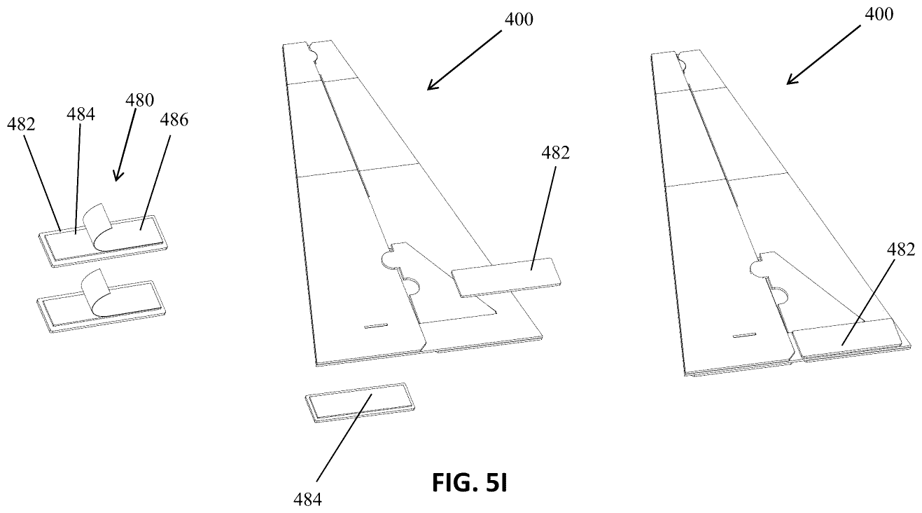

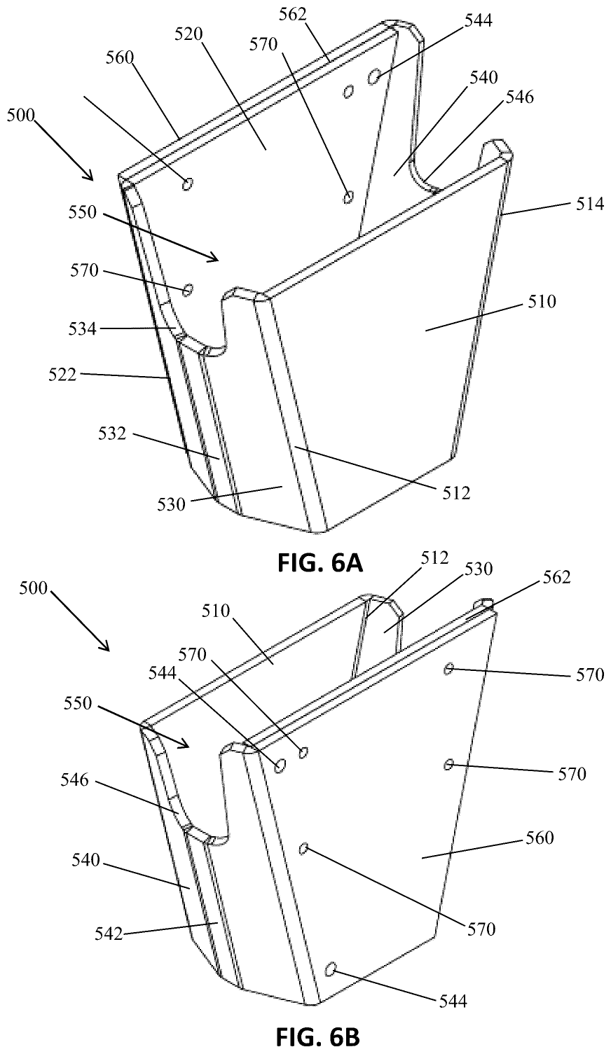

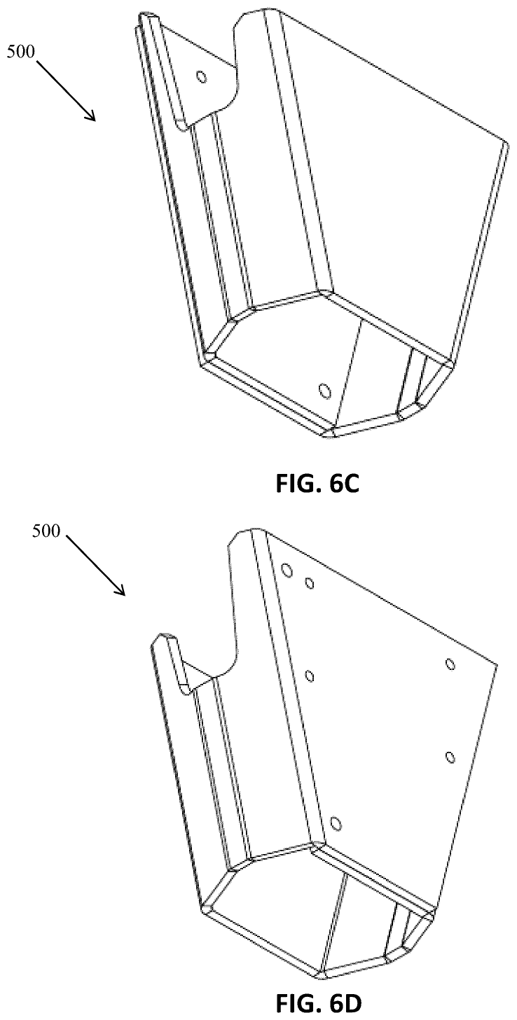

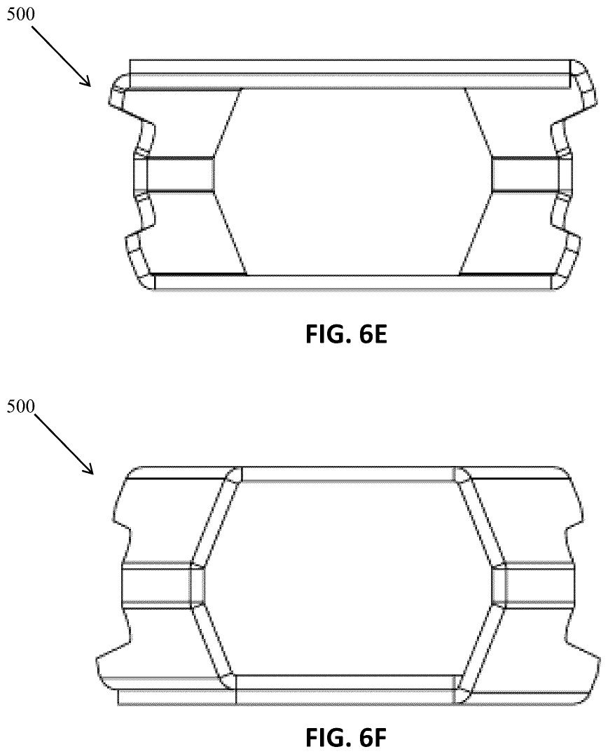

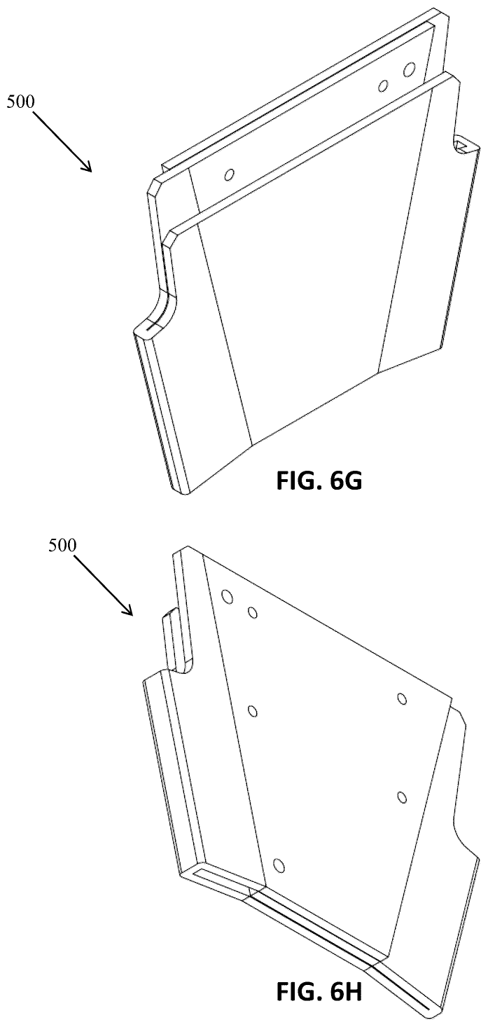

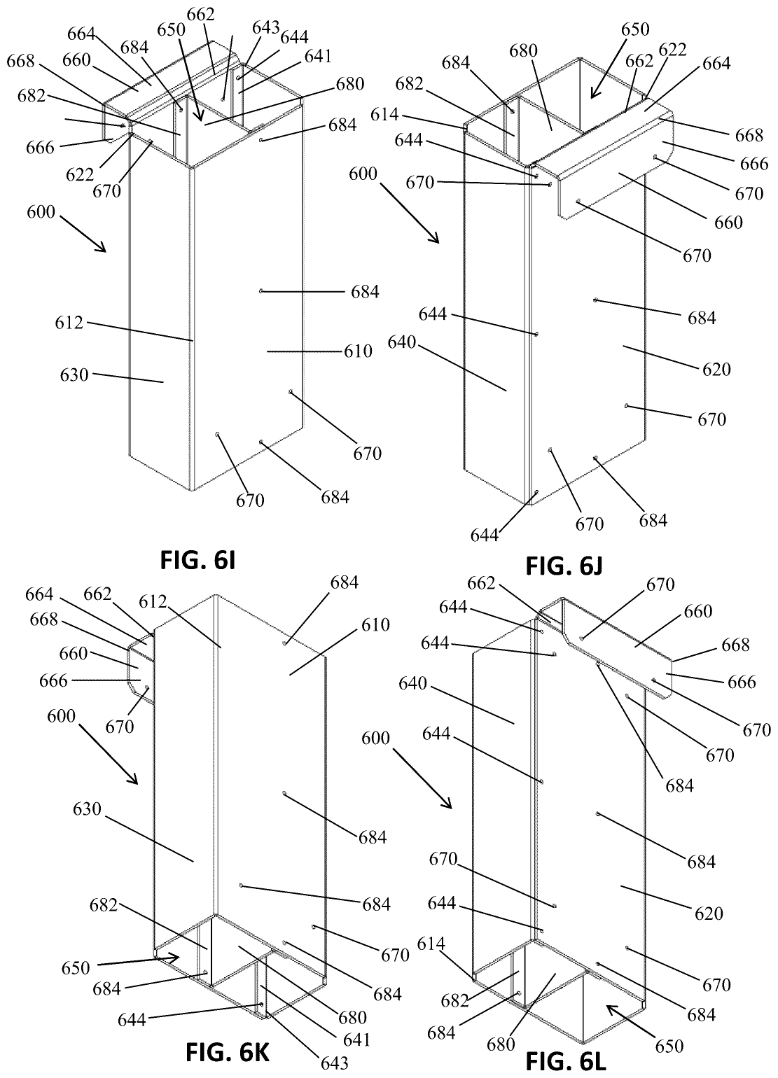

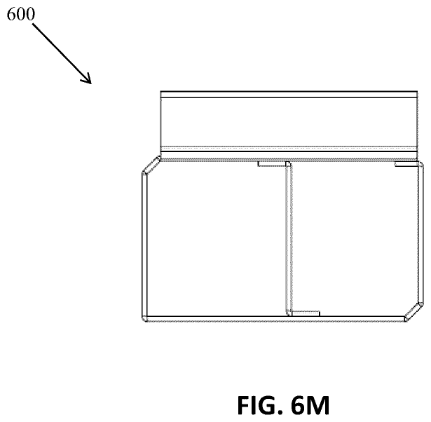

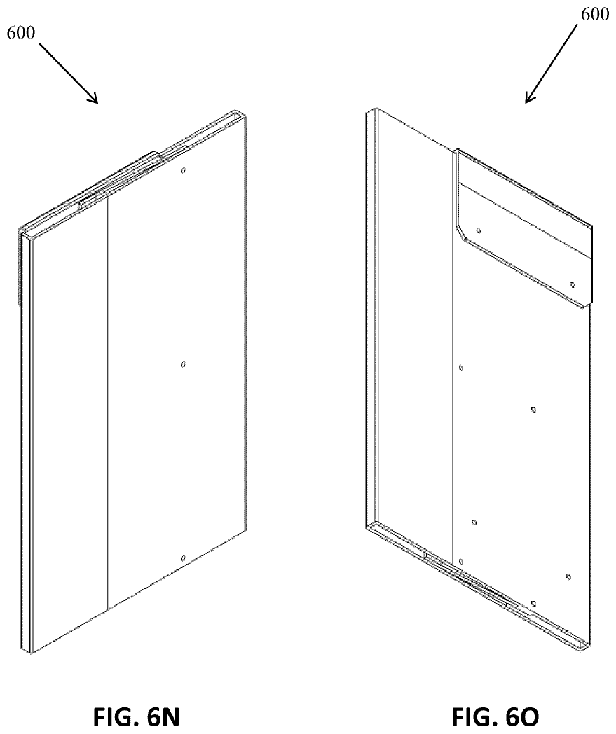

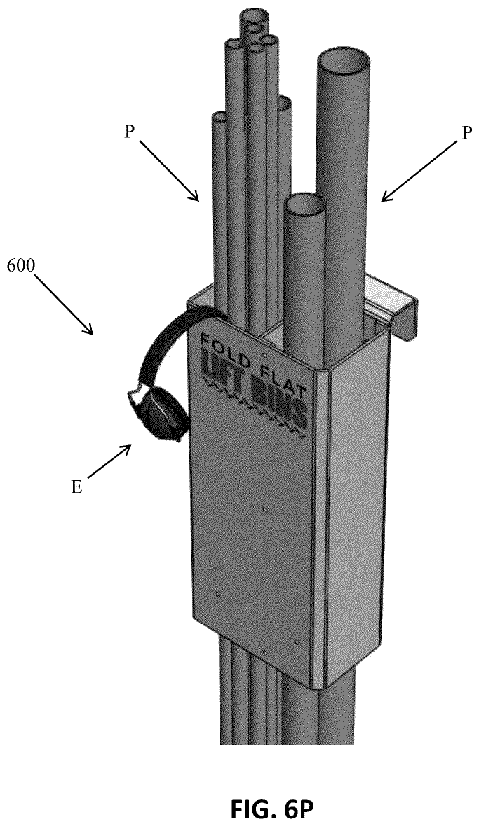

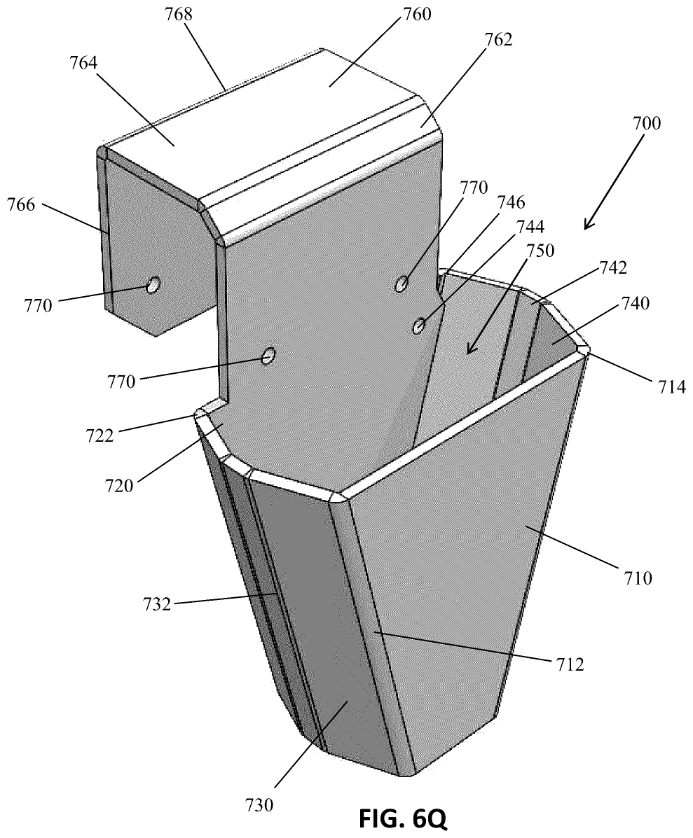

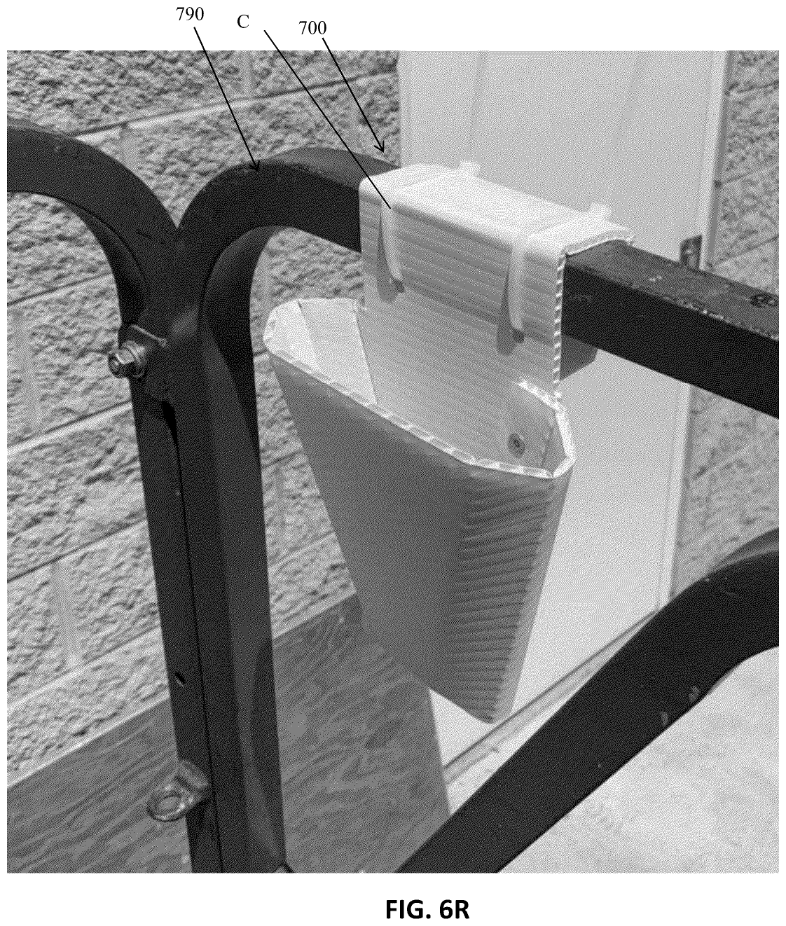

FIGS. 6A-6R illustrate a non-limiting implementation of a foldable and collapsible holster or caddy 500 in accordance with the present disclosure, and wherein the holster or caddy 500 formed from at least one corrugated plastic sheet 50. FIG. 6A is a front-top isometric view of a first non-limiting embodiment of holster or caddy 500 in an assembled-expanded configuration. FIG. 6B is a rear-top isometric view of the first non-limiting embodiment holster or caddy 500 in the assembled configuration. FIG. 6C is a front-bottom isometric view of the first non-limiting embodiment holster or caddy 500 in the assembled configuration. FIG. 6D is a rear-bottom isometric view of the first non-limiting embodiment holster or caddy 500 in the assembled configuration. FIG. 6E is a top plan view of the first non-limiting embodiment holster or caddy 500 in the assemble configuration. FIG. 6F is a bottom plan view of the first non-limiting embodiment holster or caddy 500 in the assembled configuration. FIG. 6G is a front-top isometric view of the first non-limiting embodiment holster or caddy 500 in the unassembled or folded configuration. FIG. 6H is a bottom-rear isometric view of the first non-limiting embodiment holster or caddy 500 in the unassembled or folded configuration. FIG. 6I is a front-top isometric view of a second non-limiting embodiment of holster or caddy 600 in an assembled-expanded configuration. FIG. 6J is a rear-top isometric view of the second non-limiting embodiment holster or caddy 600 in the assembled configuration. FIG. 6K is a front-bottom isometric view of the second non-limiting embodiment holster or caddy 600 in the assembled configuration. FIG. 6L is a rear-bottom isometric view of the second non-limiting embodiment holster or caddy 600 in the assembled configuration. FIG. 6M is a top plan view of the second non-limiting embodiment holster or caddy 600 in the assembled configuration. FIG. 6N is a front-top isometric view of the second non-limiting embodiment holster or caddy 600 in the unassembled or folded configuration. FIG. 6O is a bottom-rear isometric view of the second non-limiting embodiment holster or caddy 600 in the unassembled or folded configuration. FIG. 6P a front-top isometric view of a second non-limiting embodiment of holster or caddy 600 in an assembled-expanded configuration and illustrated a plurality of pipe, rods or the like partially positioned in the holster or caddy 600. FIG. 6Q is a front-top isometric view of a third non-limiting embodiment of holster or caddy 700 in an assembled-expanded configuration. FIG. 6R is a front-top isometric view of the third non-limiting embodiment of holster or caddy 700 in an assembled-expanded configuration that is connected to a portion of an exemplary aerial lift cage 790 or other structure.

Referring now to FIGS. 6A-6H, there is illustrated one non-limiting embodiment of a foldable and collapsible holster or caddy 500. The holster or caddy 500 can be formed of a single piece of material (e.g., sheet of plastic corrugated material 50, etc.). The holster or caddy 500 includes a body formed of a front wall 510, a back wall 520 and first and second side walls 530, 540. The holster or caddy 500 is partially or fully absent a bottom wall. The body forms an internal holster compartment 550 when the holster or caddy 500 is in the assembled-expanded to the unfolded and assembled-expended configuration. Side walls 530, 540 are connected to the front wall 510 and the back wall 520. The front wall 510 is connected to the first and second sides walls 530, 540 by a living hinge 512, 514, and the back wall 520 is connected to the first side wall 530 by a living hinge 522, and the second side wall 540 by one or more connectors 544 that form a detachable connection (e.g., snap, hook and loop fastener, etc.) or a permanent connection (e.g., adhesive, permanent mechanical connection, melted connection, etc.). Alternatively, the back wall 520 is connected to the first and second sides walls 530, 540 by a living hinge, and the front wall 510 is connected to first side wall 530 by a living hinge, and the second side wall 540 by one or more connectors 544 that form a detachable connection (e.g., snap, hook and loop fastener, etc.) or a permanent connection (e.g., adhesive, permanent mechanical connection, melted connection, etc.). The second side wall 540 can optionally include a connection flange that is connected by the one or more connector 544 to the back wall 520 or the front wall 510. The connection flange, when used, can optionally be movable relative to the other portion of the second side wall 540 by a living hinge. As can be appreciated, the back wall 520 or front wall 510 can include the connection flange that is connected to one of the side walls.

Each of the first and second sides walls 530, 540 includes one or more side living hinges 532, 542 to enable the first and second sides walls 530, 540 to be folded and unfolded when the holster or caddy 500 is folded into the unassembled or folded position or collapsed position or substantially flat configuration; and unfolded to the assemble-expanded configuration. Generally, the first and second sides walls 530, 540 have the same number of side living hinges 532, 542. In one non-limiting configuration, each of the first and second sides walls 530, 540 includes a single side living hinges 522, 542 that is located in the middle or mid-region of the first and second sides walls 530, 540 as illustrated in FIGS. 6A & 6B so that the first and second sides walls 530, 530 can be folded in half or nearly in half when the holster or caddy 500 is folded into the folded and substantially flat configuration as illustrated in FIGS. 6G & 6H.

The top edge of the first and second sides walls 530, 540 can optionally include a U-shaped or C-shaped profile 534, 546 in the mid-region of the first and second sides walls 530, 540 as illustrated in FIGS. 6A-6D. Such U-shaped or C-shaped profile can be used to support one or more pipes, rods, tubes or the like when the holster or caddy 500 is in the expanded or assemble configuration.

Referring now to FIGS. 6A-6D, 6G and 6H, the back wall 520 can optionally have a height that is greater (e.g., 5-70% greater and all values and ranges therebetween) than a height of the front wall 510. The longitudinal length of each of the front and back walls 510, 520 is greater (e.g., 10-2000% greater and all values and ranges therebetween) than a longitudinal length of each of the first and second sides walls 530, 540.

Referring now to FIGS. 6A-6F, a rear flange 560 can be positioned on all or a portion of the back wall 520. The rear flange 560 can optionally be a contact surface for the holster or caddy 500 when the holster or caddy 500 is connected to a structure. Rear flange 560 can also or alternatively function to increase the strength and/or rigidity of the holster or caddy 500 when the holster or caddy 500 is in the unfolded or assembled-expanded configuration. In one non-limiting arrangement, the rear flange 560 is optionally connected to the top edge of the back wall 520 by a back living hinge 562. The body of the rear flange 560 can optionally be connected to the back wall 520 by one or more permanent or releasable connectors (snap, adhesive, melted connection, press-fit connection, etc.), which can be the same or different from connectors 544. As illustrated in FIGS. 6A & 6B, the two connectors 544 are used to both partially connect the rear flange 560 to the back wall 520, and also to connect the second side wall 540 to the back wall 520.

The holster or caddy 500 can optionally include one or more holes or openings 570 that are configured to receive a connector, not shown, that is used to secure the holster or caddy 500 to a structure. The one or more openings 570 that are positioned on the front wall 510 or the back wall 520 are generally configured to extend from an outer surface of the holster or caddy 500 to the internal holster compartment 550. The one or more openings 570 can be positioned in a variety of locations on the holster or caddy 500 (e.g., back wall, rear flange, side walls, etc.). As illustrated in FIGS. 6A-6D, one or more openings 570 are located on back wall 520, and rear flange 560.

The bottom of the internal holster compartment 550 is mostly or fully open (60-100% open and all values and ranges therebetween) as illustrated in FIGS. 6C-6F so as to allow tools, pipes, rods, tool handles, etc. to be inserted into the internal holster compartment 550 and through the bottom of the internal holster compartment 550; however, it will be appreciated that the bottom of the internal holster compartment can be partially or fully closed (60-100% fully closed and all values and ranges therebetween).

Referring now to FIGS. 6A-6D, the shape of the front wall 510 and the back wall 520 is generally trapezoidal shape. A length of the top edge of the front wall 510 is longer than a length of the bottom edge of the front wall 510. Likewise, a length of the top edge of the back wall 520 is longer than a length of the bottom edge of the back wall 520. The shape of the rear flange 560 can be the same or similar to the shape of the back wall 520. As illustrated in FIGS. 6E-6F, the cross-sectional area of the internal holster compartment 550 decrease from the top to the bottom of the internal holster compartment when the holster or caddy 500 is in the expanded or assemble configuration.

Although not illustrated, one or more portions of the internal holster compartment 550 can optionally include a protective liner as is discussed in more detail below. The protective liner can optionally include a liquid barrier layer that inhibits or prevents liquids to pass fully through the protective liner. The protective liner can be permanently or releasably secured to one or more portions of the internal holster compartment 550 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the internal holster compartment 550 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the internal holster compartment 550, the protective liner can be removed and optionally cleaned and then reinserted on internal holster compartment 550 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the internal holster compartment 550. As can also be appreciated, the protective liner can be positioned on other portions of the holster or caddy 500. One or more sides of the holster or caddy 500 can optionally include logos, instructions, branding, etc.

Referring now to FIGS. 6I-6P, there is illustrated another non-limiting embodiment of a foldable and collapsible holster or caddy 600. The holster or caddy 600 can be formed of two pieces of material (e.g., sheet of plastic corrugated material 50, etc.). The holster or caddy 600 includes a body formed of a front wall 610, a back wall 620 and first and second side walls 630, 640. The holster or caddy 600 is partially or fully absent a bottom wall. The body forms an internal holster compartment 650 when the holster or caddy 600 is in the assembled-expanded to the unfolded and assembled-expended configuration. Side walls 630, 640 are connected to the front wall 610 and the back wall 620. The front wall 610 is connected to the first and second side walls 630, 640 by a living hinge 612, 614, and the back wall 620 is connected to the first side wall 630 by a living hinge 622, and the second side wall 640 by one or more connectors 644 that form a detachable connection (e.g., snap, hook and loop fastener, etc.) or a permanent connection (e.g., adhesive, permanent mechanical connection, melted connection, etc.). Alternatively, the back wall 620 is connected to the first and second sides walls 630, 640 by a living hinge, and the front wall 610 is connected to first side wall 630 by a living hinge, and the second side wall 640 by one or more connectors 644 that form a detachable connection (e.g., snap, hook and loop fastener, etc.) or a permanent connection (e.g., adhesive, permanent mechanical connection, melted connection, etc.). The second side wall 640 can optionally include a connection flange 641 that is connected by the one or more connector 644 to the back wall 620 or the front wall 610. The connection flange 641, when used, can optionally be movable relative to the other portion of the second side wall 540 by a living hinge 643. As can be appreciated, the back wall 620 or front wall 610 can include the connection flange that is connected to one of the side walls. The longitudinal length of each of the front and back walls 610, 620 is greater (e.g., 10-2000% greater and all values and ranges therebetween) than a longitudinal length of each of the first and second sides walls 630, 640. The front wall 610, back wall 620, and side walls 630, 640 each have a rectangular shape. The shape and size of the front wall 610 and back wall 620 are the same. The shape and size of the first and second side walls are the same.

A rear flange 660 can be connected to the top edge of the back wall 620 by a back living hinge 662. The rear flange 660 can include a first portion 664 and a second portion 666 that are connected together by a living hinge 668 such that the first and second portions 664, 666 can move relative to one another. As illustrated in FIGS. 6I-6L, the first and second portions 664, 668 of the rear flange 660 can be bent such that the plane of the first portion 664 is generally perpendicular (e.g., 0-20° within perpendicularity and all valves and ranges therebetween) to the plane of the back wall 620, and the plane of the second portion 666 is generally parallel (e.g., 0-20° within being parallel and all valves and ranges therebetween) to the plane of the back wall 620; however, it can be appreciated that the first and second portions can be bent to other angles relative to the back wall 620.

The holster or caddy 600 can optionally include one or more holes or openings 670 that are configured to receive a connector (e.g., zip-tie, wire, cord, etc.), not shown, that is used to secure the holster or caddy 600 to a structure such as, but not limited to, a cage of an aerial lift. The one or more openings 670 that are positioned on the front wall 610 or the back wall 620 are generally configured to extend from an outer surface of the holster or caddy 600 to the internal holster compartment 650. The one or more openings 670 can be positioned in a variety of locations on the holster or caddy 600 (e.g., back wall, front wall, rear flange, etc.). As illustrated in FIGS. 6I-6L, one or more openings 670 are located on front wall 610, back wall 620, and rear flange 660.

The bottom of the internal holster compartment 650 is mostly or fully open (60-100% open and all values and ranges therebetween) as illustrated in FIGS. 6K-6M so as to allow tools, pipes, rods, tool handles, etc. to be inserted into the internal holster compartment 650 and through the bottom of the internal holster compartment 650; however, it will be appreciated that the bottom of the internal holster compartment can be partially or fully closed (60-100% fully closed and all values and ranges therebetween).

The internal holster compartment 650 can optionally include one or more divider flanges 680 that divides the internal holster compartment 650 into two or more compartments. As illustrated in FIGS. 6I-6M, the internal holster compartment 650 includes a single divider flange 680 that divides the internal holster compartment 650 into two compartments. Each side of the divider flange includes a connection flange 682 that is connected to either the front wall 610 or back wall 620 by a divider connector 684. Referring now to FIG. 6P, internal holster compartment 650 the holster or caddy 600 includes two compartments that are illustrated as containing a portion of pipes P. In one compartment, one size of pipe P is partially positioned in the compartment, and the other compartment includes different sized pipes P that are partially positioned in such compartment. As such the two compartments can be used to organize materials that are positioned in the two compartments. As also illustrated in FIG. 6P, a set of ear protectors E are partially hanging in one of the compartments. As can be appreciated, many different items can be partially positioned in the internal holster compartment 650.

Although not illustrated, one or more portions of the internal holster compartment 650 can optionally include a protective liner as is discussed in more detail below. The protective liner can optionally include a liquid barrier layer that inhibits or prevents liquids to pass fully through the protective liner. The protective liner can be permanently or releasably secured to one or more portions of the internal holster compartment 650 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the internal holster compartment 650 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the internal holster compartment 650, the protective liner can be removed and optionally cleaned and then reinserted on internal holster compartment 650 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the internal holster compartment 650. As can also be appreciated, the protective liner can be positioned on other portions of the holster or caddy 600. One or more sides of the holster or caddy 600 can optionally include logos, instructions, branding, etc.

Referring now to FIGS. 6Q-6R, there is illustrated another non-limiting embodiment of a foldable and collapsible holster or caddy 700. The holster or caddy 700 can be formed of a single piece of material (e.g., single sheet of plastic corrugated material 50, etc.). The holster or caddy 700 includes a body formed of a front wall 710, a back wall 720 and first and second side walls 730, 740. The holster or caddy 700 illustrated can be partially or fully absent a bottom wall. The body forms an internal holster compartment 750 when the holster or caddy 700 is in the assembled-expanded to the unfolded and assembled-expended configuration. Side walls 730, 740 are connected to the front wall 710 and the back wall 720. The front wall 710 is connected to the first and second sides walls 730, 740 by a living hinge 712, 714, and the back wall 720 is connected to the first side wall 730 by a living hinge 722, and the second side wall 740 by one or more connectors 744 that form a detachable connection (e.g., snap, hook and loop fastener, etc.) or a permanent connection (e.g., adhesive, permanent mechanical connection, melted connection, etc.). Alternatively, the back wall 720 is connected to the first and second sides walls 730, 740 by a living hinge, and the front wall 710 is connected to first side wall 730 by a living hinge, and the second side wall 740 by one or more connectors 744 that form a detachable connection (e.g., snap, hook and loop fastener, etc.) or a permanent connection (e.g., adhesive, permanent mechanical connection, melted connection, etc.). The second side wall 740 can optionally include a connection flange 746 that is connected by the one or more connector 744 to the back wall 720 or the front wall 710. The connection flange 746, when used, can optionally be movable relative to the other portion of the second side wall 740 by a living hinge. As can be appreciated, the back wall 720 or front wall 710 can include the connection flange that is connected to one of the side walls.

Each of the first and second sides walls 730, 740 includes one or more side living hinges 732, 742 to enable the first and second sides walls 730, 740 to be folded and unfolded when the holster or caddy 700 is folded into the unassembled or folded position or collapsed position or substantially flat configuration; and unfolded to the assemble-expanded configuration. Generally, the first and second sides walls 730, 740 have the same number of side living hinges 732, 742. In one non-limiting configuration, each of the first and second sides walls 730, 740 includes a single side living hinge 732, 742 that is located in the middle or mid-region of the first and second sides walls 730, 740 as illustrated in FIGS. 6Q & 6R so that the first and second sides walls 730, 730 can be folded in half or nearly in half when the holster or caddy 700 is folded into the folded and substantially flat configuration.

A rear flange 760 can be connected to the top edge of the back wall 720 by a back living hinge 762. The rear flange 760 can include a first portion 764 and a second portion 766 that are connected together by a living hinge 768 such that the first and second portions 764, 766 can move relative to one another. As illustrated in FIGS. 6Q-6R, the first and second portions 764, 768 of the rear flange 760 can be bent such that the plane of the first portion 764 is generally perpendicular (e.g., 0-20° within perpendicularity and all valves and ranges therebetween) to the plane of the back wall 720, and the plane of the second portion 766 is generally parallel (e.g., 0-20° within being parallel and all valves and ranges therebetween) to the plane of the back wall 720; however, it can be appreciated that the first and second portions can be bent to other angles relative to the back wall 720.

The holster or caddy 700 can optionally include one or more holes or openings 770 that are configured to receive a connector C (e.g., zip-tie, cord, wire, rope, twine, chain, etc.) that is used to secure the holster or caddy 700 to a structure such as a bar 790 on a cage of an aerial lift or some other structure (e.g., ladder, rail, fence, cage, etc.) as illustrated in FIG. 6R. The one or more openings 770 that are positioned on the front wall 710 or the back wall 720 are generally configured to extend from an outer surface of the holster or caddy 700 to the internal holster compartment 750. The one or more openings 770 can be positioned in a variety of locations on the holster or caddy 700 (e.g., back wall, rear flange, side walls, etc.). As illustrated in FIGS. 6Q-6R, one or more openings 770 are located on back wall 720, and rear flange 760.

The bottom of the internal holster compartment 750 is mostly or fully open (60-100% open and all values and ranges therebetween) so as to allow tools, pipes, rods, tool handles, etc. to be inserted into the internal holster compartment 750 and through the bottom of the internal holster compartment 750; however, it will be appreciated that the bottom of the internal holster compartment can be partially or fully closed (60-100% fully closed and all values and ranges therebetween).

Referring now to FIGS. 6Q-6R, the shape of the front wall 710 and the back wall 720 is generally trapezoidal shape. A length of the top edge of the front wall 710 is longer than a length of the bottom edge of the front wall 710. Likewise, a length of the top edge of the back wall 720 is longer than a length of the bottom edge of the back wall 720. The cross-sectional area of the internal holster compartment 750 decreases from the top to the bottom of the internal holster compartment when the holster or caddy 700 is in the expanded or assemble configuration.

Although not illustrated, one or more portions of the internal holster compartment 750 can optionally include a protective liner as is discussed in more detail below. The protective liner can optionally include a liquid barrier layer that inhibits or prevents liquids to pass fully through the protective liner. The protective liner can be permanently or releasably secured to one or more portions of the internal holster compartment 750 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the internal holster compartment 750 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the internal holster compartment 750, the protective liner can be removed and optionally cleaned and then reinserted on internal holster compartment 750 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the internal holster compartment 750. As can also be appreciated, the protective liner can be positioned on other portions of the holster or caddy 700. One or more sides of the holster or caddy 500 can optionally include logos, instructions, branding, etc.

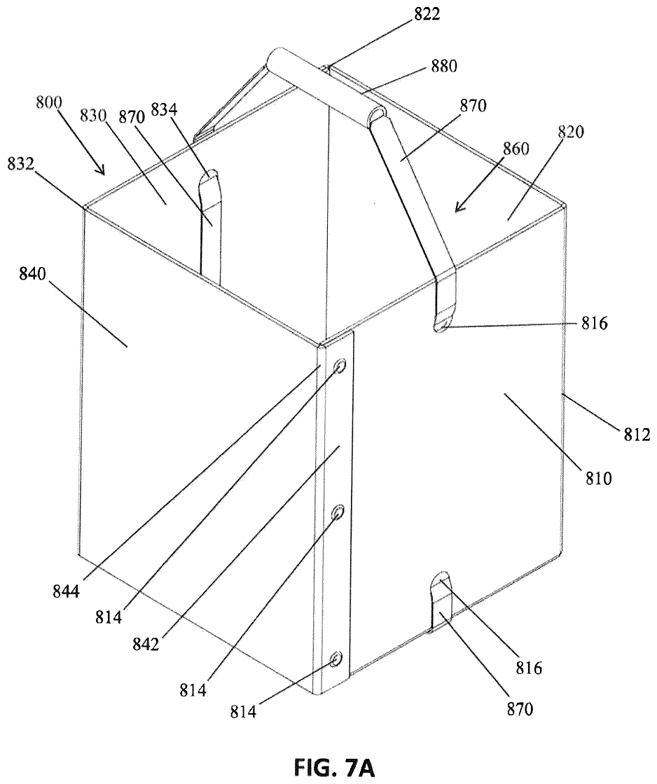

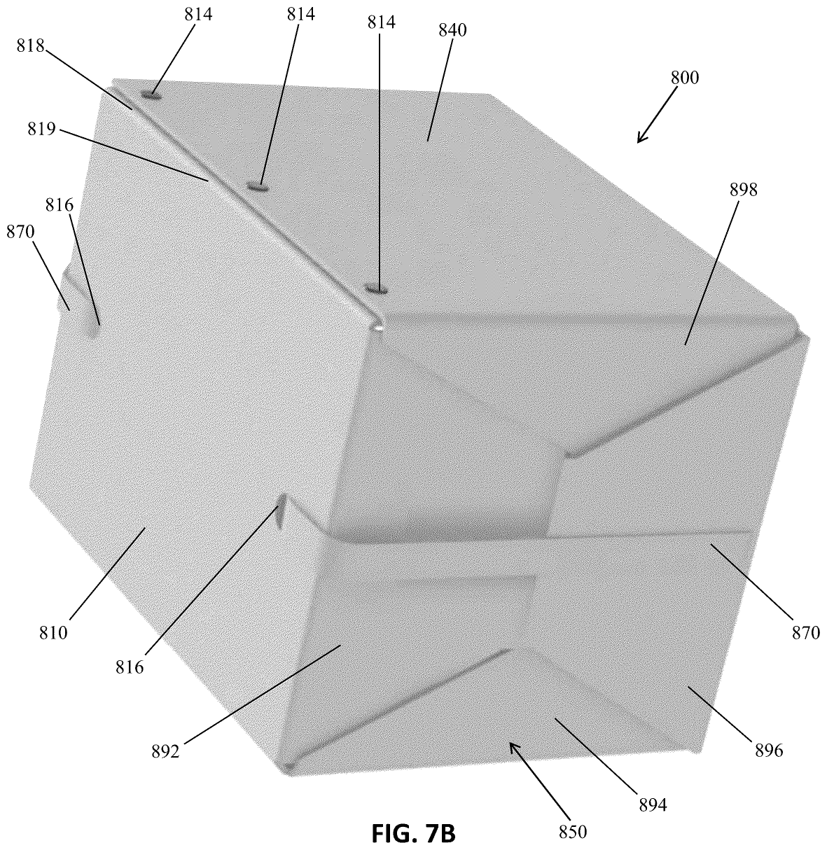

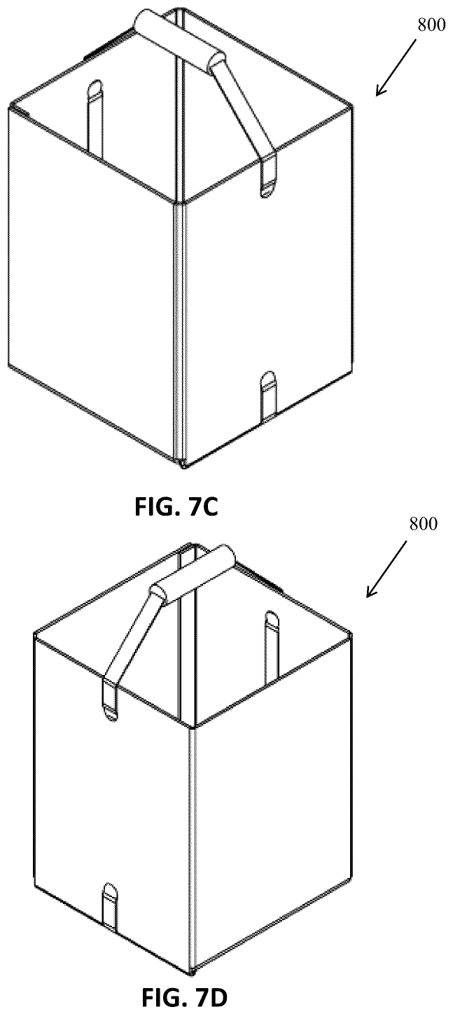

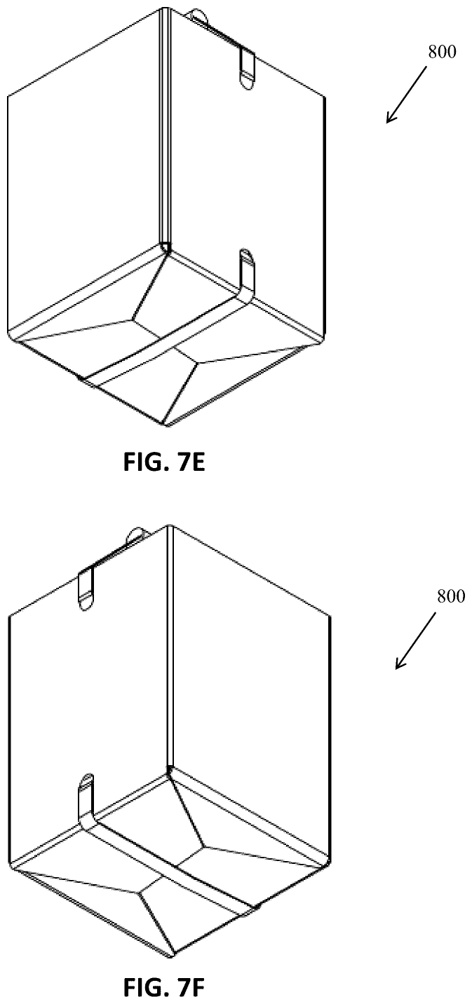

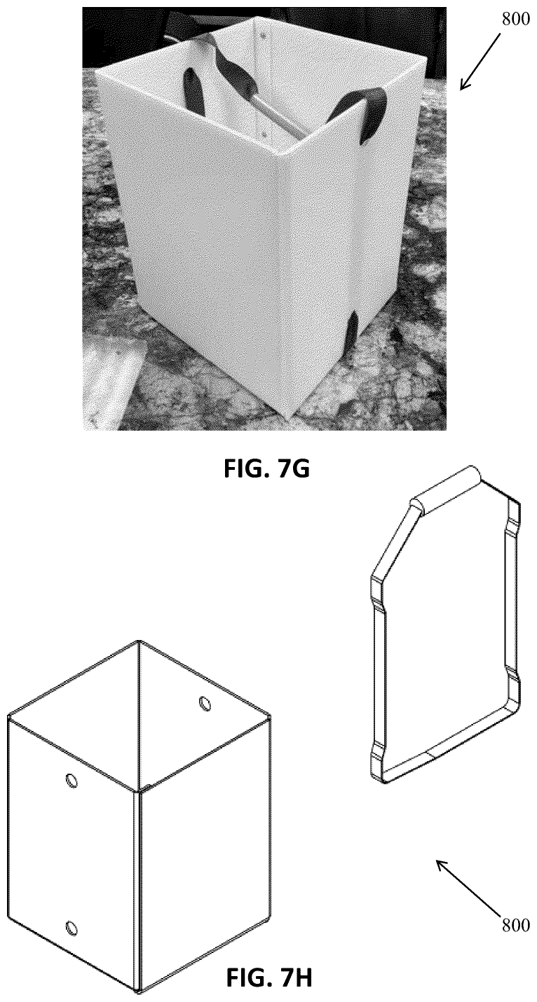

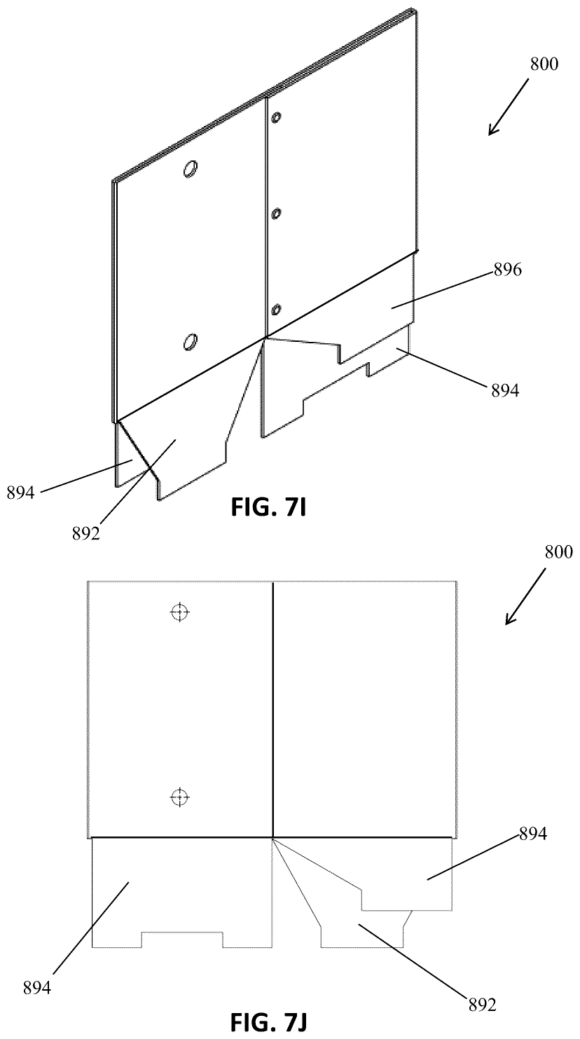

Referring now to FIGS. 7A-7J, there is illustrate a non-limiting implementation of a foldable and collapsible bucket 800 formed from one or more corrugated plastic sheets. FIG. 7A is a front-top isometric view of the bucket 800 in the unfolded and assembled configuration. FIG. 7B is a front-bottom isometric view of the bucket 800 in the unfolded and assembled configuration having a modified connection arrangement. FIG. 7C is a back-top isometric view of the bucket 800 in the unfolded and assembled configuration. FIG. 7D is a side-top isometric view of the bucket 800 in the unfolded and assembled configuration. FIG. 7E is a back-bottom isometric view of the bucket 800 in the unfolded and assembled configuration. FIG. 7F is a side-bottom isometric view of the bucket 800 in the unfolded and assembled configuration. FIG. 7G is a side-top isometric view of the bucket 800 in the unfolded and assembled configuration. FIG. 7H is an exploded view of the bucket 800 in the unfolded position and the strap 870 and handle 880 separated from the bucket 800. FIG. 7I is a front-top isometric view of the bucket 800 in the folded and unassembled configuration and flat configuration. FIG. 7J is a back plan view of the bucket 800 in the folded and unassembled configuration and flat configuration.

The bucket 800 includes side walls 810, 820, 830, 840 and a bottom surface 850 that defines bucket compartment 860 when the bucket 800 is in the unfolded and assembled configuration. Side wall 810 is connected to side wall 820 by a living hinge 812. Side wall 820 is connected to side wall 830 by a living hinge 822. Side wall 830 is connected to side wall 840 by a living hinge 832. Side wall 840 is connected to side wall 810 by one or more permanent or releasable connectors 814 (snap, adhesive, melted connection, press-fit connection, etc.). In one non-limiting configuration, connectors 814 are a plurality of releasable snap connectors that are spaced from one another at different heights along a side portion of side wall 810. Side wall 840 optionally includes a side connection flange 842 that is connected to the body of side wall 840 by a living hinge 844. The connectors 814 are configured to permanently or releasably connect the side connection flange 842 to the front face or back face of side wall 810 when the bucket 800 is in the unfolded and assembled configuration. As illustrated in FIG. 7A, the plurality of connectors 814 permanently or releasably connect the side connection flange 842 to the front face of side wall 810 when the bucket 800 is in the unfolded and assembled configuration. Referring now to FIG. 7A, the bucket is modified such that side wall 810 includes a side connection flange 818 that is connected to the body of the side wall 819 by a living hinge 819. A plurality of connectors 814 permanently or releasably connect the side connection flange 818 to the back face of side wall 840, or alternatively the front face of side wall 840, when the bucket 800 is in the unfolded and assembled configuration. The size and shape of each of the side walls can be the same (e.g., square-shaped, rectangular shaped, etc.).

Side walls 810, 830 can optionally each include one or more strap openings 816, 834 that are configured to receive a strap 870 of a strap and handle 880 arrangement. The one or more strap openings 816, 834 are spaced from the edges of side walls 810, 830. As illustrated in FIGS. 7A-7G, the strap 870 runs over a portion of the inside surface and outside surface of side walls 810, 830, and over the bottom of the bottom surface 810 when the bucket 800 is in the unfolded and assembled configuration. As illustrated in FIGS. 7A-7G, the strap 870 runs over more of the inside surface of side walls 810, 830 than over the outside surface of side walls 810, 830; however, this is not required. The strap openings 816, 834 on side walls 810, 830 can be positioned directly opposite from one another when the bucket 800 is in the unfolded and assembled configuration. As illustrated in FIGS. 7A-7G, the strap openings 816, 834 on side walls 810, 830 that are located on the bottom portion (e.g., bottom-central portion) are positioned directly opposite from one another when the bucket 800 is in the unfolded and assembled configuration, and the strap openings 816, 834 on side walls 810, 830 that are located on the top portion (e.g., top-central portion) are positioned directly opposite from one another when the bucket 800 is in the unfolded and assembled configuration. When two or more strap openings 816, 834 are located on one or both of side walls 810, 830, the two or more strap openings 816, 834 located on each side wall are aligned along the same vertical axis of the side wall. As illustrated in FIGS. 7A-7G, when side walls 810, 830 each include two strap openings 816, 834, one strap opening is located near the top edge of the side wall and the other strap opening is located near the bottom edge of the side wall, and each of the spacing of the strap opening from the top edge of the side wall and the spacing of the strap opening from the bottom edge of the side wall is less (at least 10% less, 10-10000% less and all values and ranges therebetween) than the spacing between the strap openings located on the same side wall.

Referring now to FIGS. 7B, 7E and 7F, the bottom surface 850 is formed from a plurality of bottom flaps 890, 892, 894, 896 that are folded together. Bottom flap 890 is handedly connected (e.g., living hinge, etc.) to side wall 810. Bottom flap 892 is handedly connected (e.g., living hinge, etc.) to side wall 820. Bottom flap 894 is handedly connected (e.g., living hinge, etc.) to side wall 830. Bottom flap 894 is handedly connected (e.g., living hinge, etc.) to side wall 840. When the bottom flaps are folded together to form the bottom surface 850 when the bucket 800 is in the unfolded and assembled configuration, the strap 870 that is positioned under the bottom of the bottom surface 850 facilitates in supporting the bottom surface 850 and maintaining the folded together bottom flaps when the bucket compartment 860 includes one or more materials. As can be appreciated, more than one strap 870 can be configured to run underneath the bottom surface 850 in supporting the bottom surface 850 and maintaining the folded together bottom flaps when the bucket compartment 860 includes one or more materials.

The bottom flaps 890, 892, 894, 896 are configured to overlap one another to form bottom surface 850. The two or more of the bottom flaps 890, 892, 894, 896 can be optionally connected together, not shown by use of a connector (e.g., snap, hook and loop fasteners, dual lock fasteners, mushroom hook fasteners, zipper, strap, adhesive, rib and groove connection, wire, slot arrangement, rivets, heat melted seam, tie arrangement [e.g., tied with cord, chin, rope, wire, etc.], etc.). As illustrated in FIGS. 7A-7J, the configuration of two or more of the bottom flaps 890, 892, 894, 896 is different. As best illustrated in FIGS. 7I-7J, at least two (e.g., 2-4 and all values and ranges therebetween) of the bottom flaps 890, 892, 894, 896 has a different configuration. In one non-limiting configuration two of the bottom flaps have the same or similar configuration (e.g., side flaps 894, 896), and the other bottom flaps have different configurations from one another.

As illustrated in FIG. 7A, a handle 880 can be releasably or permanently connected to the strap 770. In one non-limiting configuration, the handle 880 is formed of a rigid or semi-rigid material (e.g., plastic, metal, fiber board, ceramic, composite material, etc.) and can optionally have a tubular configuration. The handle 880 can optionally include an internal cavity that extends the fully longitudinal length of the handle so that a portion of the strap can be positioned in and through the internal cavity.

The bucket 800 can optionally be configured to be filled with paint or other liquid. When the bucket 800 is used to hold liquids, a plastic liner or water-proof liner (not shown) can be inserted into the bucket to inhibit or prevent leakage of liquid from the bucket 800. The bucket 800 can be configured to contain tools, instruments, or accessories. In one non-limiting embodiment, the bucket 800 is at least a 0.25 gallon bucket (e.g., 0.25-20 gallon bucket and all values and ranges therebetween).

The bucket 800 can be configured to be collapsible into a substantially flat configuration when not in use as illustrated in FIGS. 7I-7J. Although not shown, the bucket 800 can optionally include one or more drainage openings in the bottom surface 850 so as to allow liquids to drain from the bottom surface 850 of the bucket 800 and/or facilitate in removing debris from the bottom surface 850 of the bucket 800. The number, size and/or location of the optional one or more drainage openings is non-limiting. Although not illustrated, the bucket compartment 860 can optionally include a protective liner as is discussed in more detail below. The protective liner can optionally include a liquid barrier layer that inhibits or prevents liquids to pass fully through the protective liner. The protective liner can be permanently or releasably secured to the top surface of the bottom surface 850 of the bucket 800 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the top surface of the bottom surface by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the top surface of the bottom surface 850, the protective liner can be removed and optionally cleaned and then reinserted on the top surface of the bottom surface 850 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the interior surface of the bucket compartment 860 of the bucket 800. As can also be appreciated, the protective liner can be positioned on other portions of the bucket 800. One or more sides of the bucket 800 can optionally include logos, instructions, branding, etc.

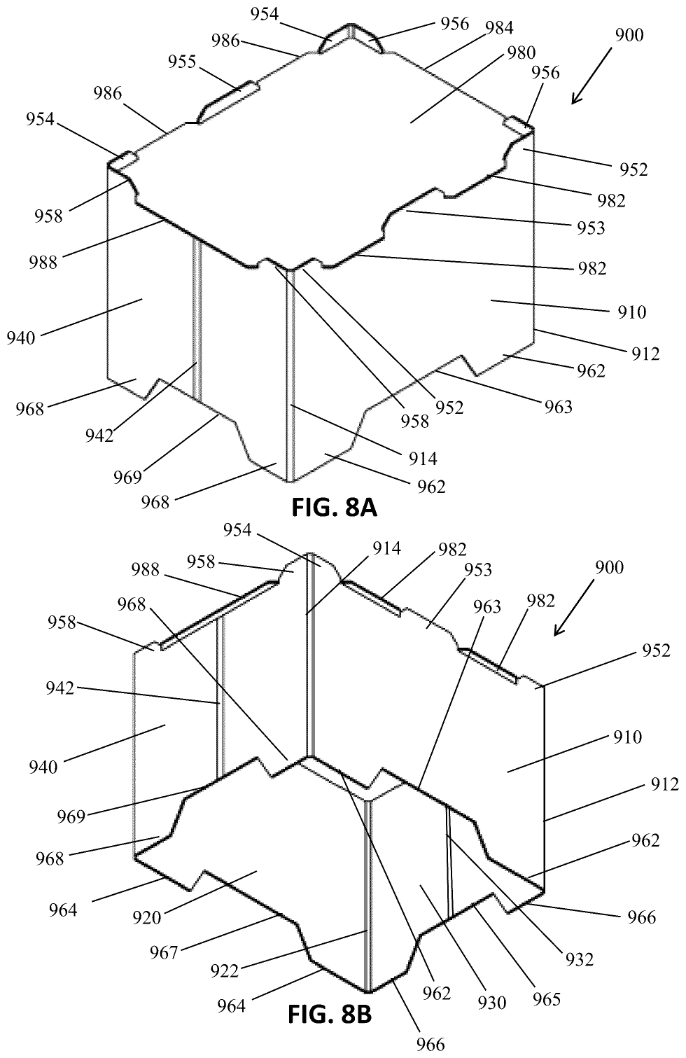

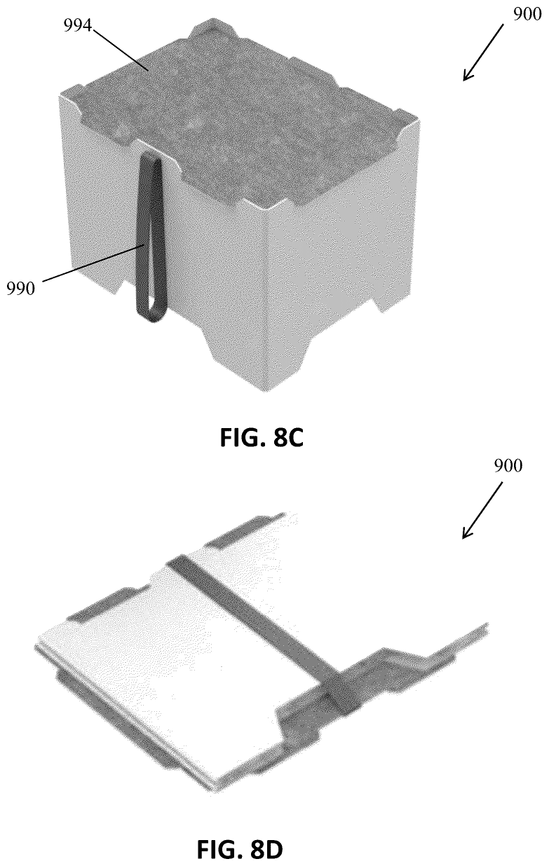

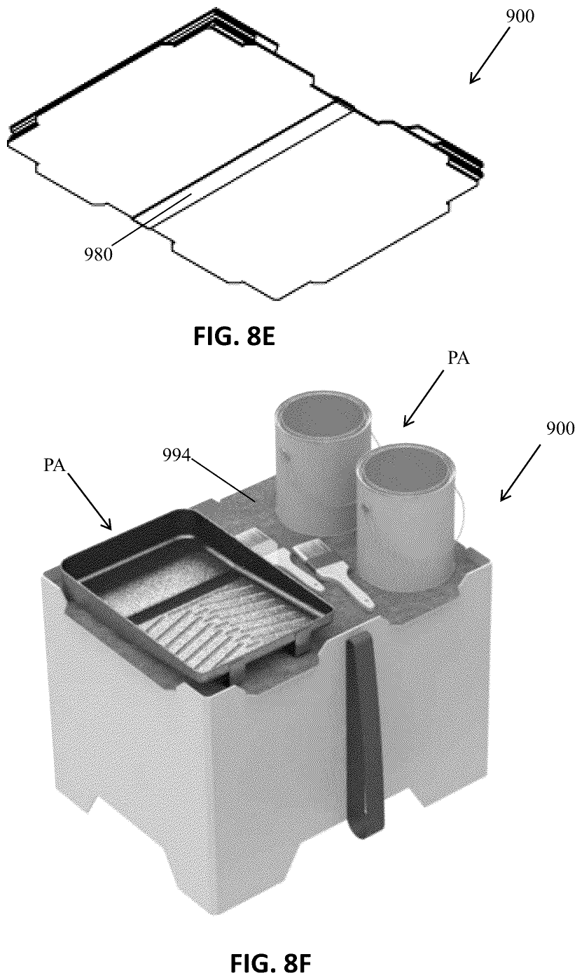

Referring now to FIGS. 8A-8F, there is illustrate a non-limiting implementation of a foldable and collapsible platform 900 formed from one or more corrugated plastic sheets. FIG. 8A is a front-top isometric view of the platform 900 in the unfolded and assembled configuration. FIG. 8B is a front-bottom isometric view of the platform 900 in the unfolded and assembled configuration. FIG. 8C is a top-side isometric view of the platform 900 in the unfolded and assembled configuration. FIG. 8D is a front-top isometric view of the platform 900 in the folded and unassembled configuration and flat configuration. FIG. 8E is a bottom isometric view of the platform 900 in the folded and unassembled configuration and flat configuration. FIG. 8F is a front-top isometric view of the platform 900 in the unfolded and assembled configuration that includes a plurality of items on the top surface of the platform 900.

Referring now to FIGS. 8A-8B, the platform 900 can be formed of two pieces of material (e.g., sheet of plastic corrugated material 50, etc.). The platform 900 includes a body and top board 980. The body is formed of a front wall 910, a back wall 920 and first and second side walls 930, 940. The platform 900 can be partially or fully absent a bottom wall. The platform includes a top board 950 that is configured to be placed on a top portion of the body when the platform 900 is in the assembled-expanded to the unfolded and assembled-expended configuration. The top board 980 is formed of a separate piece of material from the body (e.g., wood, metal, ceramic, glass, plastic, corrugated plastic, fiber board, cardboard, composite material, etc.). The material used to form the body and the top board can be the same; however, this is not required. In one non-limiting configuration, the material used to form the body and the top board are the same. In another non-limiting configuration, the material used to form the body and the top board are different.

Side walls 930, 940 are connected to the front wall 910 and the back wall 920. The front wall 910 is connected to the first and second sides walls 930, 940 by a living hinge 912, 914, and the back wall 920 is connected to the first side wall 930 by a living hinge 922, and the second side wall 940 by one or more connectors that form a detachable connection (e.g., snap, hook and loop fastener, etc.) or a permanent connection (e.g., adhesive, permanent mechanical connection, melted connection, etc.). Alternatively, the back wall 920 is connected to the first and second sides walls 930, 940 by a living hinge, and the front wall 910 is connected to first side wall 930 by a living hinge, and the second side wall 940 by one or more connectors that form a detachable connection (e.g., snap, hook and loop fastener, etc.) or a permanent connection (e.g., adhesive, permanent mechanical connection, melted connection, etc.). The second side wall 940 can optionally include a connection flange that is connected by the one or more connectors to the back wall 920 or the front wall 910. The connection flange, when used, can optionally be movable relative to the other portion of the second side wall by a living hinge. As can be appreciated, the back wall 920 or front wall 910 can include the connection flange that is connected to one of the side walls. The longitudinal length of each of the front and back walls 910, 920 is greater (e.g., 10-2000% greater and all values and ranges therebetween) than a longitudinal length of each of the first and second sides walls 930, 940; however, it can be appreciated that the longitudinal length of the first and second side walls and the front and back walls is the same. The front wall 910, back wall 920, and side walls 930, 940 each have a square or rectangular shape. The shape and size of the front wall 910 and back wall 920 are the same. The shape and size of the first and second side walls 930, 940 are the same.

As illustrated in FIGS. 8A-8B, the body of the platform 900 includes has a box-like shape and the top of the body has a resting surface or top surface and a plurality of support legs 952, 953, 954, 955, 956, 958 that are formed by the front wall 910, back wall 920, and first and second side walls 930, 940. Likewise, the bottom of the body has a plurality of bottom legs 962, 964, 966, 968 that are formed by the front wall 910, back wall 920, and first and second side walls 930, 940. A raised bottom portion 963, 965, 957, 969 is positioned between two adjacently positioned bottom legs. In one non-limiting configuration the raised bottom portions on the front and back walls have the same size and configuration, and the raised bottom portions on the first and second side walls has the same size and configuration. An upper recessed region is located between support legs 952, 953, 954, 955, 956, 958. In one non-limiting configuration, each of the first and second side walls 930, 940 has a single upper recessed region that has the same size and configuration. In another non-limiting configuration, each of the front and back walls 910, 920 has a plurality of upper recessed regions that have the same size and configuration.

Each of the side wall 930, 940 includes a living hinge 932, 942 that allow the side wall to be folded (e.g., folded in half, etc.) when the platform is folded into the folded and substantially flat configuration as illustrated in FIGS. 8D-8E.

When the platform 900 is in the expanded and assembled configuration, the top board 980 is laid on the resting surface of the body. The top board 980 generally does not include a living hinge; however, this is not required. The perimeter of the top board includes a plurality of support flanges 982, 984, 986, 988 that enables the top board 980 to be supported on the body of the platform 900. The support flanges 982, 984, 986, 988 of the top board 980 are positioned between upper recessed region is located between support legs 952, 953, 954, 955, 956, 958 so as to maintain the top board 980 in position on the top of the body of the platform 900. As illustrated in FIGS. 8A-8B, the support flanges 982, 984, 986, 988 of the top board 980 are positioned are positioned below the upper edge of support legs 952, 953, 954, 955, 956, 958; however, this is not required. The top board 980 is configured to be releasably positioned on the resting surface of the body. One or more connectors (e.g., magnet, hook and loop fastener, snap, etc.), not shown, can be used to releasably connect the top board 980 to the resting surface.

The platform 900 can optionally include an optional strap 990 (e.g., elastomeric strap, standard strap, etc.) that secures the platform 900 when in the substantially flat configuration as illustrated in FIGS. 8D-8E. The strap 990 can also or alternatively be used to facilitate in the carrying of the platform 900. The strap 990 is illustrated as being inserted into a strap opening 992 in one of the support legs 952, 953, 954, 955, 956, 958; however, this is not required.

As illustrated in FIG. 8F, the top board 980 can be configured to support painting items PA (e.g. paint tray, paint brushes, paint cans, paint accessories, etc.). It is to be understood that the platform 900 is not limited for use with only painting accessories.

Referring now to FIGS. 8C and 8F, the top surface of the top board 980 can optionally include a protective liner 994 as is discussed in more detail below. The protective liner can optionally include a liquid barrier layer that inhibits or prevents liquids to pass fully through the protective liner. The protective liner can be permanently or releasably secured to the top board 980 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the top board 980 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the top board 980, the protective liner can be removed and optionally cleaned and then reinserted on the top board 980 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the top board 980. As can also be appreciated, the protective liner can be positioned on a portion or all of the inner side wall surfaces of other surfaces of the platform 900. One or more sides of the platform 900 can optionally include logos, instructions, branding, etc.

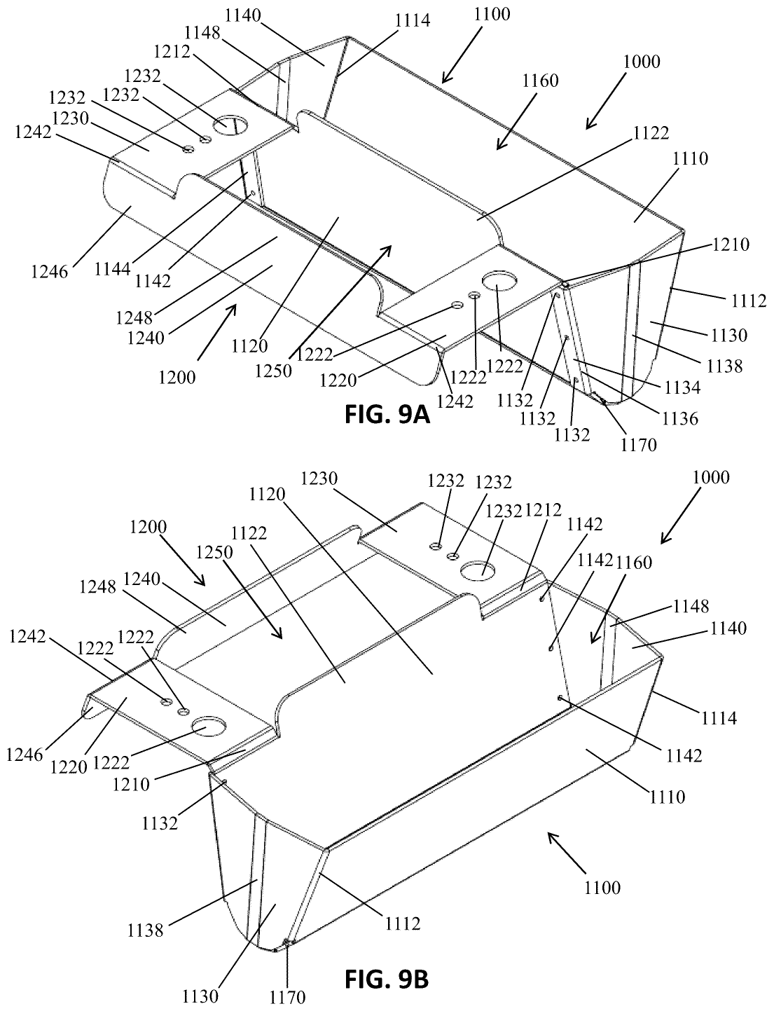

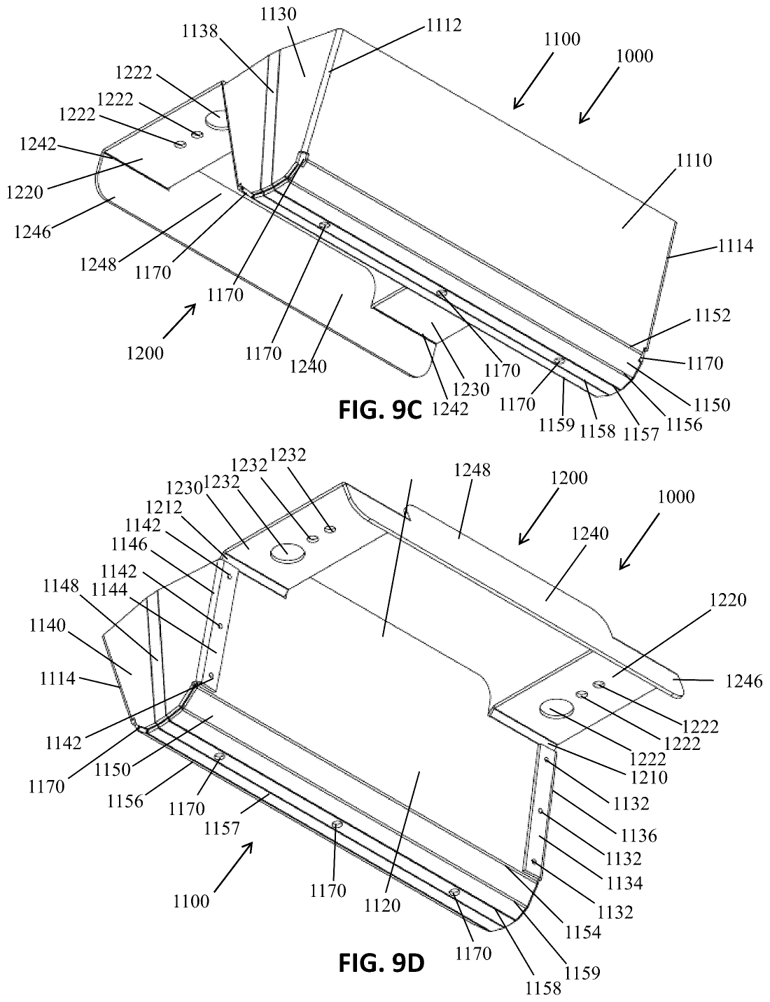

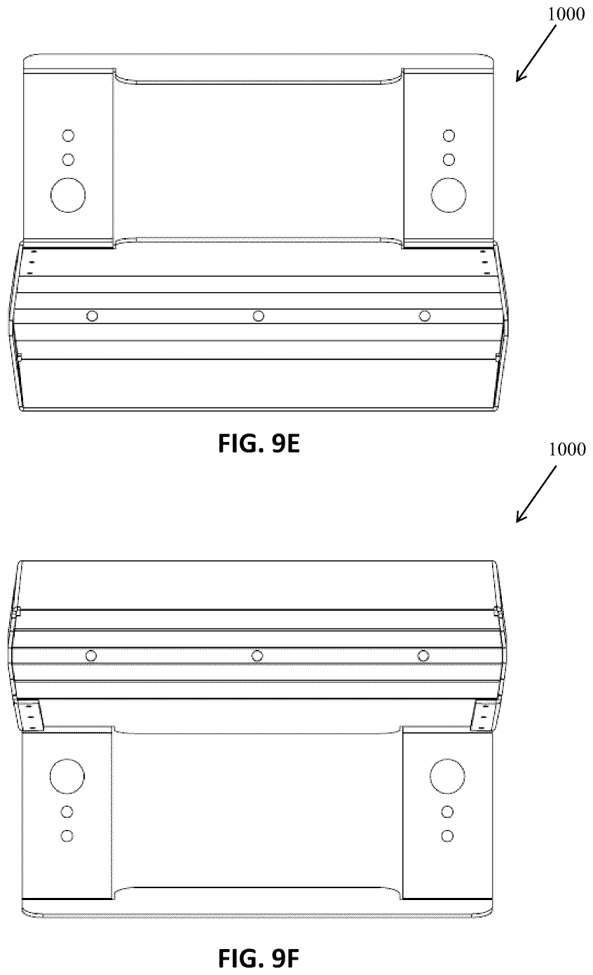

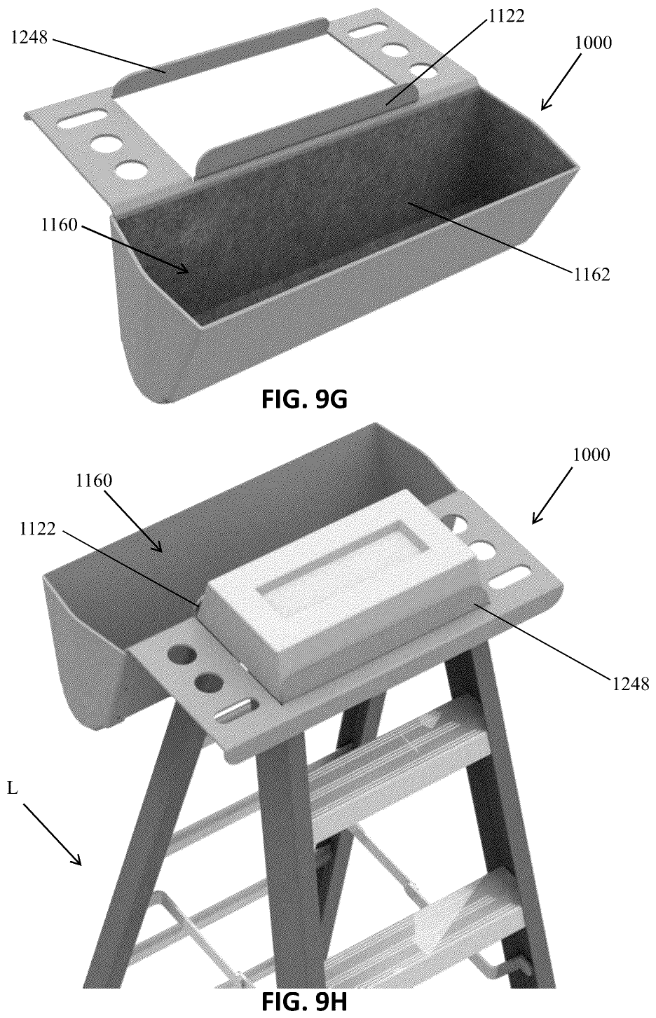

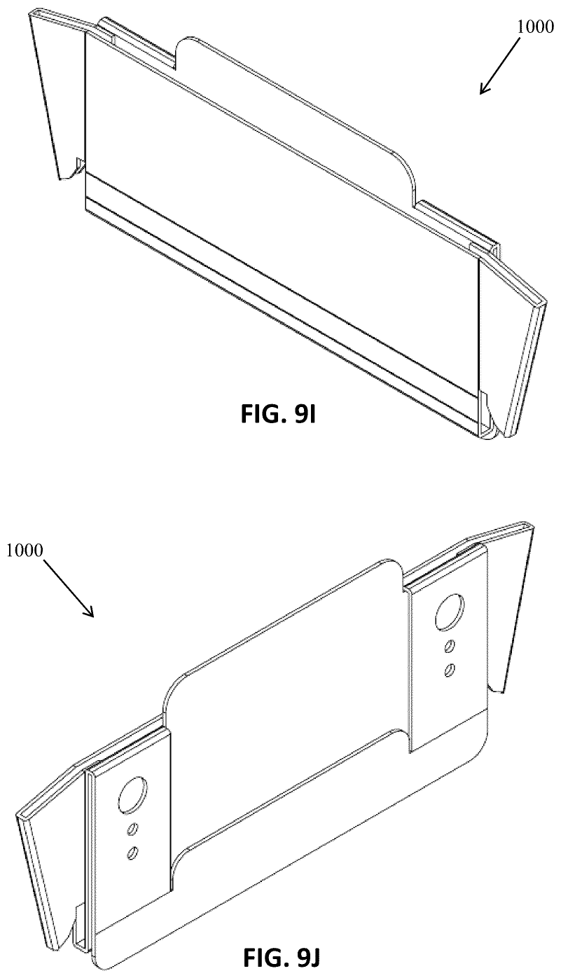

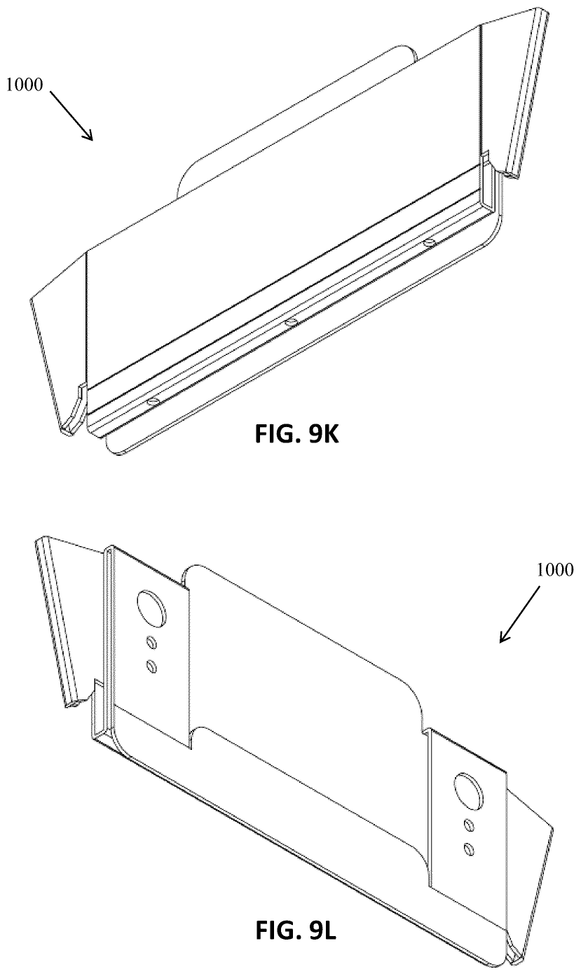

FIGS. 9A-9L illustrate a non-limiting implementation of a foldable and collapsible ladder caddy 1000 in accordance with the present disclosure, and wherein the ladder caddy 1000 is formed from one or two corrugated plastic sheets 50. FIG. 9A is a top-rear isometric view of the ladder caddy 1000 in an assembled-expanded configuration. FIG. 9B is a top-front isometric view of the ladder caddy 1000 in the assembled configuration. FIG. 9C is a bottom-front isometric view of the ladder caddy 1000 in the assembled configuration. FIG. 9D is a bottom-rear isometric view of the ladder caddy 1000 in the assembled configuration. FIG. 9E is a top plan view of the ladder caddy 1000 in the assembled configuration. FIG. 9F is a bottom plan view of the ladder caddy 1000 in the assembled configuration. FIG. 9G is a top-front isometric view of the ladder caddy 1000 in an assembled-expanded configuration and which include an optional protective liner. FIG. 9H is a top-rear isometric view of the ladder caddy 1000 in an assembled-expanded configuration and is positioned on the top portion of a ladder L. FIG. 9I is a top-front isometric view of the ladder caddy 1000 in an unassembled or folded position or collapsed position or substantially flat configuration. FIG. 9J of a top-rear isometric view of the ladder caddy 1000 in an unassembled or folded position or collapsed position or substantially flat configuration. FIG. 9K is a bottom-front isometric view of the ladder caddy 1000 in an unassembled or folded position or collapsed position or substantially flat configuration. FIG. 9L of a bottom-rear isometric view of the ladder caddy 1000 in an unassembled or folded position or collapsed position or substantially flat configuration.

The ladder caddy 1000 includes a ladder trough 1100 and a ladder support member 1200. The ladder trough 1100 is formed of a front wall 1110, a back wall 1120, first and second sides walls 1130, 1140 and a bottom wall 1150 which all form an internal compartment 1160 when the ladder trough 1100 is in the assembled-expanded to the unfolded and assembled-expended configuration. Side walls 1130, 1140 are connected to the front wall 1110 and the back wall 1120. The front wall 1110 is connected to the first and second sides walls 1130, 1140 by a living hinge 1112, 1114, and the back wall 330 is connected to the first and second sides walls 1130, 1140 by a connectors 1132, 1142 that form a detachable connection (e.g., snap, hook and loop fastener, etc.) or a permanent connection (e.g., adhesive, permanent mechanical connection, melted connection, etc.). Alternatively, the back wall 1120 is connected to the first and second sides walls 1130, 1140 by a living hinge, and the front wall 1110 is connected to the first and second sides walls 1130, 1140 by a connector that forms a detachable connection (e.g., snap, hook and loop fastener, etc.) or a permanent connection (e.g., adhesive, permanent mechanical connection, melted connection, etc.).

The first and second side walls 1130, 1140 can optionally include a connection flange 1134, 1144 that is connected by connectors 1132, 1142 to the back wall 1120 or the front wall 1110. The connection flanges 1134, 1144 can optionally be movable relative to the other portion of the first and second side walls 1130, 1140 by a living hinge 1136, 1146. As can be appreciated, the back wall 1120 or front wall 1110 can include the connection flange that is connected to one of the side walls 1130, 1140. Each of the first and second sides walls 1130, 1140 includes one or more side living hinges 1138, 1148 to enable the first and second sides walls 1130, 1140 to be folded and unfolded when the ladder trough 1000 is folded into the unassembled or folded position or collapsed position or substantially flat configuration; and unfolded to the assemble-expanded configuration. Generally, the first and second sides walls 1130, 1140 have the same number of side living hinges. In one non-limiting configuration, each of the first and second sides walls 1130, 1140 includes a single side living hinge 1138, 1148 that is located in the middle or mid-region of the first and second sides walls 1130, 1140 as illustrated in FIGS. 9A & 9B so that the first and second sides walls 1130, 1140 can be folded in half or nearly in half when the ladder trough 1000 is folded into the folded and substantially flat configuration as illustrated in FIGS. 9I-9L.

The bottom wall 1150 is connected to the front wall 1110 and back wall 1120 by living hinges 1152, 1154, and the bottom wall is not connected to first and second side walls 1130, 1140. As illustrated in FIGS. 9C & 9D, the bottom wall 1150 includes one or more living hinges 1156, 1157, 1158, 1159 that enables the bottom wall 1150 to be folded in substantially flat configuration when the ladder 1100 is folded into the folded and substantially flat configuration as illustrated in FIGS. 9I-9L. In one non-limiting configuration, the bottom wall 1150 includes a plurality of living hinges such that when the bottom wall 1150 is in the unfolded or assembled-expanded configuration, the bottom profile of the bottom wall 1150 has a generally curved or arcuate profile; however, this is not required. The ladder trough 1110 can optionally include one or more drainage openings 1170 so as to allow liquids to drain from the internal compartment 1160 of the ladder trough 1100 and/or facilitate in removing debris from internal compartment 1160 of the ladder trough 1100. As illustrated in FIGS. 9C-9D, the one or more drainage openings 1170, when used, can be located in the bottom wall 1150, and/or adjacent to first and/or second side walls 1130, 1140.

Referring now to FIGS. 9A-9B, the side portions of the back wall 1120 can optionally have a height that is about the same (e.g., within 0-10% the same and all values and ranges therebetween) than a height of the front wall 1110. The longitudinal length of each of the front and back walls 1110, 1112 is greater (e.g., 10-5000% greater and all values and ranges therebetween) than a longitudinal length of each of the first and second sides walls 1130, 1140.

Referring now to FIGS. 9A-9G, ladder support member 1200 is connected to the back wall 1120. The ladder support member 1200 is configured to releasably connect to a top portion of a ladder L so as to support the ladder trough 1100 on a ladder L when the ladder caddy 1000 in an assembled-expanded configuration. The ladder support member 1200 can be connected to the top edge of the back wall 1120 by a living hinge 1210, or can be formed of a separate piece of material that is connected to the back wall 1120 by one or more connectors (e.g., snap, adhesive, melted connection, press-fit connection, etc.). As illustrated in FIGS. 9A-9H, the ladder support member 1200 is be connected to the top edge of the back wall 1120 by a support living hinge 1210. In such non-limiting configuration, the front wall 1110, sides walls 1120, 1140 and bottom wall 1150 of the ladder trough 1110 are formed of one piece of material and the back wall 1120 and ladder support member 1200 are formed of another piece of material. Also, in such a configuration, the ladder caddy 1000 can be formed of a single piece of material.

Support member 1200 is formed of first and second side arms 1220, 1230 that are connected to support living hinge 1210, 1212, and a rear arm 1240 that is connected to the first and second side arms 1220, 1230. The first and second side arms 1220, 1230 are spaced from one another, and the support living hinge 1210, 1212 and a rear arm 1240 are spaced from one another, and together with a portion of the back wall 1120 defines a ladder opening 1250. The rear arm 1240 can optionally be connected to the first and second side arms 1220, 1230 by a living hinge 1242, 1243. The ladder opening 1250 is configured to fit about a top portion of a ladder L as illustrated in FIG. 9H so as to support the ladder caddy 1000 on a ladder L. Generally, the shape of the ladder opening 1250 is generally rectangular; however, the ladder opening 1250 can have other shapes.

As illustrated in FIGS. 9A-9L, the back wall 1120 can optionally include an upwardly extending wall flange 1122 that is located between living hinges 1210, 1212. The rear arm 1240 is configured that when the rear portion of the rear arm 1240 is bent downwardly about living hinges 1242, a rear portion 1246 of the rear arm 1240 extends downwardly below a bottom surface of the first and second side arms 1220, 1230, and a front portion 1248 of the rear arm extends upwardly above a top surface of the first and second side arms 1220, 1230 as illustrated in FIGS. 9A-9D, 9G and 9H. As best illustrated in FIG. 9H, the upwardly extending wall flange 1122 of the back wall 1120 and the front portion 1248 of the rear arm are configured to contact a portion of the top portion of the ladder L to facilitate in stabilizing and/or securing the ladder caddy 1000 on the ladder L. As illustrated in FIGS. 9A-9B, the rear arm 1240 can optionally be bent such that the front portion 1248 of the rear arm angles toward the back wall 1120 when the ladder caddy 1000 is in the assemble configuration. As illustrated in FIGS. 9A-9B, the wall flange 1122 of the back wall 1120 can optionally be oriented such that the wall flange 1122 angles rearwardly toward the front portion 1248 of the rear arm when the ladder caddy 1000 is in the assemble configuration.

The first and/or second side arms 1220, 1230 can optionally include one or more openings 1222, 1232 that are configured to receive and support a portion of tool (e.g., screw drive, hammer, pliers, flashlight, etc.) on the first and/or second side arms 1220, 1230. Additionally or alternatively, the one or more openings 1222, 1232 can be used to facilitate in securing the ladder caddy 1000 to the top portion of the ladder L by one or more connection arrangements (e.g., zip-ties, wire, cord, or other attachment devices). The number and/or size of the one or more openings 1222, 1232 on the first and/or second side arms 1220, 1230 is non-limiting. As illustrated in FIGS. 9A-9D, each of the first and second side arms 1220, 1230 includes three openings 1222, 1232, and wherein two of the openings have the same shape and the third opening has a different shape.

One or more portions of the internal compartment 1160 of the ladder trough 1100 can optionally include a protective liner 1162 as is discussed in more detail below and as illustrated in FIG. 9G. The protective liner 1162 can optionally include a liquid barrier layer that inhibits or prevents liquids to pass fully through the protective liner. The protective liner can be permanently or releasably secured to the top surface of the internal compartment 1160 of the ladder trough 1100 by any number of arrangements (e.g., adhesive, snap, hook and loop fasteners, dual lock fasteners, mushroom hook fasteners, zipper, strap, rib and groove connection, etc.). In one non-limiting arrangement, the protective liner 1162 is releasably secured to the internal compartment 1160 of the ladder trough 1100 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner 1162 is releasably secured to the internal compartment 1160 of the ladder trough 1100, the protective liner 1162 can be removed and optionally cleaned and then reinserted on the internal compartment 1160 of the ladder trough 1100 or be replaced with a new protective liner 1162 when the protective liner gets dirty, worn, has liquids spilled thereon, etc. The color and thickness of the protective liner 1162, when used, is non-limiting. As can be appreciated, the protective liner 1162 can be sized to fully overlie or partially overlie (e.g., overlie 5%-99.00% and all values and ranges therebetween) the internal compartment 1160 of the ladder trough 1100. As can also be appreciated, the protective liner 1162 can be positioned on other portions of the ladder caddy 1000. One or more sides of the ladder caddy 1000 can optionally include logos, instructions, branding, etc.

In one non-limiting embodiment, the ladder trough 1100 can support at least 2 lbs. (e.g., 2-100 lbs. and all values and ranges therebetween) of items, tools, and equipment. In another non-limiting embodiment, the ladder caddy 1000 can fold down to 5-100 in. long (and all values and ranges therebetween), 2-25 in. wide (and all values and ranges therebetween), and 0.25-4 in. thick (and all values and ranges therebetween).

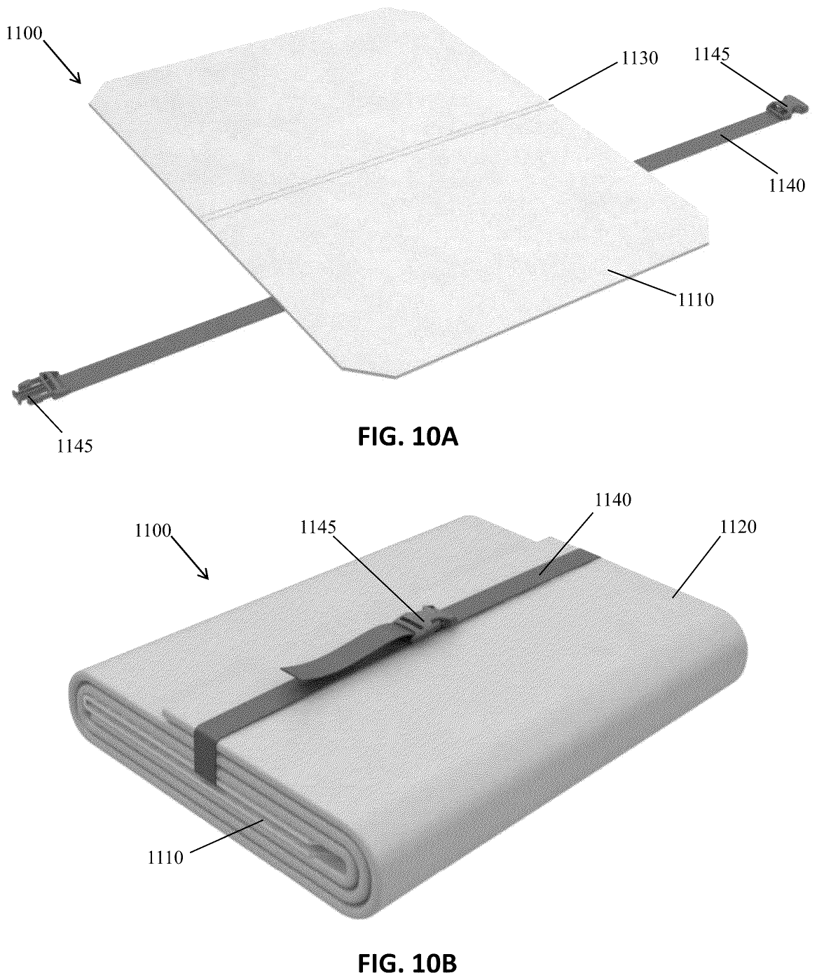

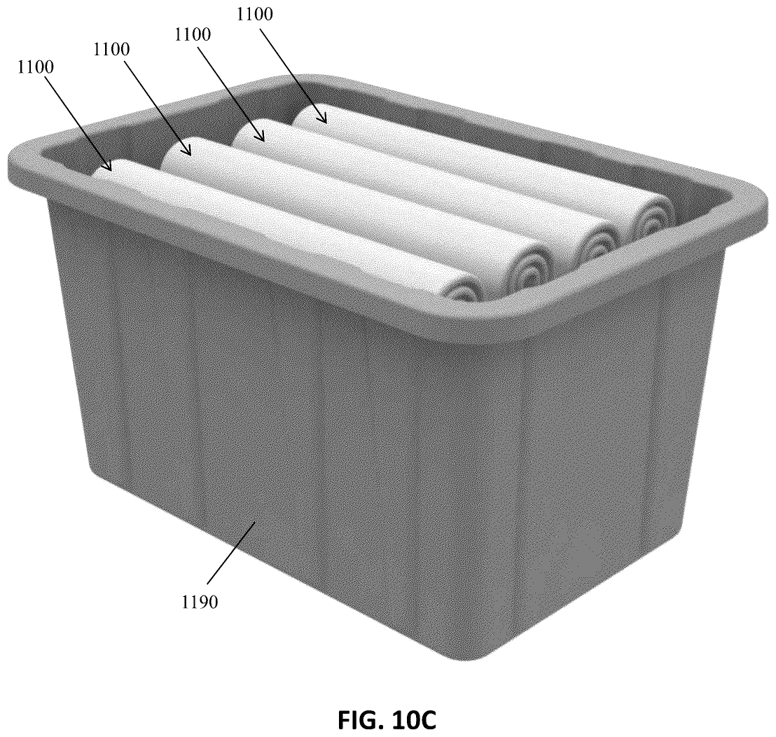

FIGS. 10A-10C illustrate a non-limiting implementation of a drop-cloth assembly 1100 comprising a corrugated plastic sheet 1110 and drop-cloths 1120. FIG. 10A depicts the corrugated plastic sheet 1110 in a flat configuration. FIG. 10B depicts the drop-cloths 1120 bundled around the corrugated plastic sheet 1110. FIG. 10C depicts a plurality of drop-cloth assemblies 1100 housed within an exemplary bin 1190. In one non-limiting embodiment, optional pre-formed perforations/fold lines 1130 are formed in the corrugated plastic sheet 1110 to aid in its folding and unfolding. In another non-limiting embodiment, the corrugated plastic sheet 1110 further optionally includes a strap 1140 having a buckle 1145. To assemble the drop-cloth assembly 1100, in accordance with one non-limiting embodiment: (i) the corrugated plastic sheet 1110 is laid out flat; (ii) the drop-cloths 1120 are bundled around the flat, corrugated plastic sheet 1110; and (iii) the corrugated plastic sheet 1110 having the drop-cloths 1120 are folded and secured via the strap 1140 and the buckle 1145. As previously mentioned, one or multiple drop-cloth assemblies 1100 can be placed in the bin 1190. In the present exemplary embodiment, the bin 1190 houses four drop-cloth assemblies 1100 (see FIG. 10C).

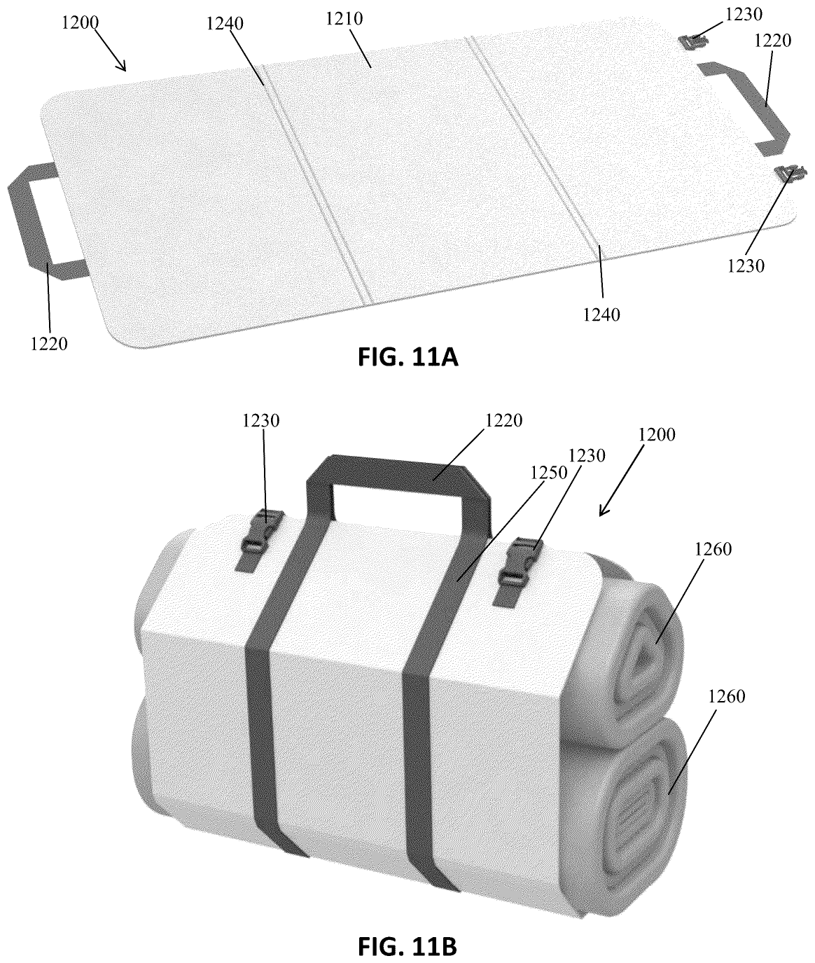

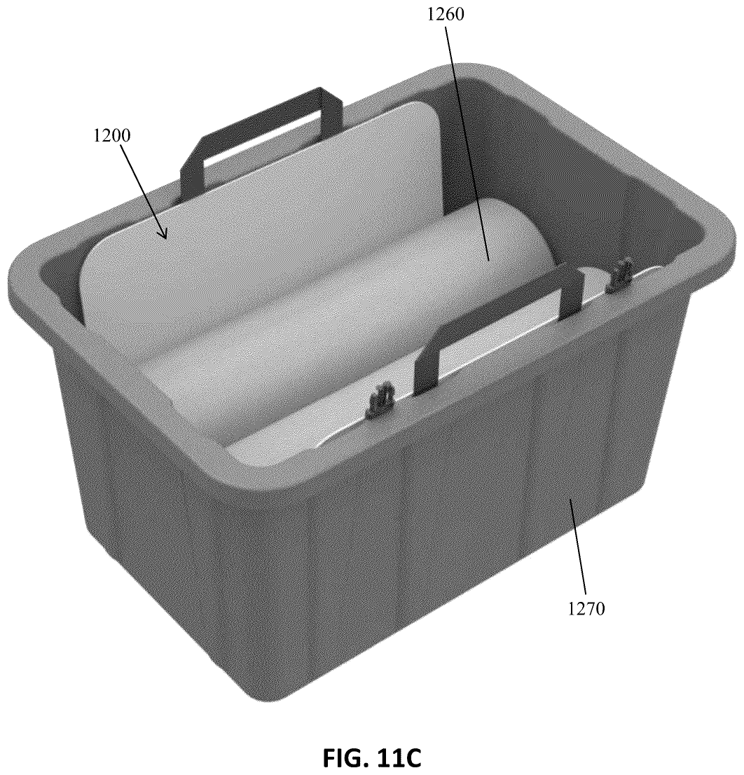

FIGS. 11A-11C illustrate another non-limiting implementation of a drop-cloth assembly 1200 comprising a corrugated plastic sheet 1210 having strap handles 1220 and drop-cloths 1260. FIG. 11A depicts the corrugated plastic sheet 1210 having strap handles 1220 in a flat configuration. FIG. 11B depicts the drop-cloths 1260 bundled in the corrugated plastic sheet 1210. FIG. 11C depicts the drop-cloth assembly 1200 housed within an exemplary bin 1270. In one non-limiting embodiment, pre-formed perforations/fold lines 1240 are formed in the corrugated plastic sheet 1210 to aid in its folding and unfolding. In another non-limiting embodiment, the corrugated plastic sheet 1210 further includes a strap 1250 having a buckle 1230. To assemble the drop-cloth assembly 1200, in accordance with one non-limiting embodiment: (i) the corrugated plastic sheet 1210 is laid out flat; (ii) the drop-cloths 1260 are placed on the flat, corrugated plastic sheet 1210; and (iii) the drop-cloths 1260 are bundled and fastened within the corrugated plastic sheet 1210 (see FIG. 11B). As previously mentioned, drop-cloth assembly 1200 can be set open in the bin 1270 (see FIG. 11C). As can be appreciated, drop-cloth assembly 1200 can be used to carry items other than drop cloths (e.g., rolls of plastic sheeting, paper rolls, etc.).

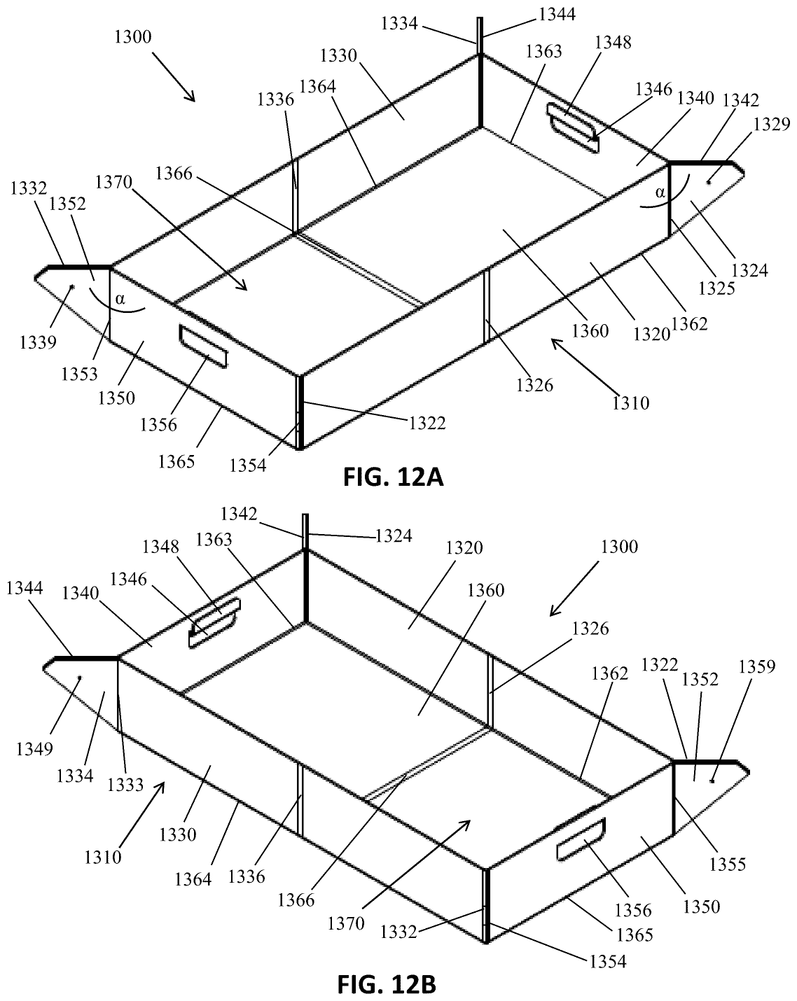

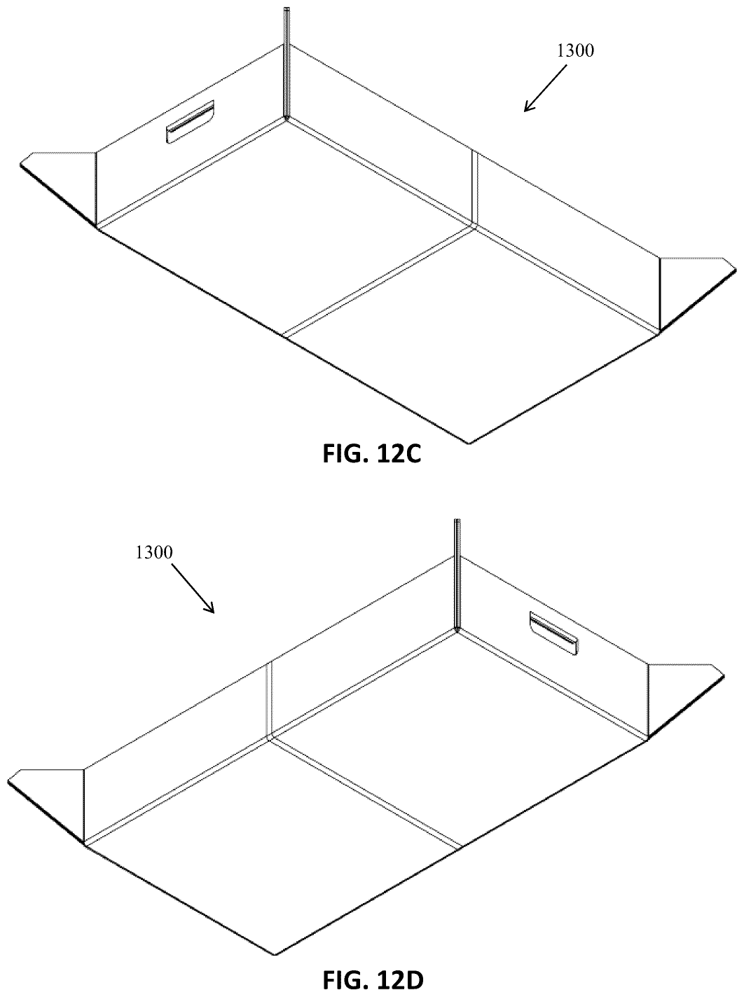

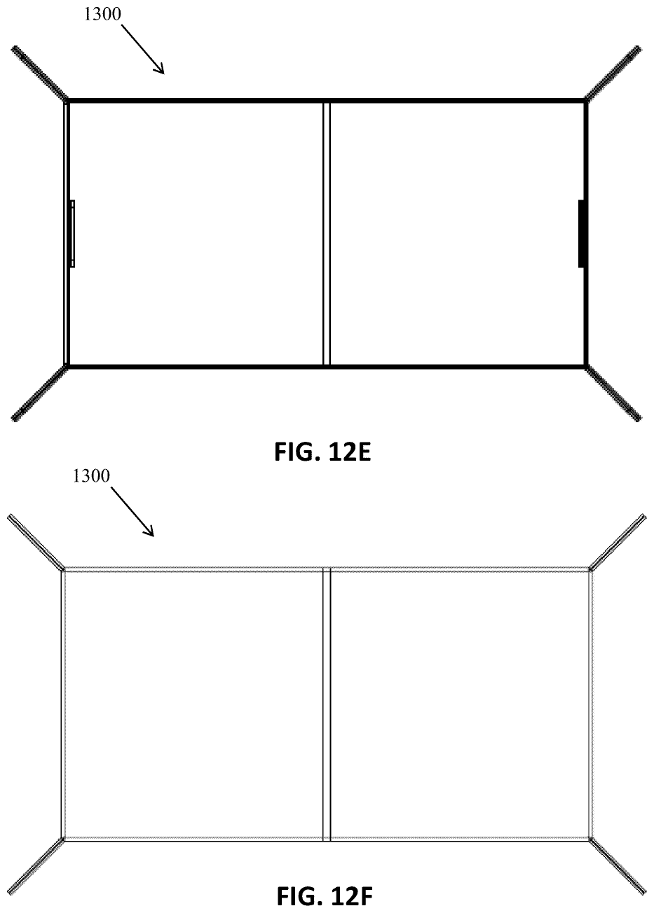

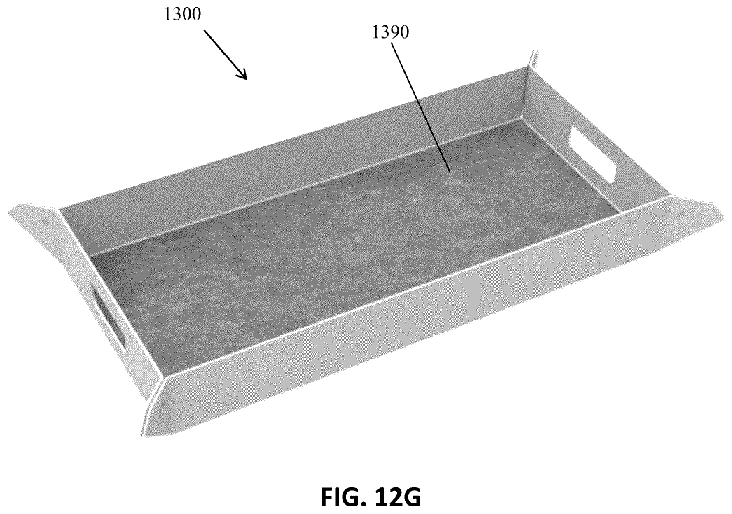

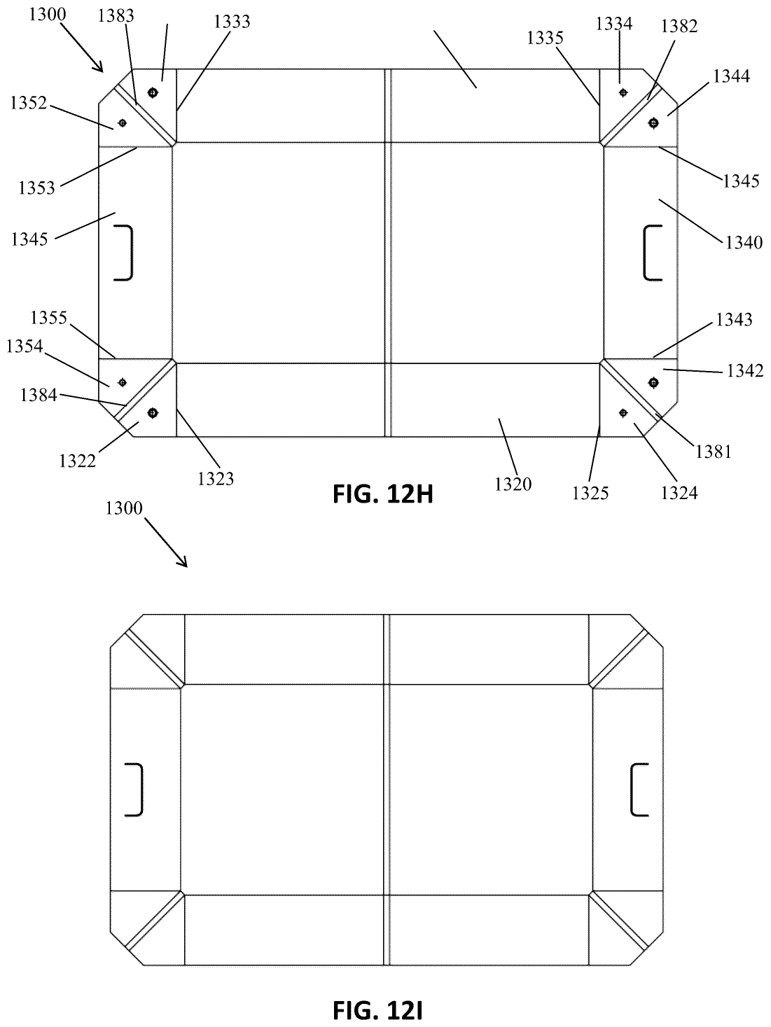

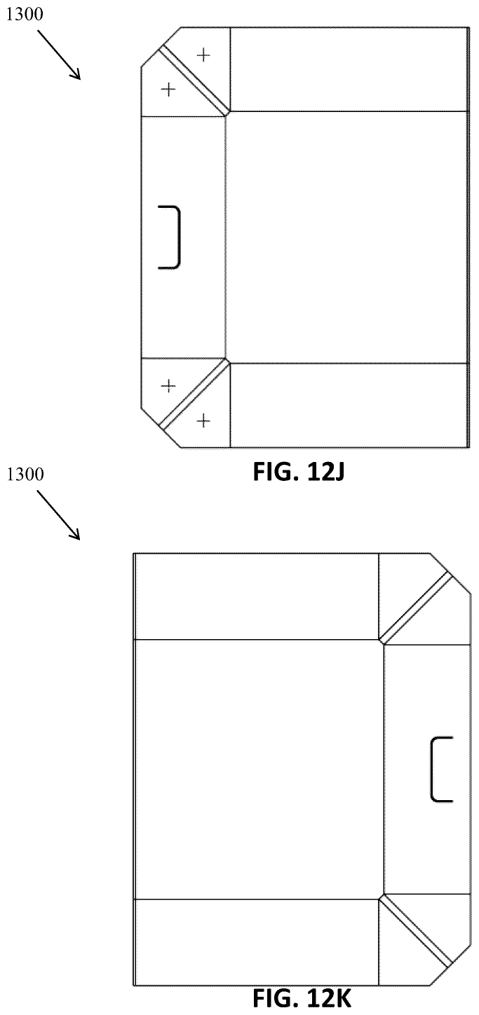

FIGS. 12A-12K illustrate a non-limiting implementation of a foldable and collapsible work tray 1300 in accordance with the present disclosure, and wherein the work tray 1300 is formed from one or more corrugated plastic sheets. In one non-limiting configuration, the work tray 1300 is formed of a single sheet of corrugated plastic. FIG. 12A is a top-front isometric view of the work tray 1300 in an assembled-expanded configuration. FIG. 12B is a top-rear isometric view of the work tray 1300 in the assembled configuration. FIG. 12C is a bottom-front isometric view of the work tray 1300 in the assembled configuration. FIG. 12D is a bottom-rear isometric view of the work tray 1300 in the assembled configuration. FIG. 12E is a top plan view of the work tray 1300 in the assembled configuration. FIG. 12F is a bottom plan view of the work tray 1300 in the assembled configuration. FIG. 12G is a top-front isometric view of the work tray 1300 in an assembled-expanded configuration and includes a protective liner 1390. FIG. 12H is a top plan view of the work tray 1300 in an unassembled and flat configuration. FIG. 12I is a bottom plan view of the work tray 1300 in an unassembled and flat configuration. FIG. 12J is a top plan view of the work tray 1300 in an unassembled, folded and flat configuration. FIG. 12K is a bottom plan view of the work tray 1300 in an unassembled, folded and flat configuration.

The work tray 1300 includes a body 1310 that is formed of a front wall 1320, a back wall 1330, first and second sides walls 1340, 1350 and a bottom wall 1360. The body forms an internal compartment 1370 when the work tray 1300 is in the assembled-expanded to the unfolded and assembled-expended configuration. The front wall 1320 includes a first and second side flanges 1322, 1324 that are connected to the body of the front wall 1320 by living hinges 1323, 1325. The front wall 1320 optionally includes a middle living hinge 1326 that allows a portion of the front wall 1320 to be folded over another portion of the front wall when the work tray 1300 in an unassembled, folded and flat configuration as illustrated in FIGS. 12J-12K. The back wall 1330 includes a first and second side flanges 1332, 1334 that are connected to the body of the back wall 1330 by living hinges 1333, 1335. The back wall 1330 optionally includes a middle living hinge 1336 that allows a portion of the back wall 1330 to be folded over another portion of the back wall when the work tray 1300 in an unassembled, folded and flat configuration as illustrated in FIGS. 12J-12K.

Side wall 1340 includes a first and second side flanges 1342, 1344 that are connected to the body of the side wall 1340 by living hinges 1343, 1345. Side wall 1340 optionally includes a handle opening 1346 and an opening flange 1348. Handle opening 1346 is configured to enable a use to grasp a portion of the side wall 1340 when carrying the work tray 1300 when in the assembled-expanded configuration. Opening flange 1348 is configured to move from a folded position that covers handle opening 1346 as illustrated as illustrated in FIGS. 12H-12I to an unfolded position such that the opening flange 1348 lies against an inner surface (or optionally outer surface) of the side wall 1340 as illustrated in FIGS. 12A-12B. The opening flange 1348 can be connected to the body of the side wall 1340 by a living hinge. Side wall 1350 includes a first and second side flanges 1352, 1354 that are connected to the body of the side wall 1350 by living hinges 1353, 1355. Side wall 1350 optionally includes a handle opening 1356 and an opening flange 1358. Handle opening 1356 is configured to enable a use to grasp a portion of the side wall 1350 when carrying the work tray 1300 when in the assembled-expanded configuration. Opening flange 1358 is configured to move from a folded position that covers handle opening 1356 as illustrated as illustrated in FIGS. 12H-12I to an unfolded position such that the opening flange 1358 lies against an inner surface (or optionally outer surface) of the side wall 1350 as illustrated in FIGS. 12A-12B. The opening flange 1358 can be connected to the body of the side wall 1350 by a living hinge.

When the work tray 1300 is in the assemble configuration as illustrated in FIGS. 12A-12G, the first and second side flanges on first and second side flanges 1340, 1350 are connected by a connector 1329, 1339, 1349, 1359 (e.g., snaps, hook and loop fasteners, dual lock fasteners, press fit connection, mushroom hook fasteners, rib and slot arrangement, adhesive, rivets, magnet, heat melted seam, zipper, tie arrangement [e.g., tied with cord, chin, rope, wire, etc.], etc.) to the adjacently positioned first and second side flanges on front and back walls 1320, 1330. Such connection can be a releasable connection or a permanent connection. One or all of the connectors can be spaced from an outer edge of the side flange; however, this is not required. In one non-limiting configuration as illustrated in FIGS. 12A-12B, when the work tray 1300 is in the assembled configuration, second side flange 1324 of front wall 1320 is connected to first flange 1342 of first side wall 1340 by connector 1329, second side flange 1344 of first side wall 1340 is connected to second flange 1334 of back wall 1330 by connector 1349, first side flange 1332 of back wall 1330 is connected to first flange 1352 of second side wall 1350 by connector 1339, second side flange 1354 of second side wall 1350 is connected to first flange 1322 of front wall 1320 by connector 1359. When the first and second flanges of the front and back walls and the first and second side walls are connected together, the connected flanges extend outwardly from the adjacently positioned front and back walls and the first and second side walls at an angle α of about 100-170° and all values and ranges therebetween (e.g., 130-150°, etc.) to the outer face of the adjacently positioned front and back walls and the first and second side walls.

A plurality of side flanges 1322, 1324, 1332, 1334, 1342, 1344, 1352, 1354 can optionally have the same shape and/or the same size. In one non-limiting configuration, all of the side flanges have the same shape and size. The length of the side flanges (measured from the interior corner of the working tray to the farthest distance from the interior corner) when connected together when the work tray 1300 is in the assembled configuration is about 20-160% (and all values and ranges therebetween) of the height of the side wall that is located adjacent to the connected together side flanges. In one non-limiting configuration, the length of the side flanges when connected together when the work tray 1300 is in the assembled configuration is equal to or greater than the height of the side wall that is located adjacent to the connected together side flanges (e.g., 100-120%, 106-107%, etc.). A plurality of the side flanges can be configured, when the work tray 1300 is in the assembled configuration, to have a) the bottom surface of the side flange slopes upwardly as it extends from a corner of the work tray 1300 and at least a portion (e.g., 25-100% and all values and ranges therebetween) of the longitudinal length of the top surface of the side flange is at the same level as the top edge of the work tray 1300, or b) the top surface of the side flange slopes upwardly as it extends from a corner of the work tray 1300 and at least a portion (e.g., 25-100% and all values and ranges therebetween) of the longitudinal length of the bottom surface of the side flange is at the same level as the bottom edge of the work tray 1300. In another non-limiting configuration, one or more of the side flanges can be formed of four edges, namely, a first top edge that extends form the living hinge, a second bottom edge that extends from the living hinge, a third edge that is connected along the living hinge and is connected to the first end of the first top edge and the first end of the second bottom edge and which is non-parallel to both the first top edge and the second bottom edge, and a fourth edge that connects together the second ends of the first top edge and second bottom edge and which is non-parallel to both the first top edge and the second bottom edge. In another non-limiting configuration, the length of the fourth edge has the shortest length of all the four edges of the side flange.

A plurality of adjacently positioned side flanges are connected to together by a living hinge. As illustrated in FIGS. 12H, 12I, side flange 1324 is connected to side flange 1342 by living hinge 1381, side flange 1344 is connected to side flange 1334 by living hinge 1382, side flange 1332 is connected to side flange 1352 by living hinge 1383, and side flange 1354 is connected to side flange 1322 by living hinge 1384.

The bottom wall 1360 is connected to the front and back walls 1320, 1330 and the first and second side walls 1340, 1350 by living hinges 1362, 1363, 1364, 1365. The bottom wall 1360 optionally includes a middle living hinge 1366 that allows a portion of the bottom wall 1360 to be folded over another portion of the bottom wall when the work tray 1300 in an unassembled, folded and flat configuration as illustrated in FIGS. 12J-12K. The middle living hinge 1366 can be aligned with and connected to one end of middle living hinges 1326, 1336 on the front and back walls 1320, 1330; however, this is not required. The middle living hinge 1366 can be located at or near the central longitudinal length location (e.g., ±0-10% of the central longitudinal length location and all values and ranges therebetween) on the bottom wall 1360. As illustrated in FIGS. 12A, 12B, the middle living hinge 1366 can be located at the central longitudinal length location of the bottom wall 1360, the middle living hinge 1326 is located at the central longitudinal length location of the front wall 1320, and middle living hinge 1336 is located at the central longitudinal length location of the back wall 1330, and the middle living hinges 1326, 1336 are connected to the middle living hinge 1366.

The shape of the internal compartment 1370 when the work tray 1300 is in the assembled-expanded configuration is generally rectangular or square shaped; however, this is not required.

The height of the front wall 1320, back wall 1330, and first and second side walls 1340, 1350 is about the same when the work tray 1300 is in the assembled-expanded configuration is generally rectangular or square shaped; however, this is not required. The longitudinal length of each of the front and back walls 1320, 1330 is generally greater (e.g., 10-5000% greater and all values and ranges therebetween) than a longitudinal length of each of the first and second sides walls 1340, 1350; however, this is not required.

The work tray 1300 can optionally include one or more drainage openings in the bottom wall 1360 so as to allow liquids to drain from the work tray 1300 and/or facilitate in removing debris from work tray 1300.

One or more portions of the internal compartment 1370 can optionally include a protective liner 1390 as illustrated in FIG. 12G, and wherein the details regarding one type of protective liner 1390 is discussed in more detail below. The protective liner 1390 can optionally include a liquid barrier layer that inhibits or prevents liquids to pass fully through the protective liner 1390. The protective liner 1390 can be permanently or releasably secured to the top surface of the internal compartment 1370 by any number of arrangements (e.g., adhesive, snap, hook and loop fasteners, dual lock fasteners, mushroom hook fasteners, zipper, strap, rib and groove connection, etc.). In one non-limiting arrangement, the protective liner 1390 is releasably secured to the internal compartment 1370 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner 1390. When the protective liner 1390 is releasably secured to the internal compartment 1370, the protective liner 1390 can be removed and optionally cleaned and then reinserted on internal compartment 1370 or be replaced with a new protective liner when the protective liner gets dirty, worn, has liquids spilled thereon, etc. The color and thickness of the protective liner 1390, when used, is non-limiting. As can be appreciated, the protective liner 1390 can be sized to fully overlie or partially overlie (e.g., overlie 5%-99.00% and all values and ranges therebetween) the internal compartment 1370. As can also be appreciated, the protective liner 1390 can be positioned on other portions of the work tray 1300. One or more sides of the work tray 1300 can optionally include logos, instructions, branding, etc.

One or more reinforcement layers, not shown, can optionally be positioned about a portion of the one or more handle openings 1346, 1356 to facilitate in strengthening the region about the handle openings, to provide improved gripping about the one or more handle openings, to facilitate in protecting the one or more handle openings from damage, etc. The type of reinforcement layer is non-limiting (e.g., paper, nylon, fabric, polyester, plastic, etc.), and the method for securing the one or more reinforcement layers about the one or more handle openings is also non-limiting (e.g., adhesive, melted seam or connection, snap, hook and loop fasteners, dual lock fasteners, mushroom hook fasteners, etc.).

In one non-limiting embodiment, the work tray 1300 is 10-100 inches long (and all values and ranges therebetween), 2-70 inches wide (and all value and ranges therebetween), and the side walls, when assembled, are 2-20 inches thick (and all values and ranges therebetween). In another non-limiting embodiment, the work tray 1300 is 21.5 inches long, 18.8 inches wide, and the side walls, when assembled are 0.5-4 inches high when the work tray 1300 is in the folded configuration. In another non-limiting embodiment, the work tray 1300 can hold up to at least 2 lbs. of items (e.g., 2-200 lbs. and all values and ranges therebetween) without breaking.

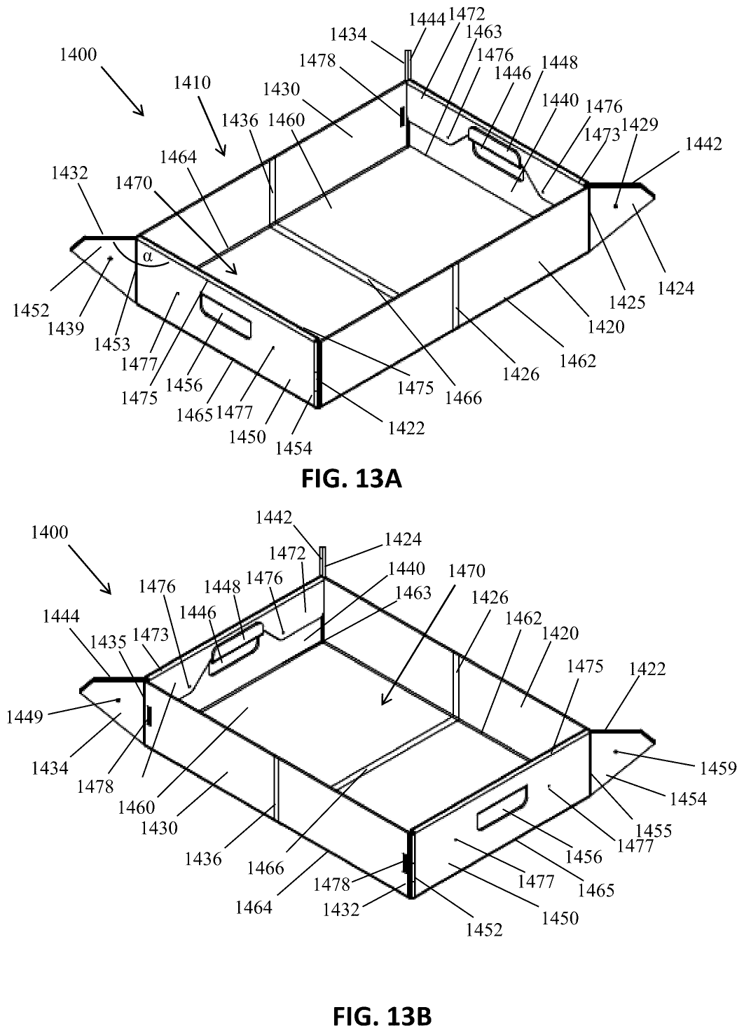

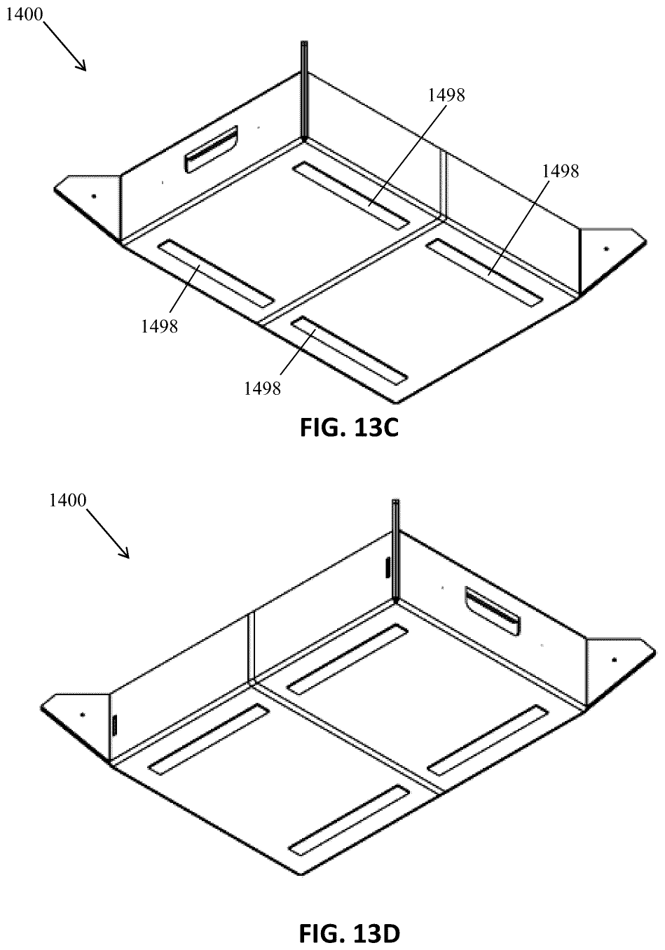

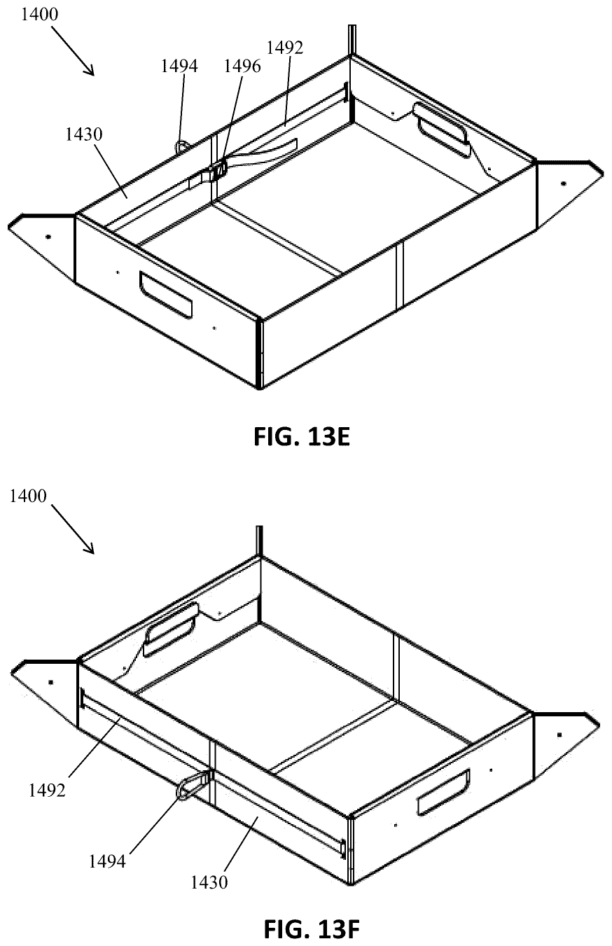

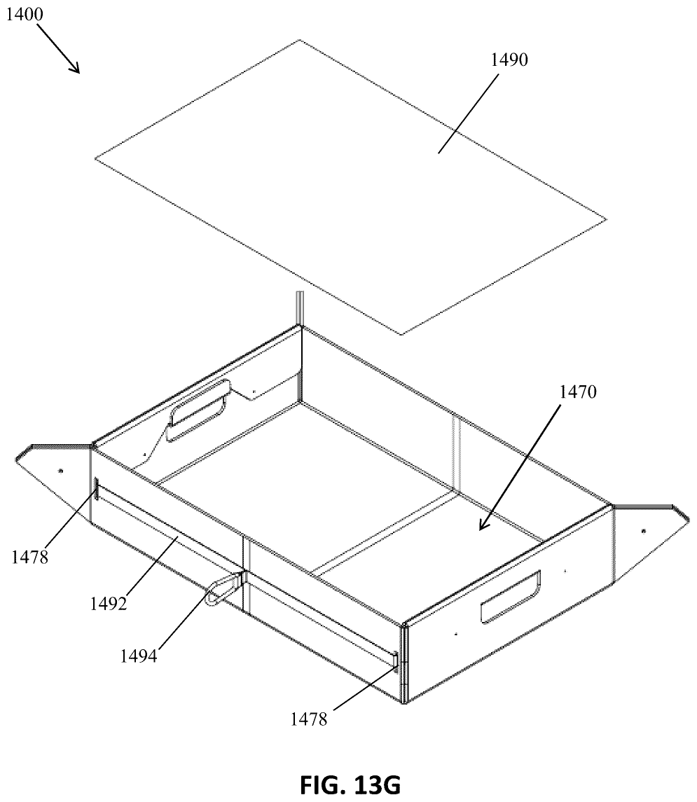

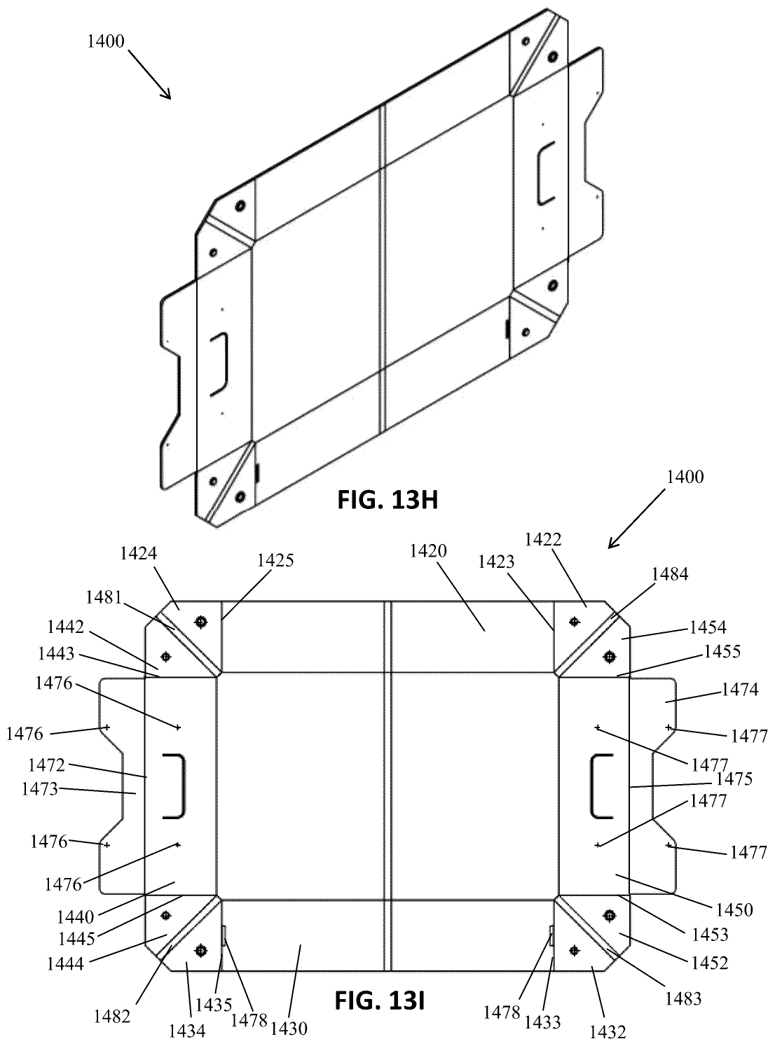

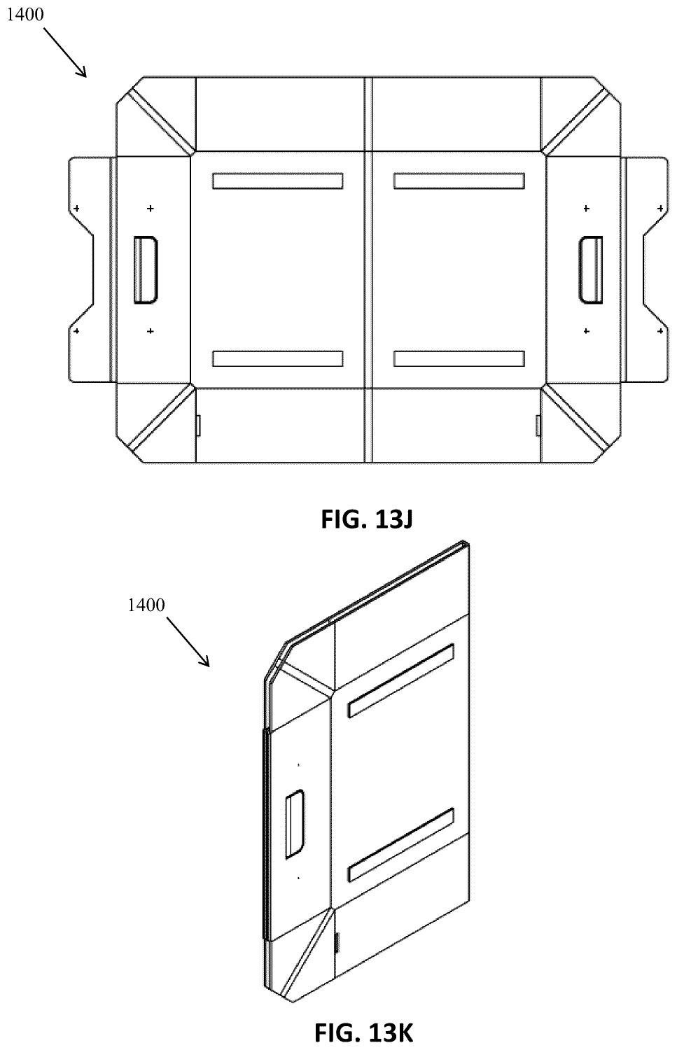

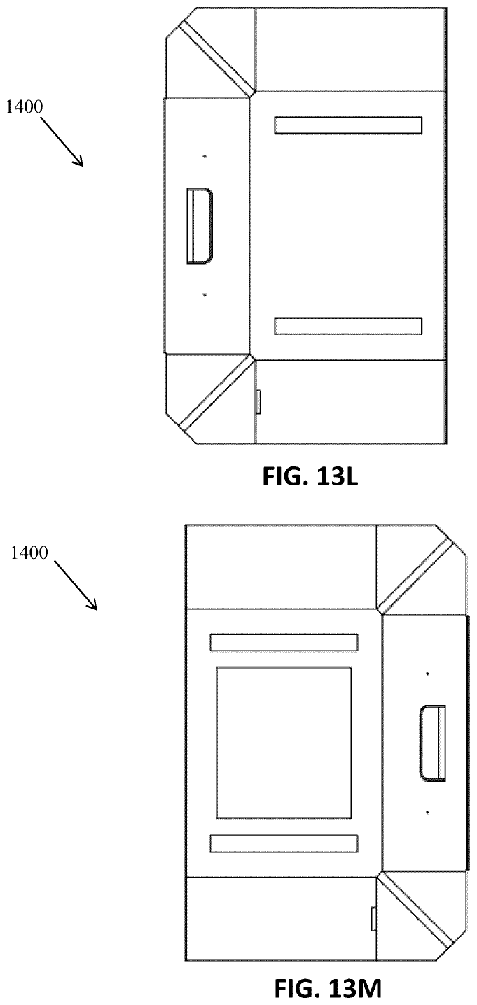

FIGS. 13A-13M illustrate a non-limiting implementation of a foldable and collapsible cargo tray 1400 in accordance with the present disclosure, and wherein the cargo tray 1400 is formed from one or more corrugated plastic sheets. In one non-limiting configuration, the body of the cargo tray 1400 is formed of a single sheet of corrugated plastic. FIG. 13A is a top-front isometric view of the cargo tray 1400 in an assembled-expanded configuration. FIG. 13B is a top-rear isometric view of the cargo tray 1400 in the assembled configuration. FIG. 13C is a bottom-front isometric view of the cargo tray 1400 in the assembled configuration. FIG. 13D is a bottom-rear isometric view of the cargo tray 1400 in the assembled configuration. FIG. 13E is a top-front isometric view of the cargo tray 1400 in an assembled-expanded configuration which includes an optional mounting strip 1490. FIG. 13F is a top-rear isometric view of the cargo tray 1400 in the assembled configuration which includes an optional mounting strip 1490. FIG. 13G is a top-front isometric view of the cargo tray 1400 in an assembled-expanded configuration which includes an optional mounting strip 1490 and an optional protective liner 1498. FIG. 13H in a top-front isometric view of the cargo tray 1400 in an unassembled and flat configuration. FIG. 13I is a bottom plan view of the cargo tray 1400 in an unassembled and flat configuration. FIG. 13J is a bottom plan view of the cargo tray 1400 in an unassembled and flat configuration. FIG. 13K is a top-front isometric view of the cargo tray 1400 in an unassembled, folded and flat configuration. FIG. 13K is a top plan view of the cargo tray 1400 in an unassembled, folded and flat configuration. FIG. 13M is a bottom plan view of the cargo tray 1400 in an unassembled, folded and flat configuration.

The cargo tray 1400 includes a body 1410 that is formed of a front wall 1420, a back wall 1430, first and second sides walls 1440, 1450 and a bottom wall 1460. The body forms an internal compartment 1470 when the cargo tray 1400 is in the assembled-expanded to the unfolded and assembled-expended configuration. The front wall 1420 includes a first and second side flanges 1422, 1424 that are connected to the body of the front wall 1420 by living hinges 1423, 1425. The front wall 1420 optionally includes a middle living hinge 1426 that allows a portion of the front wall 1420 to be folded over another portion of the front wall when the cargo tray 1400 in an unassembled, folded and flat configuration as illustrated in FIGS. 13K-13M. The back wall 1430 includes a first and second side flanges 1432, 1434 that are connected to the body of the back wall 1430 by living hinges 1433, 1435. The back wall 1430 optionally includes a middle living hinge 1436 that allows a portion of the back wall 1430 to be folded over another portion of the back wall when the cargo tray 1400 in an unassembled, folded and flat configuration as illustrated in FIGS. 13K-13M.

Side wall 1440 includes a first and second side flanges 1442, 1444 that are connected to the body of the side wall 1440 by living hinges 1443, 1445. Side wall 1440 optionally includes a handle opening 1446 and an opening flange 1448. Handle opening 1446 is configured to enable a use to grasp a portion of the side wall 1440 when carrying the work tray 1400 when in the assembled-expanded configuration. Opening flange 1448 is configured to move from a folded position that covers handle opening 1446 as illustrated as illustrated in FIGS. 13H-13M to an unfolded position such that the opening flange 1348 lies against an inner surface (or optionally outer surface) of the side wall 1440 as illustrated in FIGS. 13A-13B. The opening flange 1448 can be connected to the body of the side wall 1440 by a living hinge. Side wall 1450 includes a first and second side flanges 1452, 1454 that are connected to the body of the side wall 1450 by living hinges 1453, 1455. Side wall 1450 optionally includes a handle opening 1456 and an opening flange 1458. Handle opening 1456 is configured to enable a use to grasp a portion of the side wall 1450 when carrying the work tray 1400 when in the assembled-expanded configuration. Opening flange 1458 is configured to move from a folded position that covers handle opening 1456 as illustrated as illustrated in FIGS. 13H-13M to an unfolded position such that the opening flange 1458 lies against an inner surface (or optionally outer surface) of the side wall 1450 as illustrated in FIGS. 13A-13B. The opening flange 1458 can be connected to the body of the side wall 1450 by a living hinge.

When the cargo tray 1400 is in the assembled configuration as illustrated in FIGS. 13A-13G, the first and second side flanges on first and second side flanges 1440, 1450 are connected by a connector 1429, 1439, 1449, 1459 (e.g., snaps, hook and loop fasteners, dual lock fasteners, press fit connection, mushroom hook fasteners, rib and slot arrangement, adhesive, rivets, magnet, heat melted seam, zipper, tie arrangement [e.g., tied with cord, chin, rope, wire, etc.], etc.) to the adjacently positioned first and second side flanges on front and back walls 1420, 1430. Such connection can be a releasable connection or a permanent connection. One or all of the connectors can be spaced from an outer edge of the side flange; however, this is not required. In one non-limiting configuration as illustrated in FIGS. 13A-13B, when the cargo tray 1400 is in the assembled configuration, second side flange 1424 of front wall 1420 is connected to first flange 1442 of first side wall 1440 by connector 1429, second side flange 1444 of first side wall 1440 is connected to second flange 1434 of back wall 1430 by connector 1449, first side flange 1432 of back wall 1430 is connected to first flange 1452 of second side wall 1450 by connector 1439, and second side flange 1454 of second side wall 1450 is connected to first flange 1422 of front wall 1420 by connector 1459. When the first and second flanges of the front and back walls and the first and second side walls are connected together, the connected flanges extend outwardly from the adjacently positioned front and back walls and the first and second side walls at an angle α of about 100-170° and all values and ranges therebetween (e.g., 130-150°, etc.) to the outer face of the adjacently positioned front and back walls and the first and second side walls.

A plurality of side flanges 1422, 1424, 1432, 1434, 1442, 1444, 1452, 1454 can optionally have the same shape and/or the same size. In one non-limiting configuration, all of the side flanges have the same shape and size. The length of the side flanges (measured from the interior corner of the working tray to the farthest distance from the interior corner) when connected together when the cargo tray 1400 is in the assembled configuration is about 20-160% (and all values and ranges therebetween) of the height of the side wall that is located adjacent to the connected together side flanges. In one non-limiting configuration, the length of the side flanges when connected together when the cargo tray 1400 is in the assembled configuration is equal to or greater than the height of the side wall that is located adjacent to the connected together side flanges (e.g., 100-120%, 106-107%, etc.). A plurality of the side flanges can be configured, when the cargo tray 1400 is in the assembled configuration, to have a) the bottom surface of the side flange slopes upwardly as it extends from a corner of the cargo tray 1400 and at least a portion (e.g., 25-100% and all values and ranges therebetween) of the longitudinal length of the top surface of the side flange is at the same level as the top edge of the cargo tray 1400, or b) the top surface of the side flange slopes upwardly as it extends from a corner of the cargo tray 1400 and at least a portion (e.g., 25-100% and all values and ranges therebetween) of the longitudinal length of the bottom surface of the side flange is at the same level as the bottom edge of the cargo tray 1400. In another non-limiting configuration, one or more of the side flanges can be formed of four edges, namely, a first top edge that extends from the living hinge, a second bottom edge that extends from the living hinge, a third edge that is connected along the living hinge and is connected to the first end of the first top edge and the first end of the second bottom edge and which is non-parallel to both the first top edge and the second bottom edge, and a fourth edge that connects together the second ends of the first top edge and second bottom edge and which is non-parallel to both the first top edge and the second bottom edge. In another non-limiting configuration, the length of the fourth edge has the shortest length of all the four edges of the side flange.

A plurality of adjacently positioned side flanges are connected to together by a living hinge. As illustrated in FIGS. 13H-13J, side flange 1424 is connected to side flange 1442 by living hinge 1481, side flange 1444 is connected to side flange 1434 by living hinge 1482, side flange 1432 is connected to side flange 1452 by living hinge 1483, and side flange 1454 is connected to side flange 1422 by living hinge 1484.

Side walls 1440, 1450 each include a top side flange 1472, 1474 that is connected to the body of the side wall by a living hinge 1473, 1475. When the cargo tray 1400 is in the fully assembled configuration as illustrated in FIGS. 13A-13B, the top side flange 1472, 1474 are configured to be folded about living hinge 1473, 1475 and over a portion of the inner side of the side walls 1440, 1450. As can be appreciated, one or both of the top side flange 1472, 1474 can alternatively be configured to be folded about living hinge 1473, 1475 and over a portion of the outer side of the side walls 1440, 1450. The folded top side flange 1472, 1474 can be optionally held in place relative to the inner or outer sides of the side walls 1440, 1450 by one or more connectors 1476, 1477 (e.g., snap, hook and loop fastener, dual lock fastener, mushroom hook fastener, zipper, strap, rib and groove connection, magnet, latch, slot arrangement, tab arrangement, zip-tie, clip, adhesive connection, etc.). The type and number of connectors 1476, 1477 is non-limiting. The folding of the top side flanges 1472, 1474 over a portion of the side walls 1440, 1450 can be used to a) provide strength and/or rigidity to the side walls 1440, 1450 when the cargo tray 1400 is in the fully assemble configuration, and/or b) provide additional strength to the upper portion of openings 1446, 1456 when the cargo tray 1400 is in the fully assembled configuration. As illustrated in FIGS. 13A and 13B, the opening flanges 1448, 1458 can be bent to optionally overlap a portion of the top side flanges 1472, 1474 so as to a) provide strength and/or rigidity to the side walls 1440, 1450 when the cargo tray 1400 is in the fully assembled configuration, b) provide additional strength to the upper portion of openings 1446, 1456 when the cargo tray 1400 is in the fully assembled configuration, and/or c) facilitate in holding the top side flanges 1472, 1474 in place relative to the inner side of the side walls 1440, 1450.

Back wall 1430 optionally includes one or more strap slots 1478. As illustrated in FIGS. 13A-13B and 13H-13J, the back wall 1430 includes two strap slots 1478 are that located at or near the living hinges 1433, 1435; however, it can be appreciated that the strap slots can be located on other regions of the back wall 1430, and/or on one or both side walls 1440, 1450, and/or the front wall 1420, and/or on one or more of the side flanges. The one or more strap slots 1478 are illustrated as being spaced from the bottom or top edge of the back wall 1430. The size and shape of the strap slots 1478 are non-limiting. As illustrated in FIGS. 13E-13G, the one or more strap slots 1478 are configured to receive a strap 1492, or cord, or wire, etc. The strap 1492 can be used to facilitate in securing the cargo tray 1400 in position in a structure or vehicle. As can be appreciated, more than one strap 1492 can be used with the cargo tray 1400. The strap 1492 can optionally include a connector 1494 (e.g., hook, loop, ring, clasp, etc.) that can be used to facilitate in forming a connection between the strap and a structure or vehicle (e.g., back seat of vehicle, track of vehicle, cargo bay of vehicle, truck bed of vehicle, etc.). A strap buckle 1496 or other type of connector can be used to secure the strap 1492 to the back wall 1430.

The bottom wall 1460 is connected to the front and back walls 1420, 1430 and the first and second side walls 1440, 1450 by living hinges 1462, 1463, 1464, 1465. The bottom wall 1460 optionally includes a middle living hinge 1466 that allows a portion of the bottom wall 1460 to be folded over another portion of the bottom wall when the work tray 1400 in an unassembled, folded and flat configuration as illustrated in FIGS. 13K-13M. The middle living hinge 1466 can be aligned with and connected to one the end of middle living hinges 1426, 1436 on the front and back walls 1420, 1430; however, this is not required. The middle living hinge 1466 can be located at or near the central longitudinal length location (e.g., ±0-10% of the central longitudinal length location and all values and ranges therebetween) on the bottom wall 1460. As illustrated in FIGS. 13I, 13J, the middle living hinge 1466 can be located at the central longitudinal length location of the bottom wall 1460, the middle living hinge 1426 is located at the central longitudinal length location of the front wall 1420, and middle living hinge 1436 is located at the central longitudinal length location of the back wall 1430, and the middle living hinges 1426, 1436 are connected to the middle living hinge 1466.

The shape of the internal compartment 1470 when the cargo tray 1400 is in the assembled-expanded configuration it is generally rectangular or square shaped; however, this is not required.

The height of the front wall 1420, back wall 1430, and first and second side walls 1440, 1450 is about the same when the cargo tray 1400 is in the assembled-expanded configuration is generally rectangular or square shaped; however, this is not required. The longitudinal length of each of the front and back walls 1420, 1430 is generally greater (e.g., 10-5000% greater and all values and ranges therebetween) than a longitudinal length of each of the first and second sides walls 1440, 1450; however, this is not required.

The cargo tray 1400 can optionally include one or more drainage openings in the bottom wall 1460, not shown, so as to allow liquids to drain from the cargo tray 1400 and/or facilitate in removing debris from cargo tray 1400.

As illustrated in 13C-13D, the bottom surface of the bottom wall 1360 can optionally include a gripping arrangement 1498. In one non-limiting configuration, the bottom surface of the bottom wall 1360 can optionally include a gripping arrangement 1498 in the form of one or more grip strips. The gripping arrangement can be configured to facilitate in maintaining the cargo tray 1400 in position on surface and/or inhibit or prevent sliding or repositioning of the cargo tray 1400 on a surface. The gripping arrangement 1498 is typically made of a different composition or material (e.g., rubber, synthetic rubber, gripping tape, gripping adhesive, gripping material, etc.) from the material (e.g., corrugated plastic sheet 50) used to form the body of the cargo tray 1400. The gripping arrangement 1498 can be permanently or releasably connected to the bottom surface of the bottom wall 1460. In one non-limiting arrangement, the bottom surface of the bottom wall 1460 includes two or more gripping strips that are adhesively connected to the bottom wall 1460.

One or more portions of the internal compartment 1470 can optionally include a protective liner 1490 as illustrated in FIG. 13G, and wherein the details regarding one type of protective liner 1490 is discussed in more detail below. The protective liner 1490 can optionally include a liquid barrier layer that inhibits or prevents liquids to pass fully through the protective liner 1490. The protective liner 1490 can be permanently or releasably secured to the top surface of the internal compartment 1470 by any number of arrangements (e.g., adhesive, snap, hook and loop fasteners, dual lock fasteners, mushroom hook fasteners, zipper, strap, rib and groove connection, etc.). In one non-limiting arrangement, the protective liner 1490 is releasably secured to the internal compartment 1470 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner 1490. When the protective liner 1490 is releasably secured to the internal compartment 1470, the protective liner 1490 can be removed and optionally cleaned and then reinserted on internal compartment 1470 or be replaced with a new protective liner when the protective liner gets dirty, worn, has liquids spilled thereon, etc. The color and thickness of the protective liner 1490, when used, is non-limiting. As can be appreciated, the protective liner 1490 can be sized to fully overlie or partially overlie (e.g., overlie 5%-99.00% and all values and ranges therebetween) the internal compartment 1470. As can also be appreciated, the protective liner 1490 can be positioned on other portions of the cargo tray 1400. One or more sides of the cargo tray 1400 can optionally include logos, instructions, branding, etc.

One or more reinforcement layers, not shown, can optionally be positioned about a portion of the one or more handle openings 1446, 1456 to facilitate in strengthening the region about the handle openings, to provide improved gripping about the one or more handle openings, to facilitate in protecting the one or more handle openings from damage, etc. The type of reinforcement layer is non-limiting (e.g., paper, nylon, fabric, polyester, plastic, etc.), and the method for securing the one or more reinforcement layers about the one or more handle openings is also non-limiting (e.g., adhesive, melted seam or connection, snap, hook and loop fasteners, dual lock fasteners, mushroom hook fasteners, etc.).

In one non-limiting embodiment, the cargo tray 1400 is 10-100 inches long (and all values and ranges therebetween), 2-70 inches wide (and all value and ranges therebetween), and the side walls, when assembled, are 2-20 inches thick (and all values and ranges therebetween). In another non-limiting embodiment, the cargo tray 1400 is 21.5 inches long, 18.8 inches wide, and the side walls, when assembled are 0.5-4 inches high when the cargo tray 1400 is in the folded configuration. In another non-limiting embodiment, the cargo tray 1400 can hold up to at least 2 lbs. of items (e.g., 2-200 lbs. and all values and ranges therebetween) without breaking. Depending on the location that the cargo tray 1400 is to be used, the shape and size of the cargo tray 1400 can be appropriately configured for such use location.

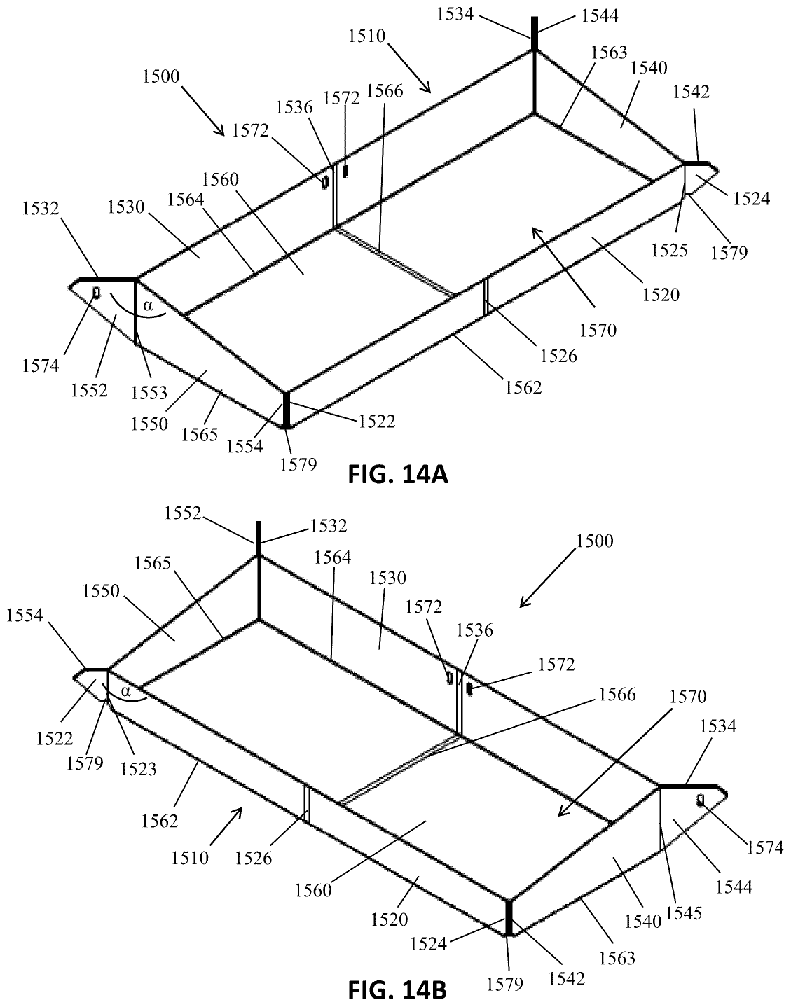

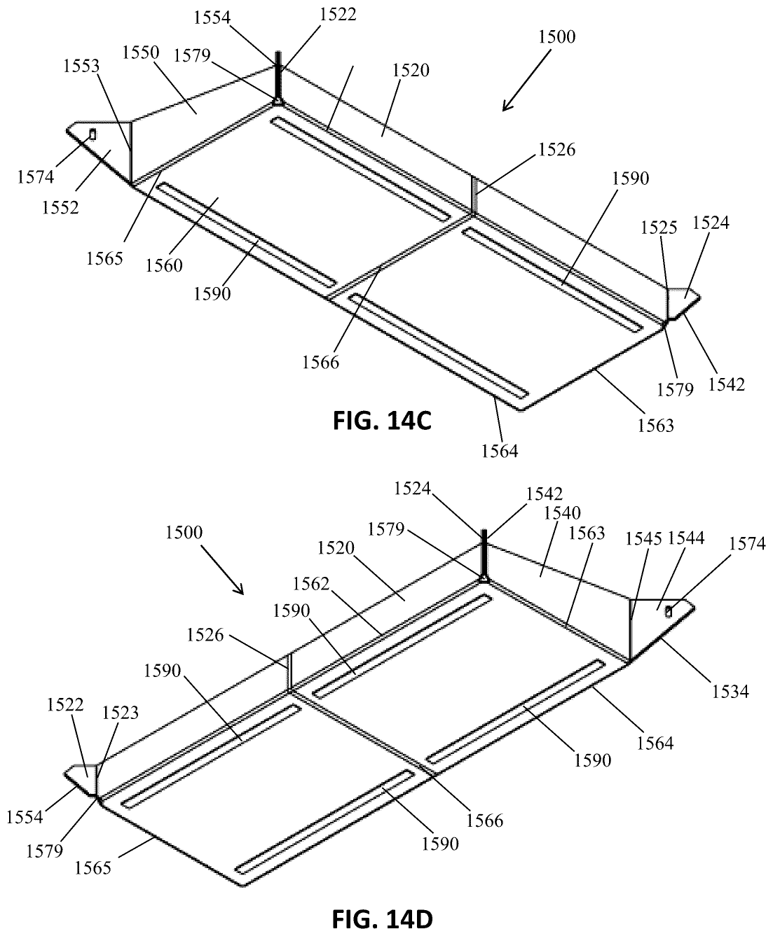

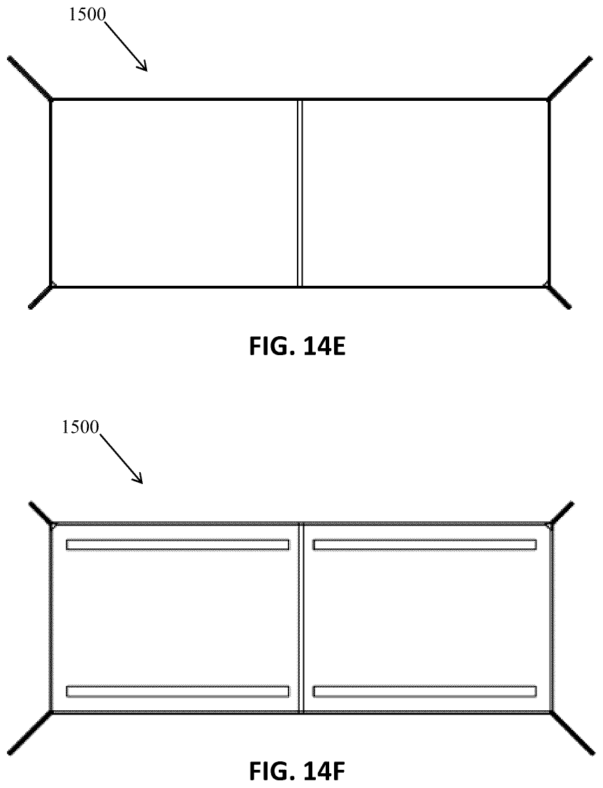

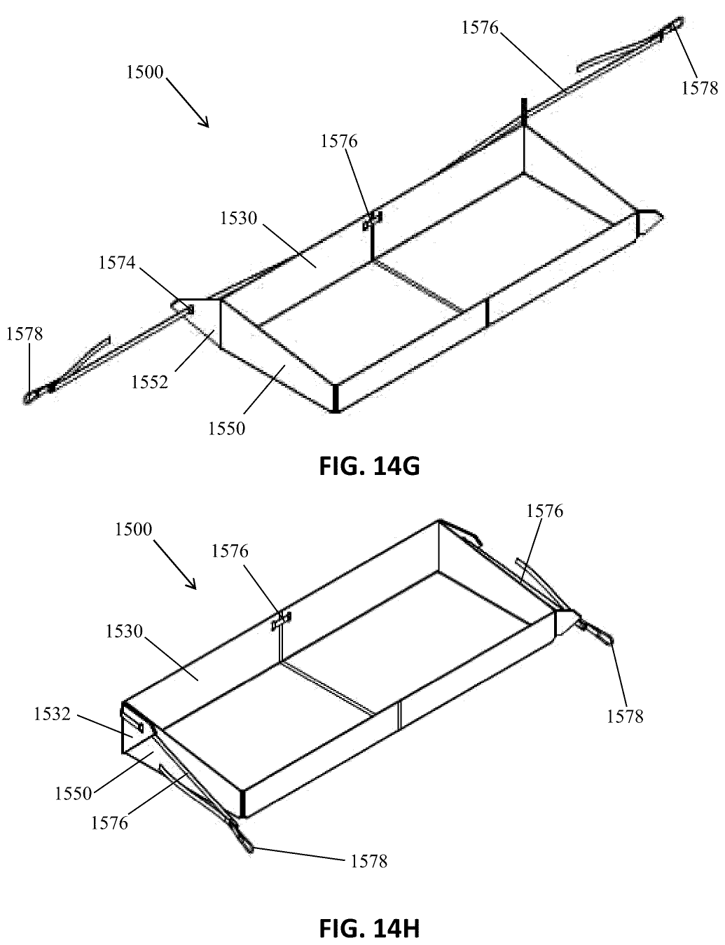

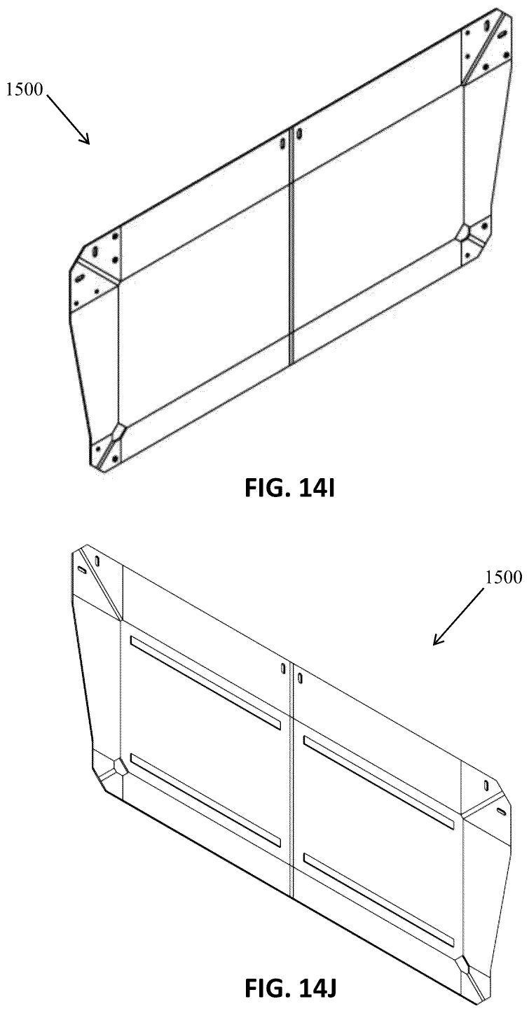

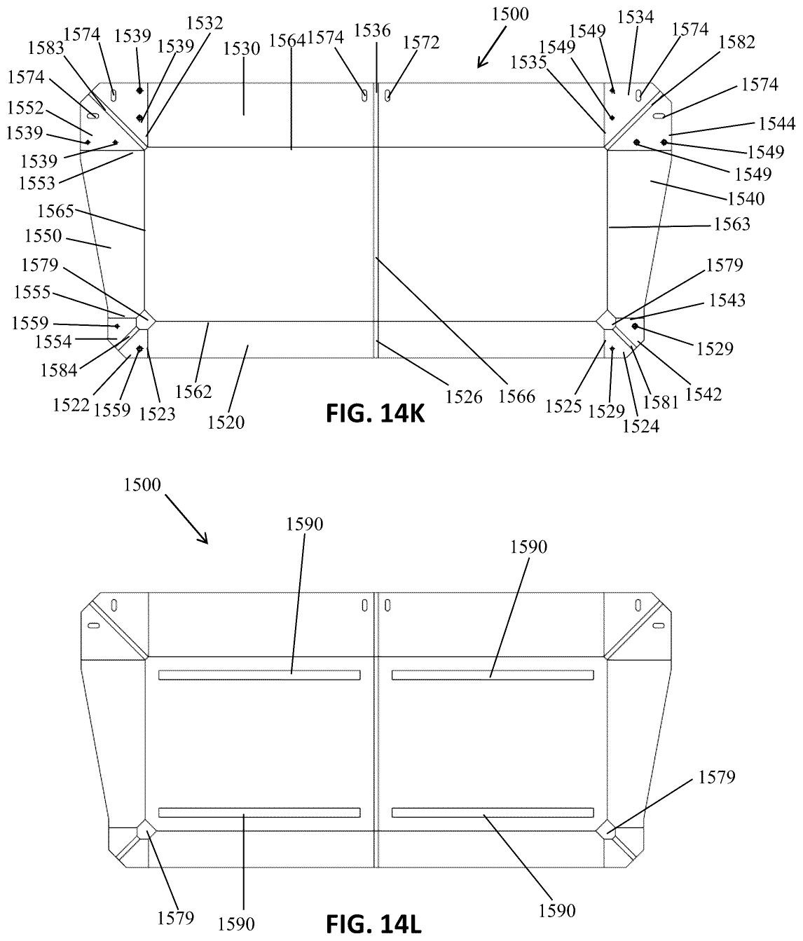

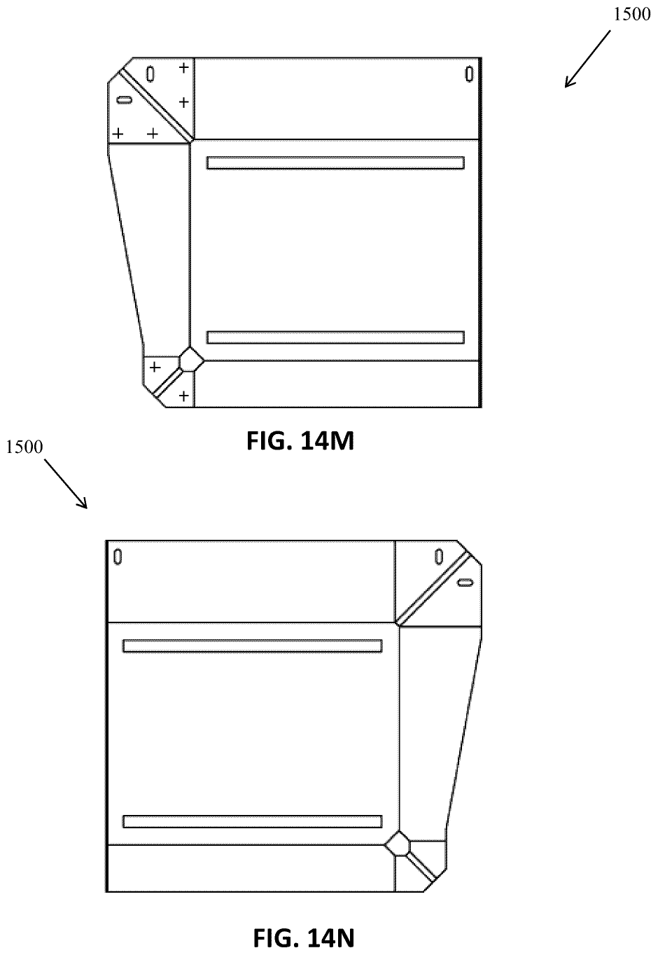

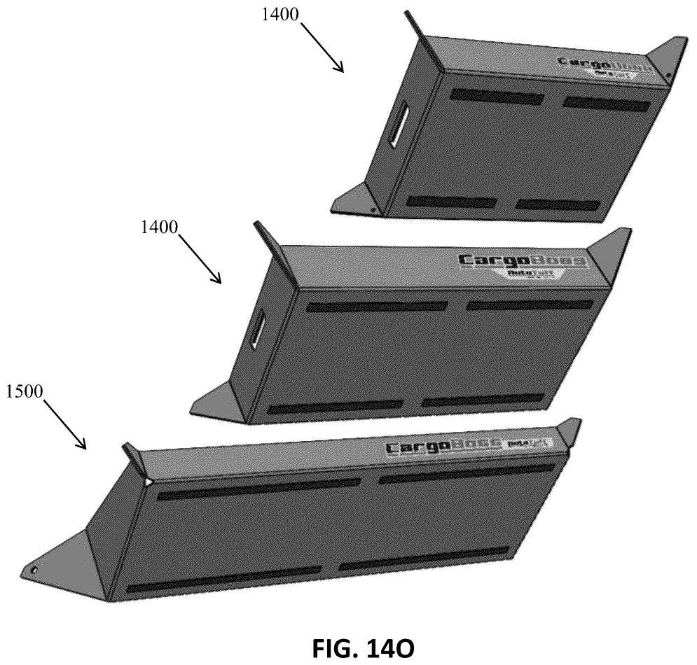

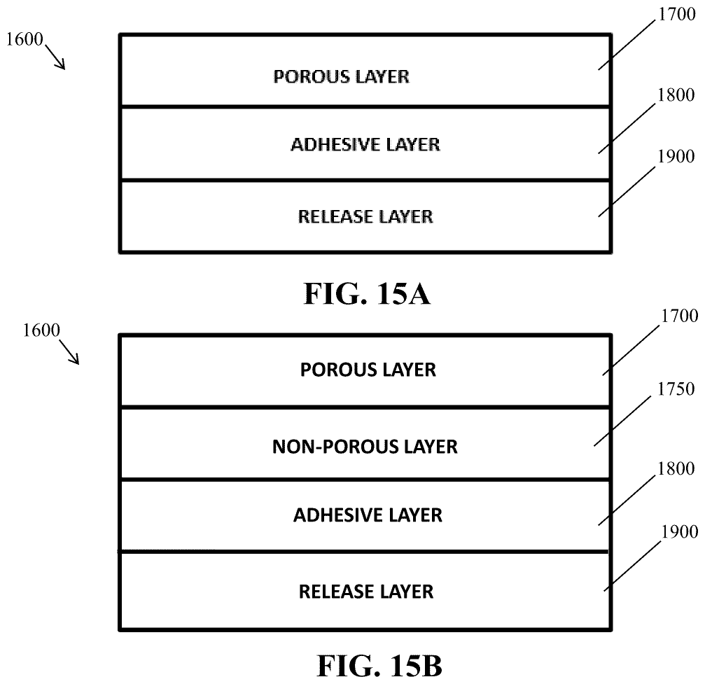

One or more side walls and/or corner flanges of the cargo tray 1400 can optionally include a connection arrangement (e.g., rings, clips, tether, cords, openings, etc.) that can be used to facilitate in securing the cargo tray 1400 to seat of a vehicle, trunk of a vehicle, cargo bay of a vehicle, truck bed of a vehicle, etc. In another non-limiting embodiment, one or more of the side walls of the cargo tray can optionally include one or more recessed regions on a top edge of the one or more side walls is configured to receive a portion of a seat belt to facilitate in securing the cargo tray of a seat of a vehicle, trunk of a vehicle, cargo bay of a vehicle, truck bed of a vehicle, etc. In another non-limiting embodiment, the bottom of the cargo tray can optionally include one or more grip strips to facilitate in maintaining the cargo tray in position while located on a seat of a vehicle, trunk of a vehicle, cargo bay of a vehicle, truck bed of a vehicle, etc. FIGS. 14A-14N illustrate another non-limiting implementation of a foldable and collapsible cargo tray 1500 in accordance with the present disclosure, and wherein the cargo tray 1500 is formed from one or more corrugated plastic sheets. In one non-limiting configuration, the body of the cargo tray 1500 is formed of a single sheet of corrugated plastic. FIG. 14A is a top-front isometric view of the cargo tray 1500 in an assembled-expanded configuration. FIG. 14B is a top-side isometric view of the cargo tray 1500 in the assembled configuration. FIG. 14C is a bottom-front isometric view of the cargo tray 1500 in the assembled configuration. FIG. 14D is a bottom-side isometric view of the cargo tray 1500 in the assembled configuration. FIG. 14E is a top plan view of the cargo tray 1500 in the assembled configuration. FIG. 14F is a bottom plan view of the cargo tray 1500 in the assembled configuration. FIG. 14G is a top-front isometric view of the cargo tray 1500 in an assembled-expanded configuration which includes an optional mounting strip 1590. FIG. 14H is another top-front isometric view of the cargo tray 1500 in an assembled-expanded configuration which includes an optional mounting strip 1590. FIG. 14I is a top-front isometric view of the cargo tray 1500 in an unassembled and flat configuration. FIG. 14J is a bottom isometric view of the cargo tray 1500 in an unassembled and flat configuration. FIG. 14K is a top plan view of the cargo tray 1500 in an unassembled and flat configuration. FIG. 14L is a bottom plan view of the cargo tray 1500 in an unassembled and flat configuration. FIG. 14M is a top plan view of the cargo tray 1500 in an unassembled, folded and flat configuration. FIG. 14N is a bottom plan view of the cargo tray 1500 in an unassembled, folded and flat configuration.

The cargo tray 1500 includes a body 1510 that is formed of a front wall 1520, a back wall 1530, first and second sides walls 1540, 1550 and a bottom wall 1560. The body forms an internal compartment 1570 when the cargo tray 1500 is in the assembled-expanded to the unfolded and assembled-expended configuration. The front wall 1520 includes a first and second side flanges 1522, 1524 that are connected to the body of the front wall 1520 by living hinges 1523, 1525. The front wall 1520 optionally includes a middle living hinge 1526 that allows a portion of the front wall 1520 to be folded over another portion of the front wall when the cargo tray 1500 is in an unassembled, folded and flat configuration as illustrated in FIGS. 14M-14N. The back wall 1530 includes a first and second side flanges 1532, 1534 that are connected to the body of the back wall 1530 by living hinges 1533, 1535. The back wall 1530 optionally includes a middle living hinge 1536 that allows a portion of the back wall 1530 to be folded over another portion of the back wall when the cargo tray 1500 in an unassembled, folded and flat configuration as illustrated in FIGS. 14M-14N.

Side wall 1540 includes a first and second side flanges 1542, 1544 that are connected to the body of the side wall 1540 by living hinges 1543, 1545. Side wall 1540 can optionally include a handle opening, now shown, that is configured to enable a use to grasp a portion of the side wall 1540 when carrying the work tray 1500 when in the assembled-expanded configuration. Side wall 1550 includes a first and second side flanges 1552, 1554 that are connected to the body of the side wall 1550 by living hinges 1553, 1555. Side wall 1450 can optionally include a handle opening, not shown, that is configured to enable a use to grasp a portion of the side wall 1550 when carrying the work tray 1500 when in the assembled-expanded configuration.

Referring now to FIGS. 14A-14D, the back wall 1530 can optionally have a height that is greater (e.g., 5-70% greater and all values and ranges therebetween) than a height of the front wall 1520. In one non-limiting specific arrangement, the height ratio of the back wall to the front wall is 1.1:1 to 10:1 (and all values and ranges therebetween). The longitudinal length of each of the front and back walls 1520, 1530 is greater (e.g., 10-5000% greater and all values and ranges therebetween) than a longitudinal length of each of the first and second sides walls 1540, 1550. The shape of the front of the front and back walls 1520, 1530, and the first and second side walls 1540, 1550, not including the attached flanges, is generally rectangular. The shape of the front of the side walls 1540, 1550, not including the side flanges, is generally rhombus-shaped. Each of the side walls 1540, 1150 have the top edge slope downwardly from the rear end to the front end of side walls 1540, 1550 when the cargo tray is in the assembled-expanded configuration. The angle of slope is non-limiting (e.g., 5-45° and all values and ranges therebetween). The bottom edge of the each of the side walls 1540, 1550 does not slope upwardly or downwardly from the rear end to the front end of side walls 1540, 1550 when the cargo tray is in the assembled-expanded configuration. In one non-limiting specific arrangement, the top edge of the sides walls progressively increases in height from the front wall to the back wall.

When the cargo tray 1500 is in the assemble configuration as illustrated in FIGS. 14A-14D, the first and second side flanges on first and second side flanges 1440, 1450 are connected by a connector 1529, 1539, 1549, 1559 (e.g., snaps, hook and loop fasteners, dual lock fasteners, press fit connection, mushroom hook fasteners, rib and slot arrangement, adhesive, rivets, magnet, heat melted seam, zipper, tie arrangement [e.g., tied with cord, chin, rope, wire, etc.], etc.) to the adjacently positioned first and second side flanges on front and back walls 1520, 1530. Such connection can be a releasable connection or a permanent connection. One or all of the connectors can be spaced from an outer edge of the side flange; however, this is not required. In one non-limiting configuration as illustrated in FIGS. 15A-15D and 14K, when the cargo tray 1500 is in the assembled configuration, second side flange 1524 of front wall 1520 is connected to first flange 1542 of first side wall 1540 by connector 1529, second side flange 1544 of first side wall 1540 is connected to second flange 1534 of back wall 1530 by connector 1549, first side flange 1532 of back wall 1530 is connected to first flange 1552 of second side wall 1550 by connector 1539, and second side flange 1554 of second side wall 1550 is connected to first flange 1522 of front wall 1520 by connector 1559. When the first and second flanges of the front and back walls and the first and second side walls are connected together, the connected flanges extend outwardly from the adjacently positioned front and back walls and the first and second side walls at an angle α of about 100-170° and all values and ranges therebetween (e.g., 130-150°, etc.) to the outer face of the adjacently positioned front and back walls and the first and second side walls.

A plurality of side flanges 1522, 1524, 1532, 1534, 1542, 1544, 1552, 1554 can optionally have the same shape and/or the same size. In one non-limiting configuration, all of the side flanges 1522, 1524, 1542, 1554 have the same shape and size. In another non-limiting configuration, all of the side flanges 1532, 1534, 1544, 1552 have the same shape and size. The length of the side flanges (measured from the interior corner of the working tray to the farthest distance from the interior corner) when connected together when the cargo tray 1500 is in the assembled configuration is about 20-160% (and all values and ranges therebetween) of the height of the side wall that is located adjacent to the connected together side flanges. In one non-limiting configuration, the length of the side flanges when connected together when the cargo tray 1500 is in the assembled configuration is equal to or greater than the height of the side wall that is located adjacent to the connected together side flanges (e.g., 100-120%, 106-107%, etc.). A plurality of the side flanges can be configured, when the cargo tray 1500 is in the assembled configuration, to have a) the bottom surface of the side flange slopes upwardly as it extends from a corner of the cargo tray 1500 and at least a portion (e.g., 25-100% and all values and ranges therebetween) of the longitudinal length of the top surface of the side flange is at the same level as the top edge of the cargo tray 1500, or b) the top surface of the side flange slopes upwardly as it extends from a corner of the cargo tray 1500 and at least a portion (e.g., 25-100% and all values and ranges therebetween) of the longitudinal length of the bottom surface of the side flange is at the same level as the bottom edge of the cargo tray 1500. In another non-limiting configuration, one or more of the side flanges can be formed of four edges, namely, a first top edge that extends from the living hinge, a second bottom edge that extends from the living hinge, a third edge that is connected along the living hinge and is connected to the first end of the first top edge and the first end of the second bottom edge and which is non-parallel to both the first top edge and the second bottom edge, and a fourth edge that connects together the second ends of the first top edge and second bottom edge and which is non-parallel to both the first top edge and the second bottom edge. In another non-limiting configuration, the length of the fourth edge has the shortest length of all the four edges of the side flange.

A plurality of adjacently positioned side flanges are connected together by a living hinge. As illustrated in FIGS. 14I-14N, side flange 1524 is connected to side flange 1542 by living hinge 1581, side flange 1544 is connected to side flange 1534 by living hinge 1582, side flange 1532 is connected to side flange 1552 by living hinge 1583, and side flange 1554 is connected to side flange 1522 by living hinge 1584.

Back wall 1530 and the side flanges of the back wall 1530 and/or side walls 1540, 1550 optionally includes one or more strap slots 1572, 1574. As illustrated in FIGS. 14A-14B, the back wall 1530 includes two strap slots 1572 that are located at or near the living hinge 1536; however, it can be appreciated that the strap slots can be located on other regions of the back wall 1530. Also, side flanges 1532, 1534 on back wall 1530 include a strap slot 1574. Further, flange 1544 on side wall 1540 and flange 1552 on side wall 1550 each include a strap slot 1574. The positioning of the strap slot 1574 on flanges 1534 and 1544, and flanges 1532 and 1552 is such that when the flanges are connected together when the cargo tray 1500 is in the assembled configuration, the strap slots on the connected together flanges partially or fully overlay one another as illustrated in FIGS. 14A-14B so that a strap 1576, cord, wire, bungee cord, or the like can be inserted through the strap slots 1574 as illustrated in FIGS. 14G-14H. The one or more strap slots 1572, 1574 are illustrated as being spaced from the bottom or top edge of the back wall 1430 and the side flanges. The size and shape of the strap slots 1572, 1574 are non-limiting. As illustrated in FIGS. 14G-14H, the one or more strap slots 1572, 1574 are configured to receive a strap 1576, or cord, or wire or bungee cord, etc. The strap 1574 can be used to facilitate in securing the cargo tray 1500 in position in a structure or vehicle. As can be appreciated, more than one strap 1574 can be used with the cargo tray 1500. The strap 1574 can optionally include a connector 1578 (e.g., hook, loop, ring, clasp, etc.) that can be used to facilitate in forming a connection between the strap 1576 and a structure or vehicle (e.g., back seat of vehicle, track of vehicle, cargo bay of vehicle, truck bed of vehicle, etc.). As illustrated in FIGS. 14G-14H, when the strap is used to connect the cargo tray 1500 to a vehicle or structure at a location is located at or near the plane of the back wall 1530, the side flanges 1532, 1543, 1552, 1554 remain in a similar position as when the cargo tray 1500 was initially fully assembled. As can be appreciated, due to the flexibility of the living hinges, the side flanges 1532, 1543, 1552, 1554 can move backwardly and forwardly as the cargo tray 1500 moves relative to vehicle or structure to which it is connected. As illustrated in FIG. 14H, the side flanges 1532, 1543, 1552, 1554 are in a forwardly bent position such that the side flanges are positioned close to side walls 1540, 1550. Such an arrangement can be optionally used when the width of the spaced that the cargo tray 1500 is to be placed is less than the width of the cargo tray 1500 when the side flanges extend outwardly from the sides of the cargo tray 1500. As can be appreciated, the side flanges 1532, 1543, 1552, 1554 can alternatively be bent rearwardly. In one non-limiting example, when side walls 1540 and 1550 have a length of 52 inches, and each of side flanges has a length of 8 inches, the side flanges are significantly bent forwardly or backwardly to enable the cargo tray 1500 to be placed in the truck bed having a width that is about 55 inches; however, the side flanges may not be bent or be barely bent when the cargo tray 1500 is placed in a truck bed having a width that is about 65 inches.

The bottom wall 1560 is connected to the front and back walls 1520, 1530 and the first and second side walls 1540, 1550 by living hinges 1562, 1563, 1564, 1565. The bottom wall 1560 optionally includes a middle living hinge 1566 that allows a portion of the bottom wall 1560 to be folded over another portion of the bottom wall when the work tray 1500 in an unassembled, folded and flat configuration as illustrated in FIGS. 14M-14N. The middle living hinge 1566 can be aligned with and connected to one end of middle living hinges 1526, 1536 on the front and back walls 1520, 1530; however, this is not required. The middle living hinge 1566 can be located at or near the central longitudinal length location (e.g., ±0-10% of the central longitudinal length location and all values and ranges therebetween) on the bottom wall 1560. As illustrated in FIGS. 14K, 14L, the middle living hinge 1566 can be located at the central longitudinal length location of the bottom wall 1560, the middle living hinge 1526 is located at the central longitudinal length location of the front wall 1520, and middle living hinge 1536 is located at the central longitudinal length location of the back wall 1530, and the middle living hinges 1526, 1536 are connected to the middle living hinge 1566.

The shape of the internal compartment 1570 when the cargo tray 1500 is in the assembled-expanded configuration is generally rectangular or square shaped; however, this is not required.

The cargo tray 1500 can optionally include one or more drainage openings 1579 in a portion of the bottom wall 1560 and/or side flanges on one or both side walls 1540, 1550 so as to allow liquids to drain from the cargo tray 1400 and/or facilitate in removing debris from cargo tray 1400.

As illustrated in 14C-14D, the bottom surface of the bottom wall 1560 can optionally include a gripping arrangement 1590. In one non-limiting configuration, the bottom surface of the bottom wall 1560 can optionally include a gripping arrangement 1590 in the form of one or more grip strips. The gripping arrangement can be configured to facilitate in maintaining the cargo tray 1500 in position on surface and/or inhibit or prevent sliding or repositioning of the cargo tray 1500 on a surface. The gripping arrangement 1590 is typically made of a different composition or material (e.g., rubber, synthetic rubber, gripping tape, gripping adhesive, gripping material, etc.) from the material (e.g., corrugated plastic sheet 50) used to form the body of the cargo tray 1500. The gripping arrangement 1590 can be permanently or releasably connected to the bottom surface of the bottom wall 1560. In one non-limiting arrangement, the bottom surface of the bottom wall 1560 includes two or more gripping strips 1590 that are adhesively connected to the bottom wall 1560.

One or more portions of the internal compartment 1570 can optionally include a protective liner, not shown, and wherein the details regarding one type of protective liner are discussed in more detail below. The protective liner can optionally include a liquid barrier layer that inhibits or prevents liquids to pass fully through the protective liner. The protective liner can be permanently or releasably secured to the top surface of the internal compartment 1570 by any number of arrangements (e.g., adhesive, snap, hook and loop fasteners, dual lock fasteners, mushroom hook fasteners, zipper, strap, rib and groove connection, etc.). In one non-limiting arrangement, the protective liner is releasably secured to the internal compartment 1570 by use of a padding glue or padding adhesive (e.g., a water soluble, vinyl adhesive; acrylic adhesive, methyl cellulose glue, PVA adhesive, starch adhesive, water-based adhesive, acrylate monomer adhesive, etc.). The adhesive layer, when used, can also optionally function as the liquid barrier layer that inhibits or prevents liquids to pass fully through the protective liner. When the protective liner is releasably secured to the internal compartment 1570, the protective liner can be removed and optionally cleaned and then reinserted on internal compartment 1570 or be replaced with a new protective liner when the protective liner gets dirty, worn, has liquids spilled thereon, etc. The color and thickness of the protective liner, when used, is non-limiting. As can be appreciated, the protective liner can be sized to fully overlie or partially overlie (e.g., overlie 5%-99.00% and all values and ranges therebetween) the internal compartment 1570. As can also be appreciated, the protective liner can be positioned on other portions of the cargo tray 1500. One or more sides of the cargo tray 1500 can optionally include logos, instructions, branding, etc.

In one non-limiting embodiment, the cargo tray 1500 is 10-100 inches long (and all values and ranges therebetween), 2-70 inches wide (and all value and ranges therebetween), and the side walls, when assembled, are 2-20 inches thick (and all values and ranges therebetween). In another non-limiting embodiment, the cargo tray 1500 is 21.5 inches long, 18.8 inches wide, and the side walls, when assembled are 0.5-4 inches high when the cargo tray 1500 is in the folded configuration. In another non-limiting embodiment, the cargo tray 1500 can hold up to at least 2 lbs. of items (e.g., 2-200 lbs. and all values and ranges therebetween) without breaking. Depending on the location that the cargo tray 1500 is to be used, the shape and size of the cargo tray 1500 can be appropriately configured for such use location.

As previously discussed above, the side flanges on the front wall 1520 and the side walls 1540, 1550 include one or more connectors 1529, 1559 (e.g., snaps arrangement, etc.) that can be optionally configured to be releasably secured together. Such a feature allows a user, when needed, to disconnect the connectors 1529, 1559 to allow the front wall 1530 to be pushed forwardly so as to lay closely or fully flat with the bottom surface of a surface that the cargo tray 1500 is positioned thereon (e.g., a vehicle, trunk of a vehicle, cargo bay of a vehicle, truck bed of a vehicle, etc.). The ability to flatten or partially flatten the front wall 1530 thus allows longer items that cannot fully fit in the internal compartment 1570, such as poles, shovels, and other larger items, to be at least partially laid in a portion of the internal compartment 1570 when connectors 1529, 1559 are at disconnected or disengaged to allow the front wall internal compartment 1570, 1530 to lay closely or fully flat with the bottom surface of the cargo tray 1500. Once such larger items are removed from the cargo tray 1500, the connectors 1529, 1559 can be reconnected so as to once again fully assemble the cargo tray 1500. Such a feature is used to increase the versatility of the cargo tray 1500 to at least partially protect a seat of a vehicle, trunk of a vehicle, cargo bay of a vehicle, truck bed of a vehicle, etc. from damage from larger items placed in the seat of a vehicle, trunk of a vehicle, cargo bay of a vehicle, truck bed of a vehicle, etc. In another non-limiting embodiment, when the cargo tray 1500 is positioned in the seat of a vehicle, trunk of a vehicle, cargo bay of a vehicle, truck bed of a vehicle, etc., the cargo tray 1500 can be optionally secured in position in the seat of a vehicle, trunk of a vehicle, cargo bay of a vehicle, truck bed of a vehicle, etc. by one or more straps 1576 to inhibit or prevent the cargo tray 1500 from sliding on the seat of a vehicle, trunk of a vehicle, cargo bay of a vehicle, truck bed of a vehicle, etc. while the vehicle is driven.

As discussed above, the side flanges can be moveably (e.g., pivotally connected to the corners, etc.) connected to the front wall, back wall and first and second side walls. The movement of one or more of the side flanges allows the cargo tray 1500 to be positioned in different width vehicle trunks, cargo bays or truck beds. The one or more moveable side flanges can be configured to be pivoted, bend, moved, etc. as required so that the cargo tray 1500 can be positioned in a desired location in a vehicle. The bendability of the one or more side flanges is a significant advantage over pre-molded plastic trays that have a single non-altering size. With reference to FIG. 14O, there is illustrated three different sized cargo trays 1400, 1500.

With reference to FIGS. 15A-15B, there is illustrated two non-limiting exemplary protective liner 1600 that can be used with any of the embodiments illustrated in FIGS. 2-14. Referring now to FIG. 15A, the protective liner 1600 includes, from the top to the bottom, porous layer 1700 that is optionally at least partially formed of an absorbable/liquid retention layer, an adhesive layer 1800, and an optional release liner 1900. As can be appreciated, the adhesive layer 1800 can be a liquid applied or spray applied adhesive coating that does not require stitching, seamed, adhesive, melted connection, etc. to be connected to the porous layer 1700. The porous layer can be optionally configured to absorb liquid. The porous layer can also or alternatively be configured to retain liquid. The adhesive layer also functions as a non-porous layer that is configured to inhibit or prevent liquid from fully penetrating through the protective liner 1600, thereby inhibiting or preventing damage to surface that are located below the protective liner 1600.

Referring now to FIG. 15B, another exemplary protective liner 1600 is illustrated. The protective liner 1600 includes, from the top to the bottom, the top layer 1700 at least partially formed of an absorbable/liquid retention layer, a non-porous layer, not shown, an adhesive layer 1800, and an optional release liner 1900. The non-porous layer can be connected (e.g. stitching, seamed, adhesive, tacks, staples, melted connection, etc.) to the top layer and/or adhesive layer 1800, and/or be spray coated, roller, dipped, etc. onto the top layer and/or adhesive layer 1800. As can be appreciated, the adhesive layer 1800 can be a liquid applied or spray applied adhesive coating that does not require stitching, seamed, adhesive, melted connection, etc. to be connected to the non-porous backing of the top layer 1700. The porous layer can be optionally configured to absorb liquid. The porous layer can also or alternatively be configured to retain liquid. The non-porous backing is configured to inhibit or prevent liquid from fully penetrating through the non-porous backing and onto/into the adhesive layer 1800, thereby inhibiting or preventing the compromising of the integrity of the adhesion of liner 1800, and/or inhibiting or preventing damage to surface that are located below the protective liner 1600.

The porous layer 1700 can optionally be formed from any absorbent/porous material. The non-porous layer, when used, can be formed of any type of waterproof material that inhibits or prevents water or other liquids from fully passing through protective liner 1600.

The one or more materials used to form the porous layer 1700 can optionally have quick-dry properties. In one non-limiting embodiment, the porous layer 1700 includes one or more woven and/or non-woven absorbent layers (e.g., 100% recycled or non-recycled non-woven layer, 100% recycled or non-recycled woven layer, etc.). In one non-limiting configuration, the porous layer 1700 is partially or fully formed of recycled polyester material (e.g., recycled material from plastic beverage bottles, etc.). In another non-limiting embodiment, the non-porous layer, when used, can include a plastic layer, a rubber backing, and a polymer coating on the bottom surface and/or embedded in the one or more woven and/or non-woven absorbent layers of the porous layer 1700. The non-porous layer can be connected to the porous layer by any means (e.g., stitching, seamed, tacks, staples, adhesive, melted connection, liquid applied coating, spray coating, etc.).

The thickness and material used to form porous layer 1700 is non-limiting. In one non-limiting embodiment, the porous layer includes one or more layers of a polyester material. In another non-limiting embodiment, the thickness of the porous layer is 0.1-3 inches (and all values and ranges therebetween).

In another non-limiting embodiment, the non-porous layer, when used, is or includes polyethylene and/or polypropylene compound, and the thickness of the non-porous layer is 0.1-3 inches (and all values and ranges therebetween). In another non-limiting embodiment, the non-porous layer is formed of or includes natural rubber or synthetic rubber, and the thickness of the non-porous layer is 0.001-3 inches (and all values and ranges therebetween). The non-porous layer, when used, can optionally be formed from recycled material.

The adhesive layer 1800 can be configured to temporarily adhere to the protective liner 1600 to a top surface of a device to be protected. In one non-limiting embodiment, adhesive layer 1800 inhibits or prevents the protective liner 1600 from shifting or moving after installation. In one non-limiting embodiment, the adhesive layer 1800 allows the protective liner 1600 to be removed and/or repositioned on the device without causing damage or leaving residue on the device; however, this is not required. In one non-limiting embodiment, the adhesive layer 1800 can be formed of or includes an acrylic adhesive, polyurethane adhesives, epoxy adhesives, padding glue or padding adhesive (e.g., a water soluble, vinyl adhesive; acrylic adhesive, methyl cellulose glue, PVA adhesive, starch adhesive, water-based adhesive, acrylate monomer adhesive, etc.), or combinations thereof. The thickness of the adhesive layer 1800 is non-limiting. In one non-limiting embodiment, the thickness of the adhesive layer 1800 is 0.001-50 mm (and all values and ranges therebetween). The adhesive layer 1800 can be connected to the bottom surface of the porous layer 1700 and/or bottom surface of the non-porous layer by any means (e.g., stitching, seamed, tacks, staples, adhesive, melted connection, liquid applied coating, spray coating, etc.). The adhesive can optionally be formed from recycled material. In one non-limiting configuration, the type of adhesive selected for the adhesive layer 1800 is configured to a) enable the protective liner to be releasably secure to many different types of surfaces (e.g., paper board surface, wood surface, plastic surface, glass surface, ceramic surface, composite board surface, fabric surface, leather surface, vinyl surface, etc.), b) enable the protective liner to be removed from a surface without leaving an adhesive residue on the surface, and/or c) cause the protective liner to not move relative to a surface that the adhesive layer is adhesively connected to, but does allow the absorbable material to be lifted from the surface.

The protective liner 1600 can optionally include a release layer 1900 that can be used to cover the bottom surface of the adhesive layer 1800 until the protective liner 1600 is ready to be installed. Prior the protective liner installation, the release layer 1900 can be removed to expose the adhesive bottom surface of the adhesive layer 1800. The type of material and thickness of the release layer 1900 is non-limiting. In one non-limiting embodiment, the release layer 1900 is formed of a polymer film and/or a paper sheet that has a thickness of 0.01-50 mm (and all values and ranges therebetween). The release liner 1900, when used, can optionally be formed from recycled material.

The protective liner 1600 is configured to protect a top surface of a device from dirt, debris, liquids, etc. that can damage, stain, smell, and/or impair the appearance of the top surface of the device. The protective liner 1600 can be configured to be optionally removable and replaceable with a new protective liner 1600 without damage to the top surface of the device. However, it can be appreciated that the protective liner 1600 can be configured to be permanently connected to the top surface of the device, and the removal of the protective liner 1600 form the device could result in damage to disfiguration of the top surface of the device. The layers of the protective liner 1600 can optionally be fully formed from recycled material.

The protective liner 1600 can optionally include anti-microbial materials, and/or be impregnated and/or coated with anti-microbial materials to inhibit or prevent the growth of microbes in the protective liner. The protective liner 1600 can optionally include scents to enhance the smell of the protective liner 1600.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the certain embodiments. These and other modifications of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

To aid the Patent Office and any readers of this application and any resulting patent in interpreting the claims appended hereto, Applicant does not intend any of the appended claims or claim elements to invoke 35 U.S.C. 112 (f) unless the words “means for” or “step for” are explicitly used in the particular claim.

What is claimed:

1. A collapsible device that can be assembled and unassembled a plurality of times; said device comprising:
A. a corner caddy comprising a body and first and second side flanges; said body includes first and second side walls, a back wall and a bottom wall that form an internal compartment; said first side wall is connected to said back wall by a first living hinge; said second side wall is connected to said back wall by a second living hinge; said first and second side walls are connected together by a first connector; said bottom wall is connected to said back wall by a bottom living hinge; a living hinge is absent between said bottom wall and said first and second side walls; said first side flange is connected to said first side wall by a first side living hinge; said second side flange is connected to said second side wall by a second side living hinge; said first side flange is bendable between a flat configuration and a generally L-shape configuration; said second side flange is bendable between a flat configuration and a generally L-shape configuration; said first and second side flanges are spaced from one another when said corner caddy is in both a generally unfolded flat configuration and an assembled-expanded configuration; and
wherein said corner caddy is collapsible to said generally unfolded flat configuration from said assembled-expandable configuration, and wherein said internal compartment has a generally triangular cross-sectional shape when said body is in said expanded configuration;
B. A collapsible pipe rack that is configured to be folded between an unfolded flat configuration and an assembled-expanded configuration; said pipe rack comprises a body that includes first and second support members, first and second end walls, first and second support members, and a base wall; said body forms an internal pipe rack compartment when said collapsible pipe rack is in expanded and assembled-expanded configuration; said first support member is connected to said first and second end walls by a first and second side living hinge; said second support member is connected to said first and second end walls by third and fourth side living hinge; said first end wall is connected between said first and second support members; said second end wall is connected between said first and second support members; said first and second end walls are spaced from one another; said first and second support members are spaced from one another; said base wall is connected to said first support member; said base wall is not connected to said second support member, and said first and second end walls; and
wherein a front portion of said base wall is configured to extend outwardly from said second support member when said pipe rack is in said expanded and assembled-expanded configuration;
C. a collapsible trough that is configured to be folded between an unfolded flat configuration and an assembled-expanded configuration; said trough comprises a body that includes front wall, a back wall, first and second side walls, and a bottom wall; said body forms an internal trough compartment when said trough is in said expanded and assembled-expanded configuration; said front wall is connected to said first side wall by a first side living hinge; said front wall is connected to said second side wall by a second side living hinge; said bottom wall is connected to front wall and said back wall by first and second bottom living hinges; said bottom wall is not connected to said first and second side walls; said first side wall includes a first body portion, a first side flange and a first side living hinge that connects said first side flange to said first body portion; said second side wall includes a second body portion, a second side flange and a second side living hinge that connects said second side flange to said second body portion; said first side flange is connected to said back wall; said second side flange is connected to said back wall;
D. a collapsible safety cone that includes a first and second slotted sheets; said first and second slotted sheets are configured to be releasable connected together to form said safety cone; said first slotted sheet includes a top slot that extends to a top edge of said first slotted sheet and extends at least 20% of a longitudinal length of said first slotted sheet; said first slotted sheet includes first and second connection flanges that are positioned in a top sheet opening that is located below and spaced from said top slot; said first and second connection flanges are each connected to a portion of said first slotted sheet by a living hinge that is located at the bottom edge of said top sheet opening; said first and second connection flanges are configured to independently move with respect to one another; said second slotted sheet includes a bottom slot that extends to a bottom edge of said second slotted sheet and extends at least 20% of a longitudinal length of said second slotted sheet; said second slot includes first and second side slots; said first side slot is positioned on an opposite side of said bottom slot from the second side slot; each of said first and second side slots are spaced from said bottom slot, said bottom edge of said second slotted sheet, and side edges of said second slotted sheet; and
wherein said top slot of said first slotted sheet is configured to receive said bottom slot of said second slotted sheet when said first and second slotted sheets are releasably connected together to form said safety cone; and
wherein said first flange of said first slotted sheet is configured to releasably connect to said first side slot of said second slotted sheet when said first and second slotted sheets are releasably connected together to form said safety cone; and
wherein said second flange of said first slotted sheet is configured to releasably connect to said second side slot of said second slotted sheet when said first and second slotted sheets are releasably connected together to form said safety cone; and
wherein said first and second connection flanges of said first slotted sheet are each configured to bend about said living hinge to enable said first and second connection flanges to be releasably connected to said second slotted sheet;
E. a collapsible holster that is configured to be folded between an unfolded flat configuration and an assembled-expanded configuration; said holster comprises a body that includes front wall, a back wall, and first and second side walls; said body forms an internal holster compartment when said holster is in said expanded and assembled-expanded configuration; said front wall is connected to said first side wall by a first side living hinge; said front wall is connected to said second side wall by a second side living hinge; said collapsible holster includes three or more features selected from the group consisting of a) said body is absent a bottom wall such that said internal holster compartment is open at both a top end and bottom end of said internal holster compartment, b) said front wall has a height that is less than a height of said back wall, c) said first and second side walls include one or more living hinges, d) said front wall and said back wall having a rhombus shape, e) said front wall and said back wall each have a rectangular shape, and f) a rear flange that is connected to said back wall and said rear flange includes at least one hinge to form a first and second portions of said rear flange;
F. a collapsible bucket that is configured to be folded between an unfolded flat configuration and an assembled-expanded configuration; said bucket comprises a body and a support strap; said body includes front wall, a back wall, and first and second side walls; said body forms an internal bucket compartment when said bucket is in said expanded and assembled-expanded configuration; said body is formed of a single piece of material; said front wall is connected to said first side wall by a first side living hinge; said first side wall is connected to said back wall by a living hinge, said back wall is connected to said second side wall by a living hinge; said second side wall is connected to said first side wall by one or more releasable connectors; a bottom of said bucket is formed of a plurality of bottom flaps that are folded together when said bucket is in said assembled-expanded configuration; each of said bottom flaps is connected by a living hinge to a bottom edge of one of said front wall, said back wall, said first side wall or said second side wall; a portion of said support strap is configured to be positioned on a bottom surface of said bottom of said bucket so as to facilitate in maintaining said bottom flaps in a folded together configuration when said bucket is in said expanded and assembled-expanded configuration; said collapsible bucket includes two or more features selected from the group consisting of a) two or more of said bottom flaps have a different size and configuration, b) two or more of said bottom flaps have a different size and configuration and two of said bottom flaps have the same size and configuration, c) said front wall and said back wall each include two strap openings that are configured to receive a portion of said support strap, and d) said first side wall and said second side wall each include two strap openings that are configured to receive a portion of said support strap;
G. a collapsible platform that is configured to be folded between an unfolded flat configuration and an assembled-expanded configuration; said platform comprises a body and top board; said body includes front wall, a back wall, and first and second side walls; said body is formed of a single piece of material; said front wall is connected to said first side wall by a first side living hinge; said first side wall is connected to said back wall by a living hinge, said back wall is connected to said second side wall by a living hinge; said second side wall is connected to said first side wall by one or more releasable connectors; said collapsible platform includes two or more features selected from the group consisting of a) said first and second side walls includes a living hinge that allow a portion of each of said first and second side walls to be folded over one another, b) each of said front and back wall include a plurality of upwardly extending support legs and a recessed region positioned between at least two adjacently positioned upwardly extending support legs, and wherein said top board includes a plurality of support flanges that are positionable between adjacently positioned upwardly extending support legs when said top board is positioned on said body when said platform is in said assembled-expanded configuration, c) each of said first and second side walls include a plurality of upwardly extending support legs and a recessed region positioned between at least two adjacently positioned upwardly extending support legs, and wherein said top board includes a plurality of support flanges that are positionable between adjacently positioned upwardly extending support legs when said top board is positioned on said body when said platform is in said assembled-expanded configuration, d) each of said front and back walls include a plurality of downwardly extending legs, and e) each of said first and second side walls include a plurality of upwardly extending support legs;
H. a collapsible ladder caddy that is configured to be folded between an unfolded flat configuration and an assembled-expanded configuration; said ladder caddy comprises a ladder trough and a ladder support member; said ladder trough includes front wall, a back wall, first and second side walls, and a bottom wall; said body forms an internal trough compartment when said ladder caddy is in said expanded and assembled-expanded configuration; said front wall is connected to said first side wall by a first side living hinge; said front wall is connected to said second side wall by a second side living hinge; said bottom wall is connected to front wall and said back wall by first and second bottom living hinges; said bottom wall is not connected to said first and second side walls; said first side wall includes a first body portion, a first side flange and a first side living hinge that connects said first side flange to said first body portion; said second side wall includes a second body portion, a second side flange and a second side living hinge that connects said second side flange to said second body portion; said first side flange is connected to said back wall; said second side flange is connected to said back wall; said ladder support is connected to said back wall; said ladder support includes first and second side arms and a rear arm that is connected to the first and second side arms; said first and second side arms are spaced from one another; said rear arm is spaced from said back wall of said ladder trough; said first and second side arms and said rear arm and at least a portion of said ladder trough define a ladder opening;
I. a collapsible work tray that is configured to be folded between an unfolded flat configuration and an assembled-expanded configuration; said work tray comprises a body that includes front wall, a back wall, first and second side walls, and a bottom wall; said body forms an internal work tray compartment when said work tray is in said expanded and assembled-expanded configuration; said front wall is connected to said bottom wall by a first bottom living hinge; said back wall is connected to said bottom wall by a back bottom living hinge; said first side wall is connected to said bottom wall by a first bottom side living hinge; said second side wall is connected to said bottom wall by a second bottom side living hinge; said front wall includes front first and second side flanges that are each connected to said first wall by first wall living hinges; said back wall includes back first and second side flanges that are each connected to said back wall by back wall living hinges; said first side wall includes first side first and second side flanges that are each connected to said first side wall by first side wall living hinges; said second side wall includes second side first and second side flanges that are each connected to said second side wall by second side wall living hinges; adjacently positioned side flanges are connected together by flange living hinges; adjacently positioned side flanges are configured to extend outwardly from a corner of said work tray when in said assembled-expanded configuration; or
J. A collapsible cargo tray that is configured to be folded between an unfolded flat configuration and an assembled-expanded configuration; said cargo tray comprises a body that includes front wall, a back wall, first and second side walls, and a bottom wall; said body forms an internal cargo tray compartment when said cargo tray is in said expanded and assembled-expanded configuration; said front wall is connected to said bottom wall by a first bottom living hinge; said back wall is connected to said bottom wall by a back bottom living hinge; said first side wall is connected to said bottom wall by a first bottom side living hinge; said second side wall is connected to said bottom wall by a second bottom side living hinge; said front wall includes front first and second side flanges that are each connected to said first wall by first wall living hinges; said back wall includes back first and second side flanges that are each connected to said back wall by back wall living hinges; said first side wall includes first side first and second side flanges that are each connected to said first side wall by first side wall living hinges; said second side wall includes second side first and second side flanges that are each connected to said second side wall by second side wall living hinges; adjacently positioned side flanges are connected together by flange living hinges; adjacently positioned side flanges are configured to extend outwardly from a corner of said cargo tray when in said assembled-expanded configuration; said cargo tray includes one or more features selected from the group consisting of a) one or more strap slots located in one of said first side wall, said second side wall, said front wall, said back wall, first and/or second side flanges of said first side wall, first and/or second side flanges of said second side wall, first and/or second side flanges of said front wall, and/or first and/or second side flanges of said back wall, b) one or more gripping members connected to a bottom surface of said bottom wall, c) a top side flange that is connected by a top side living hinge to a body of said first side wall, and wherein said top side flange is configured to be bent about said top side living hinge over a portion of a front face or a back face of said first side wall, d) a top side flange that is connected by a top side living hinge to a body of said second side wall, and wherein said top side flange is configured to be bent about said top side living hinge over a portion of a front face or a back face of said second side wall, e) a top side flange that is connected by a top side living hinge to a body of said first side wall, and an opening flange in said first side wall, and wherein said top side flange is configured to be bent about said top side living hinge over a portion of a front face or a back face of said first side wall, and wherein said opening flange is movable to form a handle opening in said first side wall, and wherein said opening flange is configured to partially overlie a portion of said top side flange of said first side wall when said opening flange is moved to form said handle opening, and/or f) a top side flange that is connected by a top side living hinge to a body of said second side wall, and an opening flange in said first side wall, and wherein said top side flange is configured to be bent about said top side living hinge over a portion of a front face or a back face of said second side wall, and wherein said opening flange is movable to form a handle opening in said second side wall, and wherein said opening flange is configured to partially overlie a portion of said top side flange of said second side wall when said opening flange is moved to form said handle opening.

2. The collapsible device as defined in claim 1, wherein said body is formed of a single piece of corrugated plastic.

3. The collapsible device as defined in claim 1, wherein said body is formed of two pieces of corrugated plastic.

4. The collapsible device as defined in claim 1, wherein said body includes at least one drainage opening that is at least partially formed by said bottom wall.

5. The collapsible device as defined in claim 1, wherein said body including a protective liner.

6. The collapsible device as defined in claim 1 that is in the form of said collapsible corner caddy, wherein said collapsible corner caddy a) includes a bottom flange; said bottom flange is connected to said first side wall by a first bottom living hinge and is connected to said second side wall by a second bottom living hinge; a living hinge is absent between said back wall and said bottom flange; said bottom flange optionally includes a bottom rib that extends downwardly from a bottom surface of said bottom flange; said bottom flange optionally includes a bottom flange living hinge that facilitates in folding said bottom flange in half when said corner caddy is folded to from said assembled-expanded configuration to said generally unfolded flat configuration; b) has a connected portion of said first and second side walls forms a cavity flange that extends inwardly into internal compartment when said corner caddy is in said expanded configuration, c) has at least one connector opening positioned on one or more structures selected from the group consisting of said first side wall, said second side wall, said first side flange and said second side flange; said at least one connector opening configured to be used with a connection device to secure said corner caddy to a structure, and/or d) includes a back wall living hinge on said back wall that facilitates in folding said back wall in half when said corner caddy is folded or collapsed from said assembled-expanded configuration to said unfolded flat configuration.

7. The collapsible device as defined in claim 1 that is in the form of said collapsible pipe rack, wherein said collapsible pipe rack a) has said first support member includes a plurality of pieces of corrugated plastic; said first and second end walls each include a plurality of pieces of said corrugated plastic, b) has a width of said base wall is less than a width between said first and second end walls, c) has said first support member include first and second rear flanges; said first and second rear flanges are each connected to said first support member by first and second flange living hinges; and wherein said first and second rear flanges are configured to extend rearwardly of said first support member when said pipe rack is in said expanded and assembled-expanded configuration, d) has a bottom edge of said first and second end walls, and a bottom edge of a mid-portion of said first support member are located between a bottom surface of said first and second rear flanges when said pipe rack is in said expanded and assembled-expanded configuration, e) includes at least one connector opening positioned on said base wall, f) includes at least one connector openings positioned on each of said first and second rear flanges, g) has a top surface of each of first and second support members forms a support surface; a midportion of each of said support surface of said first and second support members has a U-shape or semi-circular shaped, h) has a mid-portion of a bottom of said second support member includes a recessed region; said recessed region is configured to receive a portion of said base wall when said pipe rack is in said expanded and assembled-expanded configuration; and wherein a bottom edge of said second support member on each side of said recessed region is located below a bottom surface of said base wall when said pipe rack is in said expanded and assembled-expanded configuration, and/or i) has each of said first and second end walls include an opening for use with a connector and includes an elastic portion and a connection end; a size and shape of said opening on said first and second end walls is the same; a first end of said connector is connected to said opening in said first end wall; said connector is configured to include in length so that said connection end can be inserted into and be releasably maintained in said opening in said second end wall.

8. The collapsible device as defined in claim 1 that is in the form of said collapsible trough, wherein said collapsible trough a) includes at least one connector opening positioned on said back wall, b) includes a rear flange that is connected to a top edge of said back wall by a back wall living hinge; said rear flange having a height that is less than a height of said back wall; said rear flange including one or more flange connectors that connects a body of said rear flange to an outer surface of said back wall; said one or more flange connectors are spaced from said back wall living hinge, c) includes at least one connector opening positioned on said rear flange, d) has each of said first and second side walls each include a side living hinge that facilitates in folding each of said first and second side walls in half when said trough is folded from said assembled-expanded configuration to said unfolded flat configuration, e) has said bottom wall includes a plurality of living hinges, and/or f) has said bottom wall includes one or more drainage openings; said one or more drainage openings fully formed in said bottom wall or partially formed by said bottom wall.

9. The collapsible device as defined in claim 1 that is in the form of said collapsible safety cone, wherein said collapsible safety cone a) has a top portion of said top slot of said first slotted sheet and a bottom portion of said bottom slot of said second slotted sheet each include outwardly flaring portion, b) has each of said first and second connection flanges includes a flange tab that are configured to pass partially or fully through said first and second side slots on said second slotted sheet, c) has said first and second connection flanges do not fully cover said top sheet opening when said first slotted sheet is in a flat configuration, d) has said second slotted sheet includes an upper slot that is positioned above and spaced from said bottom slot; a longitudinal length of said upper slot is less than a longitudinal length of said bottom slot; said first slotted sheet includes; said at least one top slot tab is connected to a portion of said first slotted sheet by a living hinge; said at least one top tab is spaced from the top edge of said first slotted sheet; said at least one top slot tab is configured to lie in a same flat plane said first slotted sheet when said first slotted sheet is in a flat configuration; said at least one top slot tab is configured to be releasably connected in said upper slot when said first and second slotted sheets are releasably connected together to form said safety cone, e) has a spacing of said first side slot from said bottom slot is different from a spacing of said second side slot from said bottom slot, f) has a size of said first connection flange is larger than a size of said second connection flange, g) has one or both of said first and second slotted sheets includes one or more of reflective tape, reflective material, logo, instructions, and/or branding, and/or h) includes one or more weights connected to i) said first second slotted sheet at a location at or below a bottom edge of said top sheet opening, and/or ii) said second slotted sheet at a location at or below a bottom edge of said first and/or second side slots.

10. The collapsible device as defined in claim 1 that is in the form of said collapsible holster, wherein said collapsible holster a) includes at least one connector opening positioned on said back wall, b) includes a rear flange that is connected to said back wall; said rear flange includes one or more features selected from the group consisting of i) said rear flange is connected to said back wall by one or more flange connectors, ii) said rear flange is connected to said back wall by a living hinge, and iii) said rear flange includes said first and second portions that are connected together by a rear flange living hinge, c) includes at least one connector opening positioned on said rear flange, d) has each of said first and second side walls each include a side living hinge that facilitates in folding each of said first and second side walls in half when said trough is folded from said assembled-expanded configuration to said unfolded flat configuration, e) has each of said first and second side walls includes a U-Shaped or C-shaped top edge profile in the top mid-region of said first and second side walls, f) has each of said front wall and said back wall have said trapezoidal shape; a length of said top edge of each of said front wall and said back wall is longer than a length of said bottom edge of each of said front wall and said back wall, g) has said body is absent a bottom wall, h) has said body includes a bottom wall that covers 80-100% of a bottom of said internal holster compartment when said holster is in said expanded and assembled-expanded configuration, i) includes a divider flange that is connected in said internal holster compartment; said divider flange is configured to divided said internal holster compartment in into two or more compartments when said holster is in said expanded and assembled-expanded configuration, and/or j) has said divider flange is connected to said front wall and said back wall.

11. The collapsible device as defined in claim 1 that is in the form of said collapsible bucket, wherein said collapsible bucket includes a handle that is connected to said strap; said handle includes an internal cavity wherein said strap is positioned therein.

12. The collapsible device as defined in claim 1 that is in the form of said collapsible platform, wherein said collapsible platform includes an elastic strap that is connected to said body.

13. The collapsible device as defined in claim 1 that is in the form of said collapsible ladder caddy, wherein said collapsible ladder caddy a) has each of said first and second side walls each include a side living hinge that facilitates in folding each of said first and second side walls in half when said ladder caddy is folded from said assembled-expanded configuration to said unfolded flat configuration, b) has said bottom wall includes a plurality of living hinges, c) has said bottom wall includes one or more drainage openings; said one or more drainage openings fully formed in said bottom wall or partially formed by said bottom wall, d) has said first and second side arms are connected by a back arm living hinge to said back wall; said rear arm is connected to said first and second side arms by a living hinge, e) has said rear arm forms an upwardly extending flange and a downwardly extending flange when said rear arm is bent downwardly about said back arm living hinge, f) has said back wall includes an upwardly extending flange that is located in a mid-portion of said back wall, and/or g) has said first and/or second side arms of said ladder support includes one or more openings.

14. The collapsible device as defined in claim 1 that is in the form of said collapsible work tray, wherein said collapsible work tray a) has each of said front wall, said back wall and said bottom wall include a mid-region living hinge that facilitates in folding each of said front wall, said back wall and said bottom wall in half when said work tray is folded from said assembled-expanded configuration to said unfolded flat configuration, b) has said bottom wall includes one or more drainage openings; said one or more drainage openings fully formed in said bottom wall or partially formed by said bottom wall, c) has each of said first and second side wall includes a handle opening and an opening flange; said opening flange on each of said first and second side walls is connected by a living hinge, d) has said adjacently positioned side flanges include one or more connectors that are configured to releasably connect together said adjacently positioned side flanges, f) has each of said side flanges have a same shape and a same size, and/or g) has a plurality of said side flanges are formed of four edges; a first top edge extends from one of said living hinge one of said front wall, back wall, first side wall or second side wall; a second bottom edge that extends from said same living hinge; a third edge that is connected along said same living hinge and is connected to a first end of said first top edge and a first end of said second bottom edge and wherein said third edge is non-parallel to both said first top edge and said second bottom edge, and a fourth edge that connects together second ends of said first top edge and second bottom edge and wherein said fourth edge is non-parallel to both said first top edge and said second bottom edge.

15. The collapsible device as defined in claim 1 that is in the form of said collapsible cargo tray, wherein said collapsible cargo tray a) has each of said front wall, said back wall and said bottom wall include a mid-region living hinge that facilitates in folding each of said front wall, said back wall and said bottom wall in half when said cargo tray is folded from said assembled-expanded configuration to said unfolded flat configuration, b) has said bottom wall includes one or more drainage openings; said one or more drainage openings fully formed in said bottom wall or partially formed by said bottom wall, c) has each of said first and second side wall includes said handle opening and said opening flange; said opening flange on each of said first and second side walls is connected by a living hinge, d) has said adjacently positioned side flanges include one or more connectors that are configured to releasably connect together said adjacently positioned side flanges, e) has each of said side flanges have a same shape and a same size, f) has a plurality of said side flanges are formed of four edges; a first top edge extends from one of said living hinge one of said front wall, back wall, first side wall or second side wall; a second bottom edge that extends from said same living hinge; a third edge that is connected along said same living hinge and is connected to a first end of said first top edge and a first end of said second bottom edge and wherein said third edge is non-parallel to both said first top edge and said second bottom edge, and a fourth edge that connects together second ends of said first top edge and second bottom edge and wherein said fourth edge is non-parallel to both said first top edge and said second bottom edge, g) has one or more of said one or more strap slots located in one of said first side wall, said second side wall, said front wall, said back wall, first and/or second side flanges of said first side wall, first and/or second side flanges of said second side wall, first and/or second side flanges of said front wall, and/or first and/or second side flanges of said back wall; one or more of said strap slots includes a strap positioned said strap slot; said strap includes one or more connectors, h) has said front wall has a height that is less than a height of said back wall, i) has said first and second side walls progressively increase in height from said front wall to said back wall, and/or j) has said first and second side flanges on said back wall and one of said side flanges on each of said first and second side walls include said strap slot that are configured to at least partially overlap one another when said first side flange on said back wall is connected to one of said side flanges on said side wall and the second side flange on said back wall is connected to one of said side flanges on said second side wall.
